(19) United States
(12) Patent Application Publication
(10) Pub. No.: US 2004/0059510 A1
(43) Pub. Date: Mar. 25, 2004

(54) System and method of managing safety compliance data

(76) Inventors: Archie R. Thompson JR., Lafayette, LA (US); Richard Scott Ricks, Bellville, TX (US); Jeffrey Scott, Ballwin, MO (US); Robert A. Albright, Houston, TX (US); Jason A. Worthen, Humble, TX (US); Larissa L. Worthen, Humble, TX (US); Justin R. Thomas, Friendswood, TX (US)

Correspondence Address: Warner J. Delaune, Jr., Adams and Reese LLP, North Tower, 19th Floor, 451 Florida Street, Baton Rouge, LA, 70801, US

(21) Appl. No.: 10/373,386

(22) Filed: Feb. 24, 2003

Related U.S. Application Data
(63) Continuation of application No. 10/175,996, filed on Jun. 20, 2002.
(63) Continuation of application No. 09/982,577, filed on Oct. 17, 2001, now abandoned.
(60) Provisional application No. 60/241,108, filed on Oct. 17, 2000.

(51) Int. Cl. G01V 1/40

(52) U.S. Cl. 702/6

(57) ABSTRACT

A system and method managing safety data in a Web-based application that may preferably be used by offshore oil and natural gas production platform operators to verify and store Safety and Environmental Management Program for Outer Continental Shelf Operations and Facilities compliance data. The system provides a reporting system for the orderly accumulation of safety system test data that can then be used for operational analyses, reliability studies, and reports that may be required by regulatory agencies. In a preferred embodiment, the system uses security technology to ensure the security and confidentiality of the client data. Users may access the application via their existing Internet browser to access the system Web site. After entering data, which may preferably be verified by the system, the user is provided with a report regarding compliance.

### SPECIFICATION

This application relies upon U.S. Provisional Patent Application Serial No. 60/241,108, filed Oct. 17, 2000; and is a continuation of U.S. Ser. No. 09/982,577, filed Oct. 17, 2001, and a continuation of U.S. Ser. No. 10/175,996, filed Jun. 20, 2002.

### FIELD OF THE INVENTION

The following may be used in the management of any data set, but preferably provides for the management of safety compliance data in the energy industry.

### BACKGROUND OF THE INVENTION

Most threats to safety from offshore oil and natural gas production involve the release of hydrocarbons. Safety systems are designed and installed throughout the production and transportation processes to focus on preventing such releases, stopping the flow of hydrocarbons to a leak if it occurs, and minimizing the effects of hydrocarbons that are released. Performance testing of the safety devices on all offshore, integrated production platforms is both an operational and regulatory requirement. The system is a web-based application that is used by offshore oil and natural gas production platform operators to verify and store SEMP compliance data (Safety and Environmental Management Program for Outer Continental Shelf Operations and Facilities). The SEMP is an acronym first used by the American Petroleum Institute (API) in the mid-1990's to describe its recommended offshore safety programs. The system is a reporting system that provides for the orderly accumulation of safety system test data that can then be used for operational analyses, reliability studies and reports that may be required by regulatory agencies.

Until the creation on the system, the offshore petroleum production Industry did not have a comprehensive, easy to use system to track and record safety test results. Several existing solutions were available, but were found to be lacking in critical capabilities. Existing solutions were either legacy, DOS based systems and/or simple spreadsheet systems that did not allow for the transfer or archival of data, or were cumbersome training intensive solutions that were not focused solely on compliance paperwork.

The SMART (Shell MMS Automated Reporting Tool) system was developed for the same reason as the system, among others. It was developed as a joint project between Shell Engineers and Paragon Engineering. SMART differs from the system in that it requires a tremendous amount of training for the offshore operators to use. The system was designed to minimize the amount of training required. SMART was designed with features that allow users to copy over previous month's data for a current report. The system does not allow users to do this, and as such provides a product with much higher data integrity. The system creates report printouts that are formatted exactly like the inspection forms that the government MMS inspectors' use, in fact the MMS forms were used as templates to create the user pages and report forms. SMART uses its own format for reports that differ significantly from the MMS inspection forms. Another fundamental design difference between SMART and the system is that the system was designed from the outset as WAN (Wide Area Network) based application, and can be used via the internet or hosted on a company's corporate intranet. SMART was designed to be hosted on a company's intranet, although at this date, it may be accessible over the Internet also.

Many offshore production companies are still using Microsoft Excel™ spreadsheets or other legacy DOS based programs. These tools do not offer the benefits of a central server database system. They are local to the platform, and the test data must be mailed or faxed back to the home office. With the system, a user can log in and access reports, documentation, and test status anywhere in the world that they have a computer with Internet access. Since the data is hosed on a secure server with daily backups, it is inherently safer than a local copy on a platform filing cabinet or a platform computer. In addition to these benefits, the system proactively error checks all users entered values, and flags any entry that is out of compliance. The system even provides the user with a suggested course of action for errors that are generated. For the benefit of the offshore operator and the management with oversight into operations, the system captures and stores all errors produced during the creation of a report and requires the user to document the corrective action. This feature is unmatched by any alternative tool, and provides a valuable feedback mechanism.

Finally, there is no existing system that archives electronic copies of platforms drawings and compliance paperwork, as the system does.

### SUMMARY OF THE INVENTION

The system and method of the present invention is a Web-based application that may be used by offshore oil and natural gas production platform operators to verify and store SEMP (Safety and Environmental Management Program for Outer Continental Shelf Operations and Facilities) compliance data. The SEMP is an acronym first used by the American Petroleum Institute (API) in the mid-1990s to describe its recommended offshore safety programs. The present invention is a reporting system that provides for the orderly accumulation of safety system test data that can then be used for operational analyses, reliability studies, and reports that may be required by regulatory agencies.

The present invention may use the latest available security technology to ensure the security and confidentiality of the client (“user”) data. Users may access the application via their existing Internet browser to access the system Web site. The Universal Resource Locator (“URL”) for the preferred embodiment of the present invention is www.sempcheck.com as well as several others including but not limited to www.offshorecompliance.com and www.GulfofMexicocompliance.com. Those skilled in the art will recognize that the present invention may be accessible at any location on any wide area network and still be within the scope of the invention. Once a user has accessed the system Web site they he or she may login to a secure site by providing a user identification code and a secure password. The user may then input the appropriate platform-specific testing/compliance data into a Web page that is essentially an operational model of each user's production and safety processes on that specific platform.

Once the user has entered all the required data for all appropriate production components and safety devices (all Pressure Vessels, Pumps, Heat Exchangers, Headers, etc.), he or she may submit his or her data into the system. The present invention may be hosted on a remote Web server/application server. The system may allow the user to verify that the data being input is correct (i.e. no typographical errors), and, upon user confirmation, may perform a verification check of the input data. The verification of the data may flag any out-of-limits entries. A report may immediately be displayed to the user that may indicate, in “easy to understand” terms, what parameter was wrong, and why it failed the error check. The user may then be re-directed to the input page to review the data. If there are no errors, the user may be re-directed to a printable page that will be the source of their documentation.

### BRIEF DESCRIPTION OF THE DRAWINGS

FIG. 1 is a flow chart of the preferred embodiment;

FIG. 2 is a representative input page;

FIG. 3 is a representative input page;

FIG. 4 is a representative component status page;

FIG. 5 is a representative error message;

FIG. 6 is a representative warning message;

FIG. 7 is a representative action item summary;

FIG. 8 is a flow chart of the preferred embodiment;

FIG. 9 is a representative platform page;

FIG. 10 is a representative well information input page;

FIG. 11 is a representative well information input page;

FIG. 12 is a representative well information page;

FIG. 13 is a representative well head injection lines information page;

FIG. 14 is a representative headers information page;

FIG. 15 is a representative pipelines information page;

FIG. 16 is a representative pressure and atmospheric vessels information page;

FIG. 17 is a representative pumps information page;

FIG. 18 is a representative compressors information page;

FIG. 19 is a representative heat exchangers information page;

FIG. 20 is a representative fired components information page;

FIG. 21 is a representative ESD and TSE information page;

FIG. 22 is a representative PSV inspections selection page;

FIG. 23 is a representative PSV input page;

FIG. 24 is a representative PSV print page;

FIG. 25 is a representative compliance checklist user input;

FIG. 26 is a representative MMS report form;

FIG. 27 is a representative completed MMS report form;

FIG. 28 is a representative inspection file;

FIG. 29 is a representative “tblActionItem” Properties;

FIG. 30 is a representative “tblChecklist” Properties;

FIG. 31 is a representative “tblChecklistComp” Properties;

FIG. 32 is a representative “tblChecklistEntry” Properties;

FIG. 33 is a representative “tblChecklistPlatform” Properties;

FIG. 34 is a representative “tblComment” Properties;

FIG. 35 is a representative “tblCommentEntry” Properties;

FIG. 36 is a representative “tblCompany” Properties;

FIG. 37 is a representative “tblCompressor” Properties;

FIG. 38 is a representative “tblCompressorEntry” Properties;

FIG. 39 is a representative “tblDeparture” Properties;

FIG. 40 is a representative “tblDepartureEntry” Properties;

FIG. 41 is a representative “tblDeviceDueDate” Properties;

FIG. 42 is a representative “tblDrawing” Properties;

FIG. 43 is a representative “tblDrawingComments” Properties;

FIG. 44 is a representative “tblESDStation” Properties;

FIG. 45 is a representative “tblESDStationEntry” Properties;

FIG. 46 is a representative “tblFiredComponent” Properties;

FIG. 47 is a representative “tblFiredComponentEntry” Properties;

FIG. 48 is a representative “tblHeader” Properties;

FIG. 49 is a representative “tblHeaderEntry” Properties;

FIG. 50 is a representative “tblHeatExchange” Properties;

FIG. 51 is a representative “tblHeatExchangeEntry” Properties;

FIG. 52 is a representative “tblHistory” Properties;

FIG. 53 is a representative “tblInspectionfiles” Properties;

FIG. 54 is a representative “tblInspectionplatform” Properties;

FIG. 55 is a representative “tblPipeline” Properties;

FIG. 56 is a representative “tblPipelineEntry” Properties;

FIG. 57 is a representative “tblPlatform” Properties-I;

FIG. 58 is a representative “tblPlatform” Properties-II;

FIG. 59 is a representative “tblPlatform_User” Properties;

FIG. 60 is a representative “tblPlatformInspect” Properties;

FIG. 61 is a representative “tblPSVInspect” Properties;

FIG. 62 is a representative “tblPSVInspectEntry” Properties;

FIG. 63 is a representative “tblPump” Properties;

FIG. 64 is a representative “tblPumpEntry” Properties;

FIG. 65 is a representative “tblReport” Properties;

FIG. 66 is a representative “tblTSE” Properties;

FIG. 67 is a representative “tblTSEEntry” Properties;

FIG. 68 is a representative “tblVessel” Properties;

FIG. 69 is a representative “tblVesselEnty” Properties;

FIG. 70 is a representative “tblWell” Properties;

FIG. 71 is a representative “tblWellEntry” Properties;

FIG. 72 is a representative “tblWellbay” Properties;

FIG. 73 is a representative “tblWellbayEntry” Properties;

FIG. 74 is a representative “tblWellhead” Properties; and

FIG. 75 is a representative “tblWellheadEntry” Properties.

### DETAILED DESCRIPTION OF PREFERRED EMBODIMENT

As a preliminary matter, the following list of abbreviations shows some of the terms that are used throughout the Description of the Preferred Embodiment.

TABLE 1
ABBREVIATIONS

| Term | Definition |
|---|---|
| API | American Petroleum Institute |
| ASP | Active Server Pages |
| BSL | Burner Safety Low |
| ESD | Emergency Shutdown Station |
| FSV | Flow Safety Valve (also known as Check valve) |
| MAOP | Maximum Allowable Operating Pressure |
| MAWP | Maximum Allowable Working Pressure |
| MDP | Maximum Discharge Pressure |
| MMS | Mineral Management Service |
| MOC | Management of Change |
| PDF | Portable Document Format |
| PSH | Pressure Safety High |
| PSL | Pressure Safety Low |
| PSV | Pressure Safety Valve |
| SCSSV | Surface Controlled Subsurface Shutoff Valve |
| SDV | Shut Down Valve |
| SEMP | Safety and Environmental Management Program |
| SSV | Subsurface Shutoff Valve |
| TSE | Temperature Safety Element |
| TSH | Temperature Safety High |

The following table defines the actors and roles for the system.

TABLE 2
ACTORS AND ROLES

| Role | Responsibilities | Comments |
|---|---|---|
| Administrator | Overall maintenance of site. Create | |
| (Admin) | accounts and serve as backup to Setup | |
| | specialist. | |
| Setup | a) Create customer accounts. | |
| Personnel | b) Perform initial setup of platform | |
| (Setup) | configuration. | |
| | c) Edits platform configuration as | |
| | required for Management of Change | |
| | (MOC). | |
| | d) Uploads Drawings and populates e- | |
| | library as required | |
| Customer | View all records for a specific | Synonymous |
| | platform and make inputs to current | with |
| | records | Operator |
| Customer | View all records for company platforms | |
| Management | | |
| Application | Validate inputs. Perform functional | |
| (System) | error checking. Notify customers of | |
| | safety updates required. Provides | |
| | platform record repository (e-library). | |

The following table defines the use cases for the application. The program capabilities are fully defined by the set of use cases.

TABLE 3
USE CASES

| ID | Actor | Use Case | Definition | Comments |
|---|---|---|---|---|
| U001 | Admin | Create Setup | The action of creating setup | |
| | | Accounts | accounts. | |
| U002 | Admin & | Create | The action of creating | |
| | Setup | Customer | customer accounts. | |
| | | Accounts | | |
| U003 | Admin & | Customer | The action of updating | |
| | Setup | Account | customer account information. | |
| | | Maintenance | | |
| U004 | Admin & | Customer | The action of resetting or | |
| | Setup | Password | modifying the customer | |
| | | Maintenance | specific password. | |
| U005 | Setup | Setup | The action of initially setting | Setup can specify which |
| | | Platform | up a platform, for any | customer information to |
| | | | specified customer, based on | modify. |
| | | | drawings, additional info and | |
| | | | Prior MMS Test Reports. | |
| U006 | Setup | Specify | The action of inputting the | Setup can specify which |
| | | Number of | specific number of platform | customer information to |
| | | Platform | components for any particular | modify. Examples of |
| | | Components | customer. | components are: wells, |
| | | | | well bays, headers, |
| | | | | pumps, compressors, |
| | | | | etc. |
| U007 | Setup | Setup | The action of initially setting | Same as above |
| | | Platform | up the platform components, | |
| | | Components | for any specified customer, | |
| | | Information | based on blueprints and | |
| | | | drawings. | |
| U008 | Setup & | ESD/TSE | The ESD stations and TSE | ESD = Emergency Shut |
| | Customer | | location will be input during | Down; TSE = |
| | | | the platform setup. The | Temperature Safety |
| | | | customer will update the date | Element |
| | | | that the ESD stations are tested | |
| U009 | Setup | Maintain | The action of updating | Setup can specify which |
| | | Platform | platform information based on | customer information to |
| | | | customer input (management | modify. |
| | | | of Change—MOC). | |
| U010 | Setup | Modify | The action of modifying the | Same as above |
| | | Platform | number of platform | |
| | | Components | components for any given | |
| | | | customer. | |
| U011 | Setup | Modify | The action of modifying the | Same as above |
| | | Platform | platform component | |
| | | Components | information, for any given | |
| | | Information | customer. | |
| U012 | Setup | Archive | The action of deleting a | The platform will |
| | | Platform | specific platform and all | simply be flagged as |
| | | | associated information from | non-display, but all |
| | | | reports and inputs for any | records and history will |
| | | | customer. | still exist in the |
| | | | | database. |
| U013 | Setup | Configure | The action of setting up an | Utilize Fax or mail to |
| | | Account for | account for customers who | receive MMS testing |
| | | non-Internet | have platforms without internet | data, utilize “fax back” |
| | | data input | access | to provide MMS forms |
| | | | | to user |
| U014 | Customer | Access | The action of accessing the | User must enter a valid |
| | & | Application | application. | username/password |
| | Customer | | | combination. |
| | Manager | | | |
| U015 | Customer | Update | The action of updating a | Customer can only |
| | | Platform | platform, or many platforms. | update platform |
| | | | | information that they |
| | | | | “own”. The customer |
| | | | | can request personnel |
| | | | | update the platform |
| | | | | information. The |
| | | | | customer can only input |
| | | | | test data. |
| U016 | Customer | Update | The action of updating a | Same as above |
| | | Platform | platform, or many platforms, | |
| | | Component | component information. | |
| | | Information | | |
| U017 | Customer | Request | The action of sending a request | Simple email form will |
| | & | Platform | to administrative or setup | suffice |
| | Customer | Modification | personnel for modifications to | |
| | Manager | | a platform or platform | |
| | | | components. | |
| U018 | Customer | Print Blank | The action a customer takes to | Required for customer |
| | | Forms | print a blank MMS form | usability |
| U019 | Customer | Report | The action of printing any page | Printed pages should fit |
| | & | Platform | of information specific to the | on landscaped, 8 ½″ × 14″ |
| | Customer | Information | platform or platform | page. |
| | Manager | | components. | If 8 ½″ × 14″ paper |
| | | | -or- printing | is unavailable, standard |
| | | | completed report | 8 ½ × 11″ paper is also |
| | | | | supported |
| U020 | Customer | Request | The action of requesting more | |
| | & | General | information from Thompson | |
| | Customer | Information | and Ricks. | |
| | Manager | | | |
| U021 | Customer | Provide | The action of providing | |
| | & | Feedback | feedback to Thompson and | |
| | Customer | | Ricks regarding the web site | |
| | Manager | | and application. | |
| U22 | System | Perform | The action of performing error | Any input that is |
| | | Error | checking on identified fields or | formula based or has |
| | | Checking | values. | error checking involved |
| | | | | will be verified, and if |
| | | | | an error does occur, a |
| | | | | simple human- |
| | | | | understandable error |
| | | | | message displayed. If |
| | | | | the Error is a MMS |
| | | | | reportable error, the |
| | | | | customer will not be |
| | | | | allowed to proceed until |
| | | | | the error is corrected. If |
| | | | | the error is not MMS |
| | | | | reportable, a warning |
| | | | | will be displayed. |
| U23 | System | Email at | The action of automatically | In Development |
| | | Update | emailing a customer when | |
| | | Interval | information requires updates. | |
| U24 | System | Generate | The action of generating a | Setup personnel or |
| | | Password | random password for a | admin will give |
| | | | customer. | passwords to customer |
| U25 | System | Maintain | The action of saving a record | |
| | | Historical | of all updates to a platform or | |
| | | Information | platform components. | |
| U26 | System | Personalize | The action of presenting | |
| | | Experience | personalized display options, | |
| | | | customer information, etc. | |
| U27 | System | Maintain | The action of saving inputs | |
| | | Historical | with input date for archival and | |
| | | Data | historical reporting purposes. | |
| U28 | System | Maintain | The action of maintaining an | |
| | | Platform | archive of online platform | |
| | | Drawings | drawings, and providing the | |
| | | | customers with the ability to | |
| | | | access the drawings | |
| U29 | System | Maintain | The action of maintaining an | Also referred to as e- |
| | | Platform | archive of online platform | library |
| | | Document- | documentation, and providing | |
| | | ation | the customers with the ability | |
| | | | to access the documents | |

The system contains three functional categories components; platform setup web pages, user input web pages, and the database. These components will be described below.

The Platform Setup web page component will be used by personnel to input the specific details of the equipment located on the users' individual platforms. The user are required to furnish the latest, MMS approved Safety Flow Charts as well as the latest Safety Analysis Function Evaluation Charts (SAFE Charts). If the aforementioned Charts are found to be nonexistent, deficient, or in conflict, then personnel will require an onsite visit by one or more of its technical representatives in order to resolve all outstanding issues of potential nonexistence. Certain personnel will always have the authority and privileges to correct and update the platform production process model as required by the user. The specific data entered during the setup process is stored in the database component. The platform setup web pages are built to comply with Active Server Pages 3.0™(ASP 3.0).

The second component, Database, is a Microsoft® SQL 2000 database. A distinct database table exists for every classification of equipment. The database will be located on the web host computer. A detailed description of the Individual tables is defined in a subsequent section

The third component is the User Input web pages. These pages are generated dynamically at least every month, upon user login, based upon the information input into the database during the platform setup part of the process. The users are able to input their monthly Mineral Management Service (“MMS”) testing information into these web pages. When the user has completed filling out one of these web pages, they will submit the page for error checking. Any entered values that are in error will be flagged as being in error at that time. If the values entered are not in error, a web page will be displayed that the users dan print out for their records. The user input web pages are ASP 3.0 compliant. ASP 3.0 allows web pages to be built with active content (dynamic), and allows scripts to be embedded in the web pages. The error checking functions within the system will be handled using Java scripting. Both the user input web pages and the setup web pages are to be hosted on a web server that runs ASP 3.0 compliant software, and utilize Microsoft® IIS (Internet Information Service). The web server utilizes the Windows 2000® Operating system. Security will be provided via a Verisign® 128 bit Secure Sockets Layer (SSL) technology. All three of these technologies are available as common e-commerce application tools.

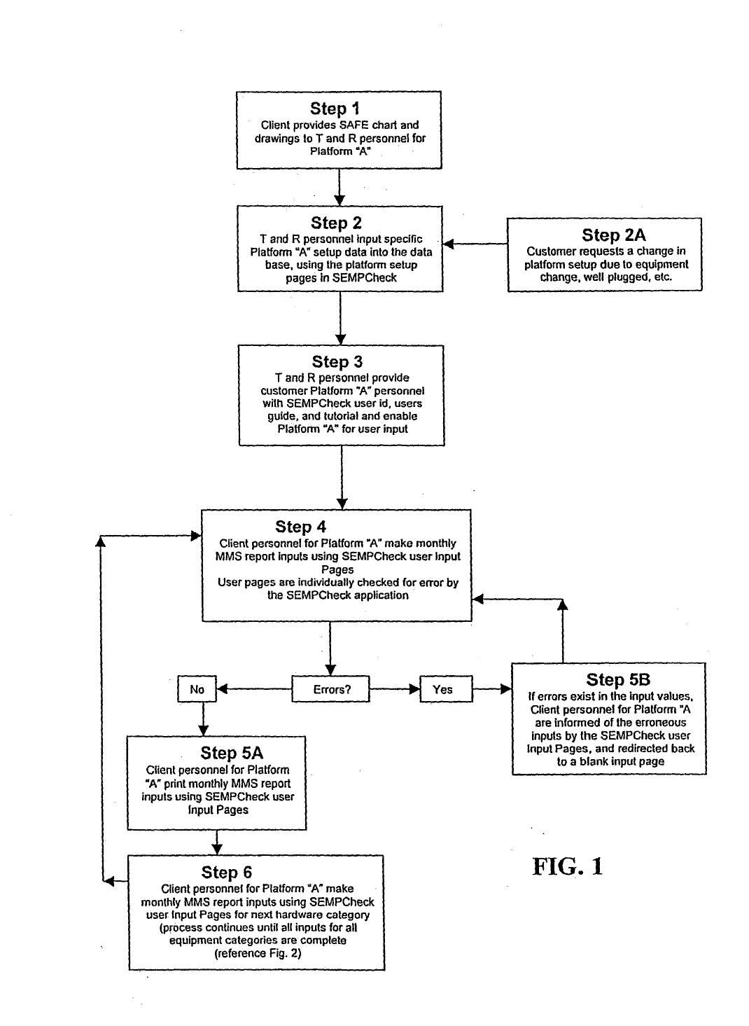

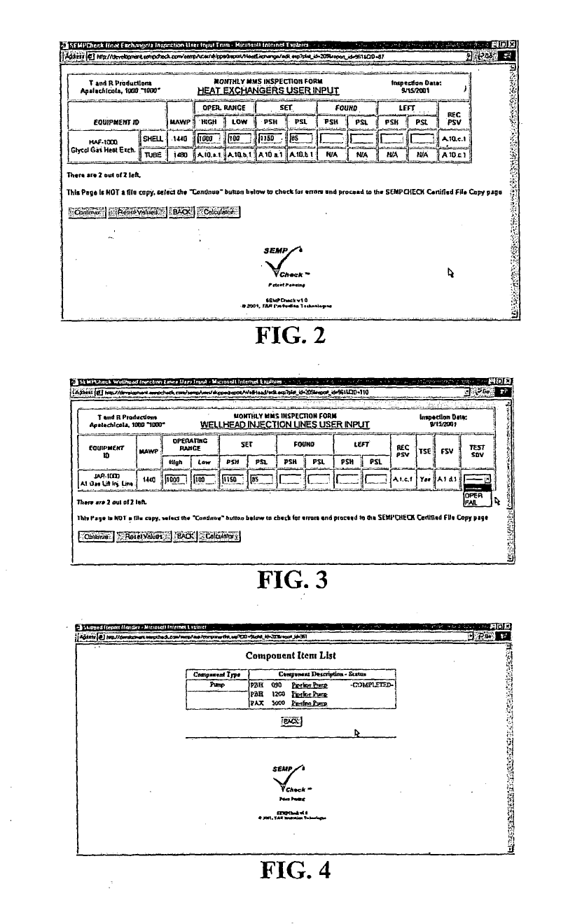

In addition to the high level flow chart, the figures on the following pages show two examples of the many possible web pages. The flow chart shown in FIG. 1 illustrates in high level the process. Examples of representative user input pages are shown in FIGS. 2-3. Within this system, there may be application hosting.

The following preferences are preferable for the web host:

1. The system web site guaranteed up 99.95% of the time, 24 hrs a day, 7 days a week;

2. Secure web site SSL security with VeriSign™ 128-bit certificate;

3. ASP 3.0 compliant server solution utilizing Microsoft™ IIS (Windows 2000™ Hosting solution);

4. SQL 2000 database integration with web site;

5. Full Server and Database backups on a daily basis;

6. UPS/backup generator; and

7. Redundant paths to Internet backbone.

In addition, clients requirements may include Clients must have a recent version of Internet Explorer™ or Netscape Navigator™. To print reports, Internet Explorer™ version 5.5 or newer is required. Adobe Acrobat™ reader or a reader compatible with Adobe's PDF (Portable Document Format) is required to read and print the reports, which are created as PDF documents. At minimum, a printer capable of printing 8 ½″×11″ paper in Landscape orientation is required. It is preferred that the reports be printed on 8 ½″×14″ paper.

The following section described detailed feature information for the application. The platform setup pages are used to create the database model of the platform and populate the database with the equipment contained on the platform. A setup page exists for every component type. The Component types are by example, as follows: Platform Info; Well; Wellbay; Wellhead Injection Lines; Header; Pump; Compressor; Vessels (Atmospheric and Pressure); Pipeline; Heat Exchanger; Fired Components; ESD and TSE Stations; and/or Compliance Checklist. The user versions of these pages can be seen in the following sections. The platform setup pages are only used by personnel during the platform setup (or creation) process.

With reference to the Platform Setup Editing Pages, the following capabilities exist as a part of the setup editing process. Once a platform has been created, the capability exists to edit the equipment on that platform. For each component class (defined above) the capability exists to ADD a component, EDIT the information relating to a component, or REMOVE a component. In addition, the Compliance Checklist can be customized to display only those tests that are applicable to a specific platform. The setup editing pages provide personnel with a completely alternative way to set a platform up. A platform can be created, and then the components on that platform can be individually added, one at a time, instead of all at once using the platform setup pages. This provides two ways to set up a platform.

Setup personnel can edit the platform access list, and specify user access level for a platform. Users can be designated as “Read Only”, “Write”, or “Neither”. A “Read Only” can read reports, print reports, download drawings and documentation, but they cannot make any test inputs or create a new report. A “Write” user can do everything that the “Read Only” user can do, plus they can created a report and make test inputs. A “Neither” user cannot even see the platform, and has no rights.

Setup personnel can Delete or Remove reports for a platform. Note that removing a report does not remove the data from the database; it merely hides the report from the user. This allows Setup personnel the capability to unremove or undelete a report later on if needed.

Setup personnel can also upload platform drawings, and delete platform drawings as required. The setup personnel can upload e-library items, delete e-library items and edit the e-library categories if required.

The setup personnel can also customize several error checking mechanisms. This first is the ESD/TSE SSV shut in time and SCSSV shut in time. These times are the times that it takes to shut in the platform when an ESD station is activated, or a TSE is pulled. This process is similar to pulling the fire alarm. The standard (default) values for these two items are 45 seconds and 120 seconds. With larger deepwater platforms coming online every day, the MMS has begun to relax these requirements slightly on a case by vase basis. The setup editing pages allow the default values to be overwritten with custom values if required.

The second error checking mechanism is on the Wellbays. In certain instances, the error-checking requirement that checks the SITP (Shut In Tubing Pressure) against the Set and Left PSH (Pressure Safety High) can be disabled.

With regard to the User Input Pages shown in FIGS. 2-3, users can create a new report by logging on to the system, selecting the appropriate platform, and selecting the “Create New Report” option. In a preferred embodiment, there is some logic involved such that: A New Report Cannot be created until an Open report is finished; All Components on the platform must be completed before an open report can be completed; and/or the components can be filled out (completed in any order). If a report is in progress (a report was started but not finished), the “Create New Report” option will not be shown, and in its place, will be an option to “Complete Existing Report”.

When a user selects “Create New Report”, they are first directed to the cover page, where the only inputs are the report test date and the inspected by names. From that point, the users are directed to a page showing all the component categories. The user can fill out the test data in any order they wish. Users are not obligated to fill out the entire report during a session; they can fill out one component at a time or fill out the entire report at once. If a user only completes part of the report, the system retains knowledge of the components tested and Untested, and indicates which have been completed with a “Completed” comment beside the component name of the component listing page. In this manner it is instantly apparent which components have been completed and which have not been completed. FIG. 4 shows a typical component page with one of 3 components completed.

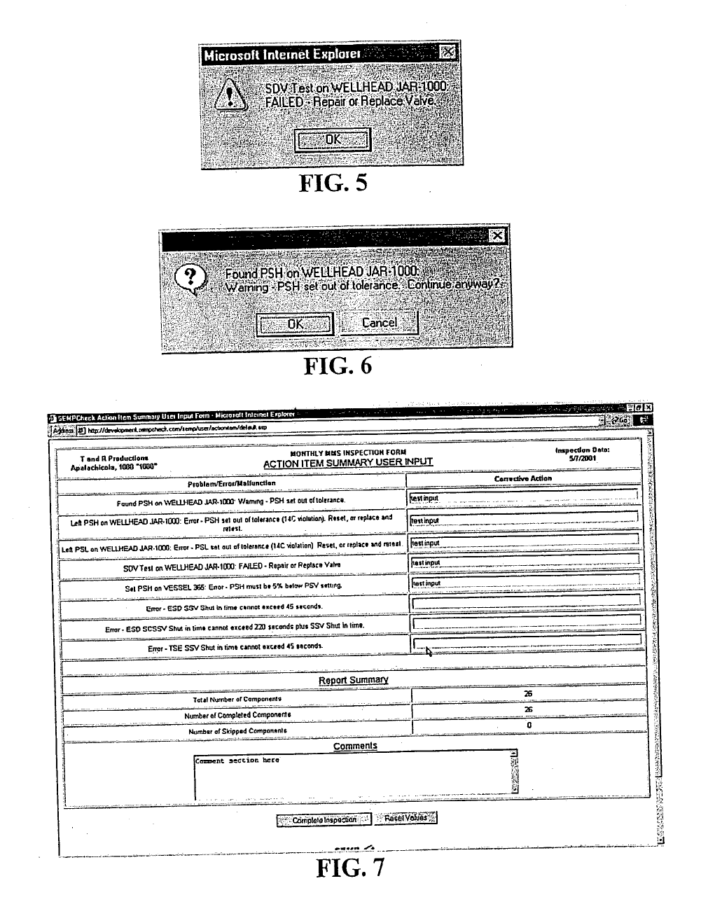

Referring to FIG. 4, a Component Completion Status, all user input is proactively error checked when each component page is submitted. If any errors or out of tolerance condition exists, the system displays a popup window that describes the error in simple, easy to understand terms and suggests the corrective action. All error messages generated in this fashion are captured in the Action Item Summary. FIG. 5 shows an example of a user generated error. Note that the page and test data is not submitted to the database while the error condition exists. This feature prevents the submission of erroneous data and requires that all input pass the compliance error checks.

In addition to the errors mentioned above, certain conditions will generate warnings. A warning is not a compliance violation, but a proactive indication that a component is set close to a tolerance or out of tolerance, but in an acceptable range. All warnings are also captured on the action item summary, but the user has the option of accepting the warning condition and proceeding with the input conditions that generated the warning. FIG. 6 shows a typical warning popup window, and FIG. 7 shows the Action Item Summary.

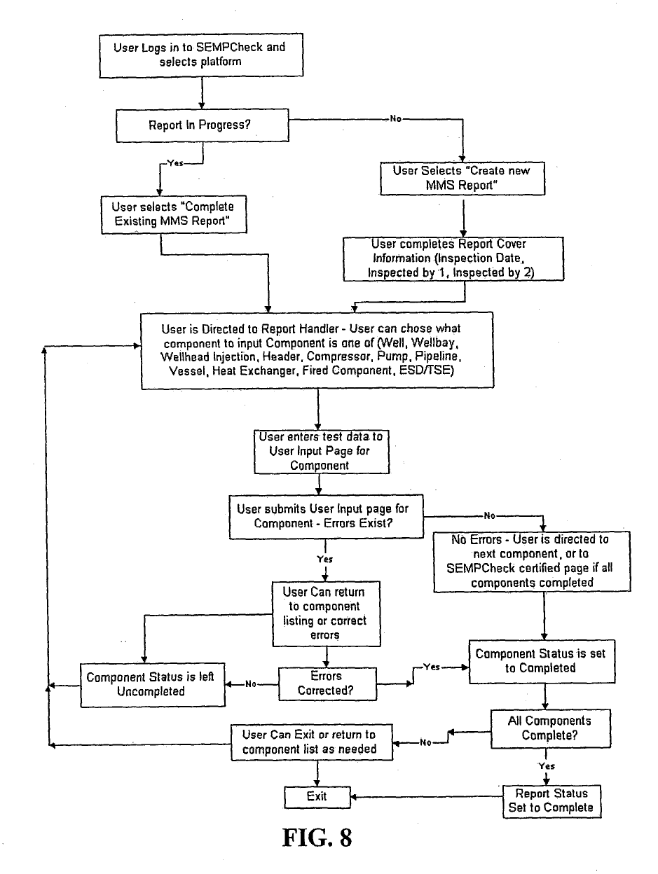

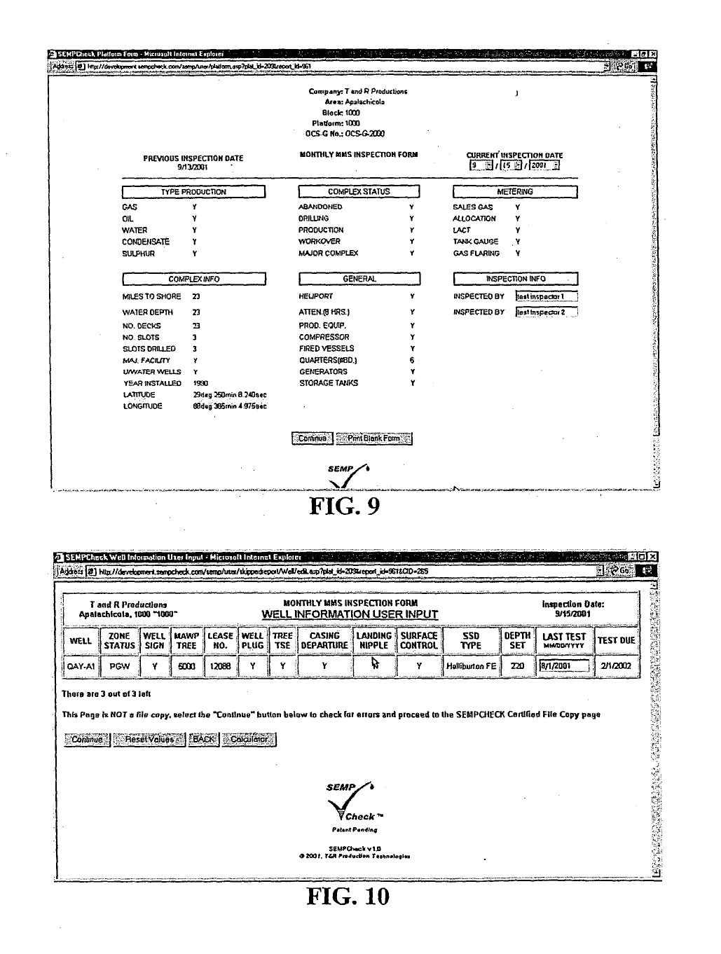

The preferred embodiment for the user report process is shown in FIG. 8. The component testing pages that relate to the user report process are discussed herein. With regard to the MMS Component Testing Pages, a Cover Page for the Platform Setup is encountered similar to the one shown in FIG. 9. The platform setup data page only has three user inputs, The Inspection Date, and the Two Persons performing the inspection. Personnel input the rest of the data on this page to the database during the platform setup process. The only data validation (or error checking) in to ensure that the Report date is a valid date (no future dates are allowed), and that the “Inspected By” inputs are filled out.

A departure is an approved exception from the regulations. The departures page typically will not have any error checking or user input fields. All values typically will be input by personnel. Preferably, any changes to the departure page are to be made by personnel. The departure page prints as a page in the report.

As shown in FIG. 10, the well information page will contain pertinent information for all wells on the platform. The following table shows all the fields for the well information, and the acceptable values for each field. The only error-checking to ensure that the well SSD “Last Test” date is filled out and is a valid date (no future date is allowed). As shown in FIG. 10, the Well Information User Input Page shows information related to the monthly MMS inspection form and allows for entry of the last test data.

TABLE 4
FIELDS FOR WELL INFORMATION

| | | Setup or | | |
|---|---|---|---|---|
| Parameter | | User | Error | Other |
| Name | Acceptable Values | Input | Checking | Calculations |
| Well | QAY-XXXX, where | S | None | None |
| | XXXX is the well | | | |
| | number | | | |
| Zone | PGW, POW, S/I GW, S/I | S | None | None |
| Status | OW, GLO, GLG | | | |
| Well Sign | Yes, No | S | None | None |
| MAWP Tree | Number input during | S | None | None |
| | setup | | | |
| Lease No. | Number input during | S | None | None |
| | setup | | | |
| Well Plug | Yes, No | S | None | None |
| Tree TSE | Yes, No | S | None | None |
| Casing | Yes, No | S | None | None |
| Departure | | | | |
| Landing | Yes, No | S | None | None |
| Nipple | | | | |
| Surface | Yes, No | S | None | None |
| Control | | | | |
| SSD Type | Text Input During Setup | S | None | None |
| Depth Set | Number input during | S | None | None |
| | setup | | | |
| Last Test | Number (Date) User | U | Format | None |
| | Input | | | |
| Test Due | Number (Date) | S | None | 6 or 12 months |
| | computation | | | from Last Test |
| | | | | based on Setup |
| | | | | Parameter |

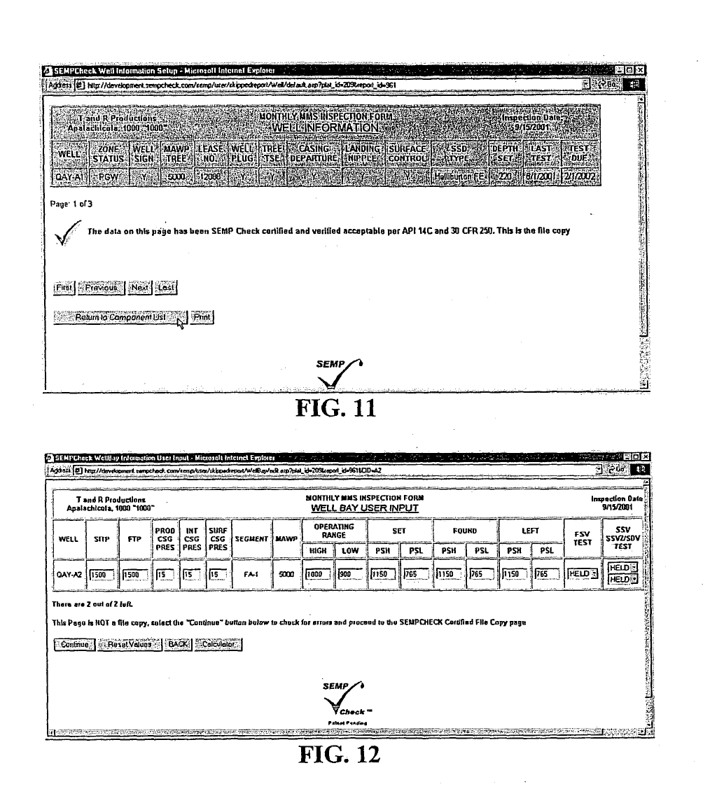

Turning to FIG. 11, the file copy of the monthly MMS inspection form is shown. In addition to the information shown, the user may return to the component list, print, or view additional information.

Referring to FIG. 12, a Well Bay Information Page is shown. The Well Bay Information page contains information pertinent to the Well Bays. There is a combination of setup data and user input data on this page. The User Input data will be error checked. The Following Table defines the input fields, acceptable values and error checking for the Well Bay pages.

TABLE 5
WELL BAY PAGES FIELDS

| | | Setup | | |
|---|---|---|---|---|
| | | or | | |
| Parameter | | User | Error | Other |
| Name | Acceptable Values | Input | Checking | Calculations |
| Well | QAY-XXXX, where XXXX | S | None | None |
| | is the well number | | | |
| SITP | User Input number | U | None | None |
| FTP | User Input number | U | None | None |
| Prod CSG | User Input number/Setup Input | U | Yes - | None |
| Press | “Departure” | | cannot | |
| | | | be >99 | |
| Int CSG | | U | | None |
| Press | | | | |
| Surf CSG | User Input number/Setup Input | U | Yes - | None |
| Press | “Departure” | | cannot | |
| | | | be >200 | |
| Segment | FA1, FA2, FA3 | S | None | None |
| MAWP | Setup Input number | S | None | None |
| Op Range | If User - number, If Setup - | U/S | Y for | None |
| High | A.1.a.1, A.1.a.2, N/A, Dep., | | User | |
| | O.O.S. | | | |
| Op Range | If User - number, If Setup - | U/S | Y for | None |
| Low | A.1.b.1, A.1.b.2, N/A, Dep., | | User | |
| | O.O.S. | | | |
| Set PSH1 | If User - number, If Setup - | U/S | Y for | None |
| | A.1.a.1, A.1.a.2, N/A, Dep., | | User | |
| | O.O.S. | | | |
| Set PSH2 | If User - number, If Setup - | U/S | Y for | None |
| | A.1.a.1, A.1.a.2, N/A, Dep., | | User | |
| | O.O.S. | | | |
| Set PSL | If User - number, If Setup - | U/S | Y for | None |
| | A.1.b.1, A.1.b.2, N/A, Dep., | | User | |
| | O.O.S. | | | |
| Found | If User - number, If Setup - | U/S | Y for | None |
| PSH1 | N/A, Dep., O.O.S. | | User | |
| Found | If User - number, If Setup - | U/S | Y for | None |
| PSH2 | N/A, Dep., O.O.S. | | User | |
| Found | If User - number, If Setup - | U/S | Y for | None |
| PSL | N/A, Dep., O.O.S. | | User | |
| Left | If User - number, If Setup - | U/S | Y for | None |
| PSH1 | N/A, Dep., O.O.S. | | User | |
| Left | If User - number, If Setup - | U/S | Y for | None |
| PSH2 | N/A, Dep., O.O.S. | | User | |
| Left PSL | If User - number, If Setup - | U/S | Y for | None |
| | N/A, Dep., O.O.S. | | User | |
| FSV Test | If User - either Held or Leak | U/S | Y for | None |
| | (only 2 choices) | | User | |
| | If Setup - A.1.d.1, A.1.d.2, N/A, | | | |
| | Dep., O.O.S. | | | |
| SSV Test | If User - either Held or Leak | U/S | Y for | None |
| | (only 2 choices) | | User | |
| | If Setup - N/A, Dep., O.O.S. | | | |
| SDV Test | If User - either Held or Leak | U/S | Y for | None |
| | (only 2 choices) | | User | |
| | If Setup - N/A, Dep., O.O.S. | | | |
| Rec PSV | If User - Number | U/S | Y for | None |
| | If Setup - A.1.c.1, A.1.c.2, | | User | |
| | A.1.c.3, A.1.c.4, A.1.c.5, N/A, | | | |
| | Dep, O.O.S. | | | |

The following table describes the error checking for the user parameters that are affected. In addition to the specific formulas below, no user entry field can be left blank.

TABLE 6
ERROR CHECKING FOR THE USER PARAMETERS

| Parameter | Error checking | |
|---|---|---|
| Name | formula | Error message |
| Prod CSG | Not Greater than 99 | Warning - Diagnostic Casing Pressure survey |
| Press | | should be performed if no departure on file. |
| Surf CSG | Not Greater than 200 | Warning - Diagnostic Casing Pressure survey |
| Press | | should be performed if no departure on file. |
| Op Range | Must be (mb) > Op | Error - Operating Range High must be greater |
| High | Range Low | than Operating Range Low |
| Op Range | Must be (mb) < Op | Error - Operating Range Low must be less than |
| Low | Range High | Operating Range High |
| Set PSH | 1) Not Greater than | 1) Error - PSH set out of tolerance (14C |
| | 1.15 × Op Range High | violation) |
| | rounded down to nearest | |
| | whole number - or - Op | |
| | Range Hi + 5 If Op | |
| | Range High less than | |
| | 33.33 | 2) Warning - PSH set less than the 15% allowed |
| | 2) Not Less than 1.15 × | |
| | Op Range High rounded | |
| | down to nearest whole | |
| | number - or - Op | 3) Error - PSH must be set significantly below |
| | Range Low − 5 If Op | SITP |
| | Range Low < 33.33 | |
| | | 4) Error - PSH must be 5% below PSV setting |
| | 3) Not Greater than | |
| | 0.85 × SITP | |
| | 4) Not Greater than | |
| | 0.95 × Rec. PSV setting | |
| Set PSL | 1) Not Less than 0.85 × | 1) Error - PSL set out of tolerance (14C |
| | Op Range Low rounded | violation) |
| | up to nearest whole | |
| | number - or - Op | |
| | Range Hi + 5 If Op | |
| | Range High < 33.33 | |
| | | 2) Warning - PSL set less than the 15% allowed |
| | 2) Not Greater than | |
| | 0.85 × Op Range Low | |
| | rounded up to nearest | |
| | whole number - or - Op | |
| | Range Low − 5 If Op | |
| | Range Low < 33.33 | |
| Found PSH | Same as set PSH 1), 2), | |
| | 3) above | |
| Found PSL | Same as set PSL above | |
| Left PSH | Same as set PSH 1), 2), | |
| | 3) above | |
| Left PSL | Same as set PSL above | |
| FSV | If “Leak” Selected | Error - Repair or Replace Valve |
| SSV | If “Leak” Selected | Error - Repair or Replace Valve |
| SDV | If “Leak” Selected | Error - Repair or Replace Valve |
| Rec. PSV | Not Greater than | Error - PSV Set Pressure should not exceed |
| | MAWP | MAWP |

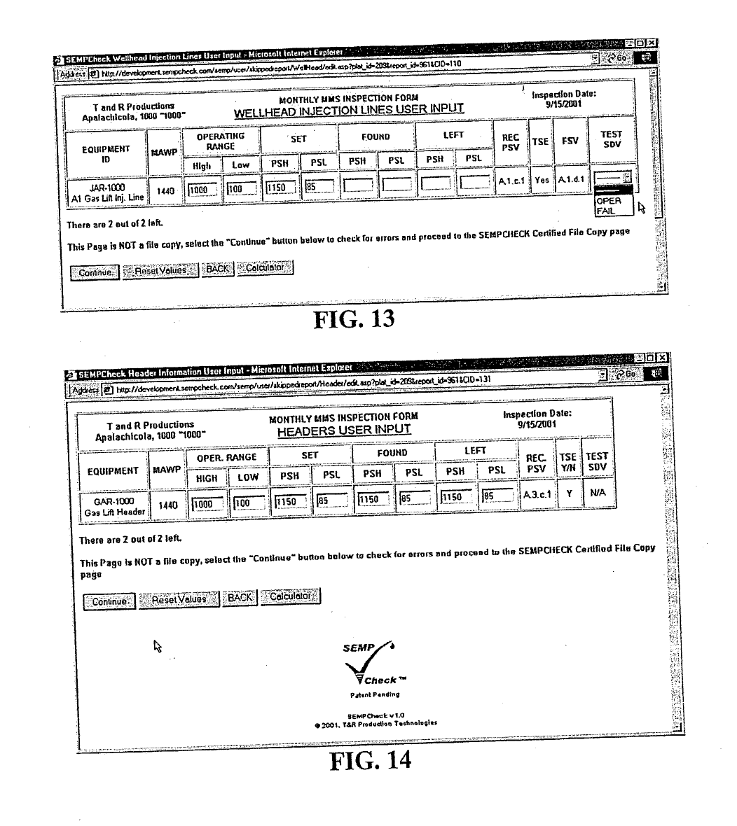

Turning to FIG. 13, the Well Head Injection Lines Information Page is shown. As depicted, allows for the information in several fields. The Wellhead Injection Lines page contains information pertinent to the Well Head Injection Lines. As with the Well Bay, there is a combination of setup data and user input data on this page. The User Input data will be error checked. The Following Table defines the input fields, acceptable values and error checking for the Well Head Injection Lines pages.

TABLE 7
WELL HEAD INJECTION LINES FIELDS

| | | Setup | | |
|---|---|---|---|---|
| | | or | | |
| Parameter | | User | Error | Other |
| Name | Acceptable Values | Input | Checking | Calculations |
| Equipment | Setup text | S | None | None |
| ID | | | | |
| Equipment | Setup text | S | None | None |
| Desc. | | | | |
| MAWP | Setup number | S | None | None |
| Op Range | If User - number, If | U/S | Y for | None |
| High | Setup - A.2.a.1, A.2.a.2, | | User | |
| | N/A, Dep., O.O.S. | | | |
| Op Range | If User - number, If | U/S | Y for | None |
| Low | Setup - A.2.b.1, A.2.b.2, | | User | |
| | N/A, Dep., O.O.S. | | | |
| Set PSH | If User - number, If | U/S | Y for | None |
| | Setup - A.2.a.1, A.2.a.2, | | User | |
| | N/A, Dep., O.O.S. | | | |
| Set PSL | If User - number, If | U/S | Y for | None |
| | Setup - A.2.b.1, A.2.b.2, | | User | |
| | N/A, Dep., O.O.S. | | | |
| Found PSH | If User - number, If | U/S | Y for | None |
| | Setup -N/A, Dep., | | User | |
| | O.O.S. | | | |
| Found PSL | If User - number, If | U/S | Y for | None |
| | Setup -N/A, Dep., | | User | |
| | O.O.S. | | | |
| Left PSH | If User - number, If | U/S | Y for | None |
| | Setup -N/A, Dep., | | User | |
| | O.O.S. | | | |
| Left PSL | If User - number, If | U/S | Y for | None |
| | Setup -N/A, Dep., | | User | |
| | O.O.S. | | | |
| Rec PSV | If User - Number | U/S | Y for | None |
| | If Setup - A.2.c.1, | | User | |
| | A.2.C.2, A.2.C.3, N/A, | | | |
| | Dep, O.O.S. | | | |
| TSE | Setup - Y, N, N/A, | S | None | None |
| | O.O.S., Dep. | | | |
| FSV Test | If User - either Held or | U/S | Y for | None |
| | Leak (only 2 choices) | | User | |
| | If Setup - A.2.d.1, N/A, | | | |
| | Dep., O.O.S. | | | |
| SDV Test | If User - either Held or | U/S | Y for | None |
| | Leak (only 2 choices) | | User | |
| | If Setup - N/A, Dep., | | | |
| | O.O.S. | | | |

The following table describes the error checking for the user parameters that are affected. In addition to the specific formulas below, no user entry field can be left blank.

TABLE 8
ERROR CHECKING FOR THE USER PARAMETERS

| Parameter | | |
|---|---|---|
| Name | Error checking formula | Error message |
| Op Range | Must be (mb) > Op Range | Error - Operating Range High |
| High | Low | must be greater than Operating |
| | | Range Low |
| Op Range | Must be (mb) < Op Range | Error - Operating Range Low |
| Low | High | must be less than Operating |
| | | Range High |
| Set PSH | 1) Not Greater than 1.15 × Op | 1) Error - PSH set out of |
| | Range High rounded down to | tolerance (14C violation) |
| | nearest whole number - or - | |
| | Op Range Hi + 5 If Op Range | |
| | High less than 33.33 | |
| | 2) Not Less than 1.15 × Op | 2) Warning - PSH set less than |
| | Range High rounded down to | the 15% allowed |
| | nearest whole number - or - | |
| | Op Range Low − 5 If Op | |
| | Range Low < 33.33 | |
| | 3) Not Greater than 0.95 × | 3) Error - PSH must be 5% |
| | Rec. PSV setting | below PSV setting |
| Set PSL | 1) Not Less than 0.85 × Op | 1) Error - PSL set out of |
| | Range Low rounded up to | tolerance (14C violation) |
| | nearest whole number - or - | |
| | Op Range Hi + 5 If Op Range | |
| | High < 33.33 | |
| | 2) Not Greater than 0.85 × Op | 2) Warning - PSL set less than |
| | Range Low rounded up to | the 15% allowed |
| | nearest whole number - or - | |
| | Op Range Low − 5 If Op | |
| | Range Low < 33.33 | |
| Found PSH | Same as set PSH above | |
| Found PSL | Same as set PSL above | |
| Left PSH | Same as set PSH above | |
| Left PSL | Same as set PSL above | |
| Rec. PSV | Not Greater than MAWP | Error - PSV Set Pressure should |
| | | not exceed MAWP |
| FSV | If “Leak” Selected | Error - Repair or Replace Valve |
| SDV | If “Leak” Selected | Error - Repair or Replace Valve |

With reference to FIG. 14, the Headers Information Page is shown. The Headers page contains information pertinent to the platforms headers. There is a combination of setup data and user input data on this page. The User Input data will be error checked. The Following Table defines the input fields, acceptable values and error checking for the Headers pages.

TABLE 9
FIELDS FOR THE HEADERS PAGES

| | | Setup | | |
|---|---|---|---|---|
| | | or | | |
| Parameter | | User | Error | Other |
| Name | Acceptable Values | Input | Checking | Calculations |
| Equipment | Setup text | S | None | None |
| ID | | | | |
| Equipment | Setup text | S | None | None |
| Desc. | | | | |
| MAWP | Setup number | S | None | None |
| Op Range | If User - number, If | U/S | Y for | None |
| High | Setup - A.3.a.1, A.3.a.2, | | User | |
| | A.3.a.3, A.3.a.4, N/A, | | | |
| | Dep., O.O.S. | | | |
| Op Range | If User - number, If | U/S | Y for | None |
| Low | Setup - A.3.b.1, A.3.b.2, | | User | |
| | A.3.b.3, N/A, Dep., | | | |
| | O.O.S. | | | |
| Set PSH | If User - number, If | U/S | Y for | None |
| | Setup - A.3.a.1, A.3.a.2, | | User | |
| | A.3.a.3, A.3.a.4, N/A, | | | |
| | Dep., O.O.S. | | | |
| Set PSL | If User - number, If | U/S | Y for | None |
| | Setup - A.3.b.1, A.3.b.2, | | User | |
| | A.3.b.3, N/A, Dep., | | | |
| | O.O.S. | | | |
| Found PSH | If User - number, If | U/S | Y for | None |
| | Setup -N/A, Dep., O.O.S. | | User | |
| Found PSL | If User - number, If | U/S | Y for | None |
| | Setup -N/A, Dep., | | User | |
| | O.O.S. | | | |
| Left PSH | If User - number, If | U/S | Y for | None |
| | Setup -N/A, Dep., | | User | |
| | O.O.S. | | | |
| Left PSL | If User - number, If | U/S | Y for | None |
| | Setup -N/A, Dep., | | User | |
| | O.O.S. | | | |
| Rec PSV | If User - Number | U/S | Y for | None |
| | If Setup - A3.c.1, | | User | |
| | A.3.c.2, A.3.c.3, A.3.c.4, | | | |
| | A.3.c.5, A.3.c.6, N/A, | | | |
| | Dep, O.O.S. | | | |
| TSE | Setup - Y, N, N/A, | S | None | None |
| | O.O.S., Dep. | | | |
| SDV Test | If User - either Held or | U/S | Y for | None |
| | Leak (only 2 choices) | | User | |
| | If Setup - N/A, Dep., | | | |
| | O.O.S. | | | |

The following table describes the error checking for the user parameters that are affected. In addition to the specific formulas below, no user entry field can be left blank.

TABLE 10
ERROR CHECKING FOR THE HEADERS PARAMETERS

| Parameter | | |
|---|---|---|
| Name | Error checking formula | Error message |
| Op Range | Must be (mb) > Op Range | Error - Operating Range High |
| High | Low | must begreater than Operating |
| | | Range Low |
| Op Range | Must be (mb) < Op Range | Error - Operating Range Low |
| Low | High | must be less than Operating |
| | | Range High |
| Set PSH | 1) Not Greater than 1.15 × Op | 1) Error - PSH set out of |
| | Range High rounded down to | tolerance (14C violation) |
| | nearest whole number - or - | |
| | Op Range Hi + 5 If Op Range | |
| | High less than 33.33 | |
| | 2) Not Less than 1.15 × Op | 2) Warning - PSH set less than |
| | Range High rounded down to | the 15% allowed |
| | nearest whole number - or - | |
| | Op Range Low − 5 If Op | |
| | Range Low < 33.33 | |
| | 3) Not Greater than 0.95 × | 3) Error - PSH must be 5% |
| | Rec. PSV setting | below PSV setting |
| Set PSL | 1) Not Less than 0.85 × Op | 1) Error - PSL set out of |
| | Range Low rounded up to | tolerance (14C violation) |
| | nearest whole number - or - | |
| | Op Range Hi + 5 If Op Range | |
| | High < 33.33 | |
| | 2) Not Greater than 0.85 × Op | 2) Warning - PSL set less than |
| | Range Low rounded up to | the 15% allowed |
| | nearest whole number - or - | |
| | Op Range Low − 5 If Op | |
| | Range Low < 33.33 | |
| Found PSH | Same as set PSH above | |
| Found PSL | Same as set PSL above | |
| Left PSH | Same as set PSH above | |
| Left PSL | Same as set PSL above | |
| Rec. PSV | Not Greater than MAWP | Error - PSV Set Pressure should |
| | | not exceed MAWP |
| SDV Test | If “Leak” Selected | Error - Repair or Replace Valve |

The Pipelines page, shown in FIG. 15, contains information pertinent to the platforms pipelines. There is a combination of setup data and user input data on this page. The User Input data will be error checked. The Following Table defines the input fields, acceptable values and error checking for the pipelines pages.

TABLE 11
FIELDS FOR PIPELINES PAGES

| | | Setup | | |
|---|---|---|---|---|
| | | or | | |
| Parameter | Acceptable | User | Error | Other |
| Name | Values | Input | Checking | Calculations |
| Equipment ID | Setup text | S | None | None |
| Equipment | Setup text | S | None | None |
| Desc. | | | | |
| MAWP | Setup number | S | None | None |
| Op Range High | If User - number, | U/S | Y for | None |
| | If Setup - A.9.a.1, | | User | |
| | A.9.a.2, A.9.a.3, | | | |
| | A.9.a.4, N/A, | | | |
| | Dep., O.O.S. | | | |
| Op Range Low | If User - number, | U/S | Y for | None |
| | If Setup - A.9.b.1, | | User | |
| | A.9.b.2, A.9.b.3, | | | |
| | A.9.b.4, N/A, | | | |
| | Dep., O.O.S. | | | |
| Set PSH | If User - number, | U/S | Y for | None |
| | If Setup - A.9.a.1, | | User | |
| | A.9.a.2, A.9.a.3, | | | |
| | A.9.a.4, N/A, | | | |
| | Dep., O.O.S. | | | |
| Set PSL | If User - number, | U/S | Y for | None |
| | If Setup - A.9.b.1, | | User | |
| | A.9.b.2, A.9.b.3, | | | |
| | A.9.b.4, N/A, | | | |
| | Dep., O.O.S. | | | |
| Found PSH | If User - number, | U/S | Y for | None |
| | If Setup -N/A, | | User | |
| | Dep., O.O.S. | | | |
| Found PSL | If User - number, | U/S | Y for | None |
| | If Setup -N/A, | | User | |
| | Dep., O.O.S. | | | |
| Left PSH | If User - number, | U/S | Y for | None |
| | If Setup -N/A, | | User | |
| | Dep., O.O.S. | | | |
| Left PSL | If User - number, | U/S | Y for | None |
| | If Setup -N/A, | | User | |
| | Dep., O.O.S. | | | |
| S/I ALL WELLS | User - Y, N, O.O.S, | S | N | None |
| | Dep. | | | |
| Rec PSV | If User - Number | U/S | Y for | None |
| | If Setup - A.9.c.1, | | User | |
| | A.9.c.2, A.9.c.3, | | | |
| | A.9.c.4, A.9.c.5, | | | |
| | N/A, Dep, O.O.S. | | | |
| REC PROD | Y, N, O.O.S., Dep. | S | N | None |
| DELV PROD | Y, N, O.O.S., Dep. | S | N | None |
| FSV | If User - Held or | U/S | Y for | None |
| | Leak (2 choices) If | | User | |
| | setup, - A.9.d.1, | | | |
| | A.9.d.2, A.9.d.3, | | | |
| | A.9.d.4, N/A, Dep., | | | |
| | O.O.S. | | | |
| SDV Test | Y, N, N/A, Dep., | S | N | None |
| | O.O.S. | | | |

The following table describes the error checking for the user parameters that are affected. In addition to the specific formulas below, no user entry field can be left blank.

TABLE 12
ERROR CHECKING FOR THE PIPELINES PARAMETERS

| | Error | |
|---|---|---|
| Parameter | checking | Error |
| Name | formula | message |
| Op Range | Must be (mb) > Op | Error - Operating Range |
| High | Range Low | High must be greater |
| | | than Operating Range Low |
| Op Range | Must be (mb) < Op | Error - Operating Range |
| Low | Range High | Low must be less than |
| | | Operating Range High |
| Set PSH | 1) Not Greater than | 1) Error - PSH set out |
| | 1.15 × Op Range High | of tolerance (14C violation) |
| | rounded down to nearest | |
| | whole number - or - | |
| | Op Range Hi + 5 If Op | |
| | Range High less than | |
| | 33.33 | |
| | 2) Not Less than | 2) Warning - PSH set |
| | 1.15 × Op Range High | less than the 15% allowed |
| | rounded down to nearest | |
| | whole number - or - Op | |
| | Range Low − 5 If Op | |
| | Range Low < 33.33 | |
| | 3) Not Greater than | 3) Error - PSH must be |
| | 0.95 × Rec. PSV | 5% below PSV setting |
| | setting | |
| Set PSL | 1) Not Less than | 1) Error - PSL set out |
| | 0.85 × Op Range Low | of tolerance (14C violation) |
| | rounded up to nearest | |
| | whole number - or - Op | |
| | Range Hi + 5 If Op | |
| | Range High < 33.33 | |
| | 2) Not Greater than | 2) Warning - PSL set |
| | 0.85 × Op Range Low | less than the 15% allowed |
| | rounded up to nearest | |
| | whole number - or - Op | |
| | Range Low − 5 If Op | |
| | Range Low < 33.33 | |
| Found PSH | Same as set PSH above | |
| Found PSL | Same as set PSL above | |
| Left PSH | Same as set PSH above | |
| Left PSL | Same as set PSL above | |
| Rec. PSV | Not Greater than MAWP | Error - PSV Set Pressure |
| | | should not exceed MAWP |
| FSV | If “Leak” Selected | Error - Repair or |
| | | Replace Valve and retest |

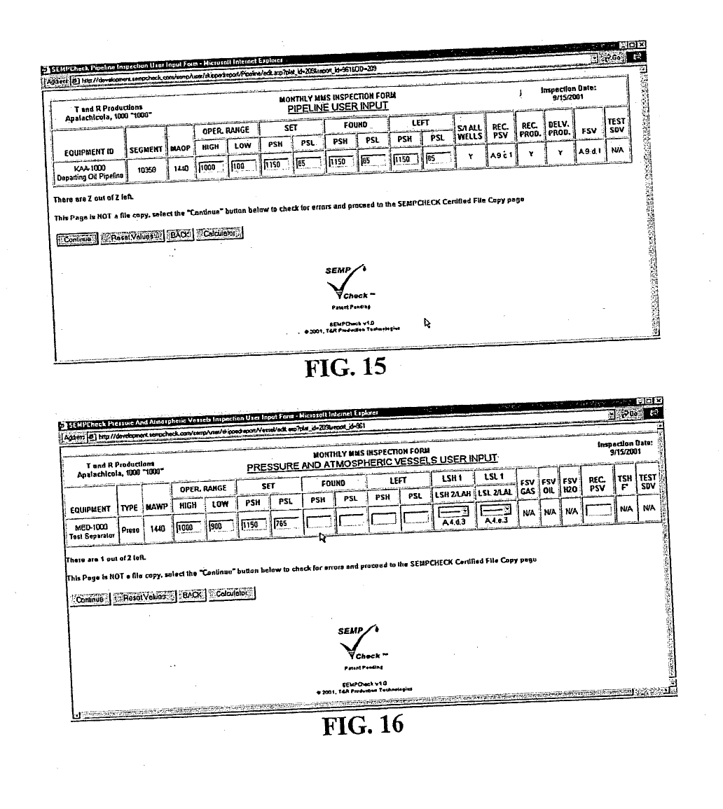

The Pressure and Atmospheric Vessels information page, shown in FIG. 16, contains information pertinent to the platforms vessels. There is a combination of setup data and user input data on this page. The User Input data will be error checked. The Following Table defines the input fields, acceptable values and error checking for the pipelines pages.

TABLE 13
FIELDS FOR VESSELS PAGES

| | | Setup | | |
|---|---|---|---|---|
| | | or | | |
| Parameter | Acceptable | User | Error | Other |
| Name | Values | Input | Checking | Calculations |
| Equipment ID | Setup text | S | None | None |
| Equipment | Setup text | S | None | None |
| Desc. | | | | |
| Type | Setup - either | S | N | If Type is |
| | Atmo or Press | | | Atmo, All |
| | | | | Operating |
| | | | | Range Hi/Low, |
| | | | | PSH, PSL |
| | | | | fields will |
| | | | | be N/A |
| MAWP | Setup number | S | None | None |
| Op Range High | If User - number | U/S | Y for | None |
| | (Input), If Setup - | | User | |
| | A.4.a.1, A.4.a.2, | | | |
| | A.4.a.3, A.4.a.4, | | | |
| | A.4.a.5, A.4.a.6, | | | |
| | N/A, Dep., O.O.S. | | | |
| Op Range Low | If User - number | U/S | Y for | None |
| | (Input), If Setup - | | User | |
| | A.4.b.1, A.4.b.2, | | | |
| | A.4.b.3, A.4.b.4, | | | |
| | A.4.b.5, N/A, Dep., | | | |
| | O.O.S. | | | |
| Set PSH | If User - number | U/S | Y for | None |
| | (Input), If Setup - | | User | |
| | A.4.a.1, A.4.a.2, | | | |
| | A.4.a.3, A.4.a.4, | | | |
| | A.4.a.5, A.4.a.6, | | | |
| | N/A, Dep., O.O.S. | | | |
| Set PSL | If User - number | U/S | Y for | None |
| | (Input), If Setup - | | User | |
| | A.4.b.1, A.4.b.2, | | | |
| | A.4.b.3, A.4.b.4, | | | |
| | A.4.b.5, N/A, Dep., | | | |
| | O.O.S. | | | |
| Found PSH | If User - number | U/S | Y for | None |
| | (Input), If Setup - | | User | |
| | N/A, Dep., O.O.S. | | | |
| Found PSL | If User - number | U/S | Y for | None |
| | (Input), If Setup - | | User | |
| | N/A, Dep., O.O.S. | | | |
| Left PSH | If User - number | U/S | Y for | None |
| | (Input), If Setup - | | User | |
| | N/A, Dep., O.O.S. | | | |
| Left PSL | If User - number | U/S | Y for | None |
| | (Input), If Setup - | | User | |
| | N/A, Dep., O.O.S. | | | |
| LSH1 | If User - number | U/S | Y for | None |
| | (Input), If Setup - | | User | |
| | A.4.d.1, A.4.d.2, | | | |
| | A.4.d.3, A.4.d.4, | | | |
| | A.5.c.1, A.5.c.2, | | | |
| | A.5.c.3, N/A, Dep, | | | |
| | O.O.S. | | | |
| LSL1 | If User - number | U/S | Y for | None |
| | (Input), If Setup - | | User | |
| | A.4.e.1, A.4.e.2, | | | |
| | A.4.e.3, A.5.d.1, | | | |
| | A.5.d.2, A.5.d.3, | | | |
| | A.5.d.4, N/A, Dep, | | | |
| | O.O.S. | | | |
| LSH2 | If User - number | U/S | Y for | None |
| | (Input), If Setup - | | User | |
| | A.4.d.1, A.4.d.2, | | | |
| | A.4.d.3, A.4.d.4, | | | |
| | A.5.c.1, A.5.c.2, | | | |
| | A.5.c.3, N/A, Dep, | | | |
| | O.O.S. | | | |
| LSL2 | If User - number | U/S | Y for | None |
| | (Input), If Setup - | | User | |
| | A.4.e.1, A.4.e.2, | | | |
| | A.4.e.3, A.5.d.1, | | | |
| | A.5.d.2, A.5.d.3, | | | |
| | A.5.d.4, N/A, Dep, | | | |
| | O.O.S. | | | |
| FSV Gas | If User - Held or | U/S | Y for | None |
| | Leak (2 choices) If | | User | |
| | setup, - A.4.f.1, | | | |
| | A.4.f.2, A.4.f.3, | | | |
| | N/A, Dep., O.O.S. | | | |
| FSV Oil | If User - Held or | U/S | Y for | None |
| | Leak (2 choices) If | | User | |
| | setup, - A.4.f.1, | | | |
| | A.4.f.2, A.4.f.3, | | | |
| | N/A, Dep., O.O.S. | | | |
| FSV H2O | If User - Held or | U/S | Y for | None |
| | Leak (2 choices) If | | User | |
| | setup, - A.4.f.1, | | | |
| | A.4.f.2, A.4.f.3, | | | |
| | N/A, Dep., O.O.S. | | | |
| Rec PSV 1 | If User - Number | U/S | Y for | None |
| | (Input) If Setup - | | User | |
| | A.4.c.1, A.4.c.2, | | | |
| | A.4.c.3, A.4.c.4, | | | |
| | A.4.c.5, A.4.c.6, | | | |
| | A.5.b.1, A.5.b.2, | | | |
| | A.5.b.3, A.5.b.4, | | | |
| | N/A, Dep, O.O.S. | | | |
| TSH F* | A.6.a.1, A.6.a.2, | S | N | None |
| | A.6.a.3, A.4.g.1, | | | |
| | A.4.g.2, A.4.g.3, | | | |
| | A.5.e.1, A.5.e.2, | | | |
| | A.5.e.3, N/A, | | | |
| | O.O.S., Dep. | | | |
| SDV Test | Y, N, N/A, Dep., | S | N | None |
| | O.O.S. | | | |
| Vent | Y, N, N/A, Dep., | S | N | None |
| | O.O.S. | | | |

The following table describes the error checking for the user parameters that are affected. In addition to the specific formulas below, no user entry field can be left blank.

TABLE 14
ERROR CHECKING FOR THE VESSELS PARAMETERS

| | Error | |
|---|---|---|
| Parameter | checking | Error |
| Name | formula | message |
| Op Range High | Must be (mb) > Op | Error - Operating Range |
| | Range Low | High must be greater |
| | | than Operating Range Low |
| Op Range Low | Must be (mb) < Op | Error - Operating Range |
| | Range High | Low must be less than |
| | | Operating Range High |
| Set PSH | 1) Not Greater than | 1) Error - PSH set out |
| | 1.15 × Op Range High | of tolerance (14C violation) |
| | rounded down to nearest | |
| | whole number - or - | |
| | Op Range Hi + 5 If Op | |
| | Range High less than | |
| | 33.33 | |
| | 2) Not Less than | 2) Warning - PSH set |
| | 1.15 × Op Range High | less than the 15% allowed |
| | rounded down to nearest | |
| | whole number - or - Op | |
| | Range Low − 5 If Op | |
| | Range Low < 33.33 | |
| | 3) Not Greater than | 3) Error - PSH must be |
| | 0.95 × Rec. PSV setting | 5% below PSV setting |
| Set PSL | 1) Not Less than | 1) Error - PSL set out |
| | 0.85 × Op Range Low | of tolerance (14C violation) |
| | rounded up to nearest | |
| | whole number - or - Op | |
| | Range Hi + 5 If Op | |
| | Range High < 33.33 | |
| | 2) Not Greater than | 2) Warning - PSL set |
| | 0.85 × Op Range Low | less than the 15% allowed |
| | rounded up to nearest | |
| | whole number - or - Op | |
| | Range Low − 5 If Op | |
| | Range Low < 33.33 | |
| Found PSH | Same as set PSH above | |
| Found PSL | Same as set PSL above | |
| Left PSH | Same as set PSH above | |
| Left PSL | Same as set PSL above | |
| LSH 1 | If “Fail” Selected | Error - Repair or |
| | | Replace Sensor and retest |
| LSL 1 | If “Fail” Selected | Error - Repair or |
| | | Replace Sensor and retest |
| LSH 2 | If “Fail” Selected | Error - Repair or |
| | | Replace Sensor and retest |
| LSL 2 | If “Fail” Selected | Error - Repair or |
| | | Replace Sensor and retest |
| FSV Oil | If “Leak” Selected | Error - Repair or |
| | | Replace Valve and retest |
| FSV Gas | If “Leak” Selected | Error - Repair or |
| | | Replace Valve and retest |
| FSV H2O | If “Leak” Selected | Error - Repair or |
| | | Replace Valve and retest |
| Rec. PSV 1 | Not Greater than MAWP | Error - PSV Set Pressure |
| | | should not exceed MAWP |
| Rec. PSV 2 | Not Greater than MAWP | Error - PSV Set Pressure |
| | | should not exceed MAWP |

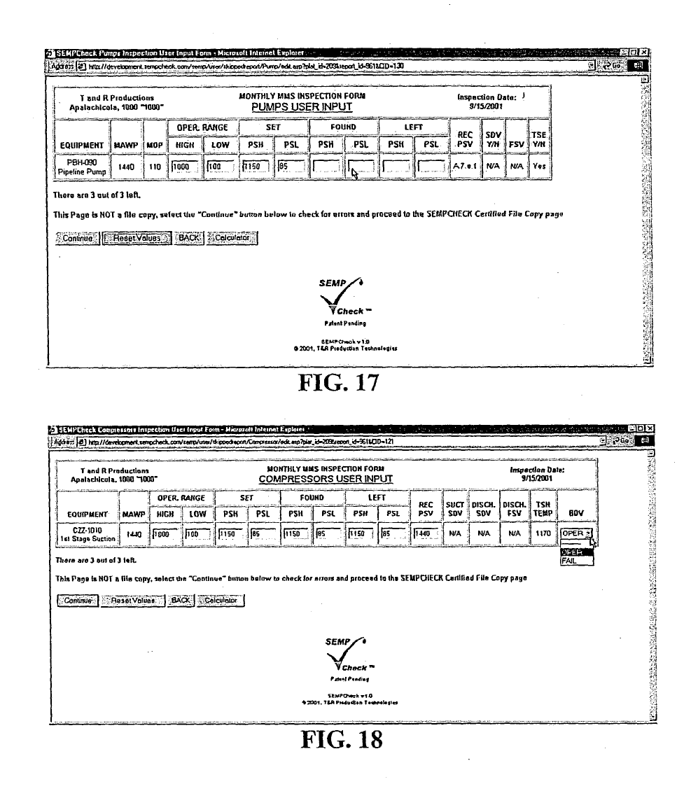

The Pumps page, shown in FIG. 17, contains information pertinent to the platforms pumps. There is a combination of setup data and user input data on this page. The User Input data will be error checked. The Following Table defines the input fields, acceptable values and error checking for the pumps pages.

TABLE 15
FIELDS FOR PUMPS PAGES

| | | Setup | | |
|---|---|---|---|---|
| | | or | | |
| Parameter | Acceptable | User | Error | Other |
| Name | Values | Input | Checking | Calculations |
| Equipment ID | Setup text | S | None | None |
| Equipment | Setup text | S | None | None |
| Desc. | | | | |
| MAWP | Setup number | S | None | None |
| MDP | Setup number | S | N | N |
| Op Range High | If User - number | U/S | Y for | None |
| | (Input), If Setup - | | User | |
| | A.7.a.1, A.7.b.1, | | | |
| | A.7.b.2, A.7.b.3, | | | |
| | A.7.b.4, A.7.b.5, | | | |
| | A.7.b.6, N/A, | | | |
| | Dep., O.O.S. | | | |
| Op Range Low | If User - number | U/S | Y for | None |
| | (Input), If Setup - | | User | |
| | A.7.c.1, A.7.c.2, | | | |
| | A.7.d.1, A.7.d.2, | | | |
| | A.7.d.3, A.7.d.4, | | | |
| | A.7.d.5, N/A, | | | |
| | Dep., O.O.S. | | | |
| Set PSH | If User - number | U/S | Y for | None |
| | (Input), If Setup - | | User | |
| | A.7.a.1, A.7.b.1, | | | |
| | A.7.b.2, A.7.b.3, | | | |
| | A.7.b.4, A.7.b.5, | | | |
| | A.7.b.6, N/A, | | | |
| | Dep., O.O.S. | | | |
| Set PSL | If User - number | U/S | Y for | None |
| | (Input), If Setup - | | User | |
| | A.7.c.1, A.7.c.2, | | | |
| | A.7.d.1, A.7.d.2, | | | |
| | A.7.d.3, A.7.d.4, | | | |
| | A.7.d.5, N/A, | | | |
| | Dep., O.O.S. | | | |
| Found PSH | If User - number, | U/S | Y for | None |
| | If Setup -N/A, | | User | |
| | Dep., O.O.S. | | | |
| Found PSL | If User - number, | U/S | Y for | None |
| | If Setup -N/A, | | User | |
| | Dep., O.O.S. | | | |
| Left PSH | If User - number, | U/S | Y for | None |
| | If Setup -N/A, | | User | |
| | Dep., O.O.S. | | | |
| Left PSL | If User - number, | U/S | Y for | None |
| | If Setup -N/A, | | User | |
| | Dep., O.O.S. | | | |
| Rec PSV | If User - Number | U/S | Y for | None |
| | (Input) If Setup - | | User | |
| | A.7.e.1, A.7.e.2, | | | |
| | A.7.f.1, A.7.f.2, | | | |
| | A.7.f.3, A.7.f.4, | | | |
| | A.7.f.5, N/A, | | | |
| | Dep, O.O.S. | | | |
| SDV Y/N | Setup - Y, N, N/A, | S | None | None |
| | O.O.S., Dep. | | | |
| FSV Y/N | If User - either | U/S | Y for | None |
| | Held or Leak (only 2 | | User | |
| | choices) If Setup - | | | |
| | N/A, Dep., O.O.S. | | | |
| TSE Y/N | Setup - Y, N, N/A, | S | None | None |
| | O.O.S., Dep. | | | |

The following table describes the error checking for the user parameters that are affected. In addition to the specific formulas below, no user entry field can be left blank.

TABLE 16
ERROR CHECKING FOR THE PUMPS PARAMETERS

| | Error | |
|---|---|---|
| Parameter | checking | Error |
| Name | formula | message |
| Op Range High | Must be (mb) > Op | Error - Operating Range |
| | Range Low | High must be greater |
| | | than Operating Range Low |
| Op Range Low | Must be (mb) < Op | Error - Operating Range |
| | Range High | Low must be less than |
| | | Operating Range High |
| Set PSH | 1) Not Greater than | 1) Error - PSH set out |
| | 1.15 × Op Range High | of tolerance (14C violation) |
| | rounded down to nearest | |
| | whole number - or - Op | |
| | Range Hi + 5 If Op | |
| | Range High less than | |
| | 33.33 | |
| | 2) Not Less than | 2) Warning - PSH set |
| | 1.15 × Op Range High | less than the 15% allowed |
| | rounded down to nearest | |
| | whole number - or - Op | |
| | Range Low − 5 If Op | |
| | Range Low < 33.33 | |
| | 3) Not Greater than | 3) Error - PSH must |
| | 0.95 × Rec. PSV setting | be 5% below PSV setting |
| Set PSL | 1) Not Less than | 1) Error - PSL set out |
| | 0.85 × Op Range Low | of tolerance (14C violation) |
| | rounded up to nearest | |
| | whole number - or - Op | |
| | Range Hi + 5 If Op | |
| | Range High < 33.33 | |
| | 2) Not Greater than | 2) Warning - PSL set |
| | 0.85 × Op Range Low | less than the 15% allowed |
| | rounded up to nearest | |
| | whole number - or - Op | |
| | Range Low − 5 If Op | |
| | Range Low < 33.33 | |
| Found PSH | Same as set PSH above | |
| Found PSL | Same as set PSL above | |
| Left PSH | Same as set PSH above | |
| Left PSL | Same as set PSL above | |
| Rec. PSV | Not Greater than MAWP | Error - PSV Set |
| | | Pressure should not |
| | | exceed MAWP |
| FSV Y/N | If “Leak” Selected | Error - Repair or |
| | | Replace Valve and retest |

The Compressor page, shown in FIG. 18, contains information pertinent to the platforms compressors. There is a combination of setup data and user input data on this page. The User Input data will be error checked. The Following Table defines the input fields, acceptable values and error checking for the Compressor pages.

TABLE 17
FIELDS FOR COMPRESSOR PAGES

| | | Setup | | |
|---|---|---|---|---|
| | | or | | |
| Parameter | Acceptable | User | Error | Other |
| Name | Values | Input | Checking | Calculations |
| Equipment ID | Setup text | S | None | None |
| Equipment | Setup text | S | None | None |
| Desc. | | | | |
| MAWP | Setup number | S | None | None |
| Op Range High | If User - number | U/S | Y for | None |
| | (Input), If Setup - | | User | |
| | A.8.a.1, A.8.a.2, | | | |
| | A.8.b.1, A.8.b.2, | | | |
| | N/A, Dep., O.O.S. | | | |
| Op Range Low | If User - number | U/S | Y for | None |
| | (Input), If Setup - | | User | |
| | A.8.c.1, A.8.c.2, | | | |
| | A.8.d.1, A.8.d.2, | | | |
| | N/A, Dep., O.O.S. | | | |
| Set PSH | If User - number | U/S | Y for | None |
| | (Input), If Setup - | | User | |
| | A.8.a.1, A.8.a.2, | | | |
| | A.8.b.1, A.8.b.2, | | | |
| | N/A, Dep., O.O.S. | | | |
| Set PSL | If User - number | U/S | Y for | None |
| | (Input), If Setup - | | User | |
| | A.8.c.1, A.8.c.2, | | | |
| | A.8.d.1, A.8.d.2, | | | |
| | N/A, Dep., O.O.S. | | | |
| Found PSH | If User - number, | U/S | Y for | None |
| | If Setup -N/A, | | User | |
| | Dep., O.O.S. | | | |
| Found PSL | If User - number, | U/S | Y for | None |
| | If Setup -N/A, | | User | |
| | Dep., O.O.S. | | | |
| Left PSH | If User - number, | U/S | Y for | None |
| | If Setup -N/A, | | User | |
| | Dep., O.O.S. | | | |
| Left PSL | If User - number, | U/S | Y for | None |
| | If Setup -N/A, | | User | |
| | Dep., O.O.S. | | | |
| Rec PSV | If User - Number | U/S | Y for | None |
| | (Input) If Setup - | | User | |
| | A.8.e.1, A.8.e.2, | | | |
| | A.8.f.1, A.8.f.2, | | | |
| | A.8.f.3, N/A, Dep, | | | |
| | O.O.S. | | | |
| Suct SDV | Setup - Y, N, N/A, | S | None | None |
| | O.O.S., Dep. | | | |
| Disch SDV | Setup - Y, N, N/A, | S | None | None |
| | O.O.S., Dep. | | | |
| Disch FSV | If User - either | U/S | Y for | None |
| | Held or Leak (only 2 | | User | |
| | choices) If Setup - | | | |
| | N/A, Dep., O.O.S. | | | |
| TSH Temp | Setup - Input (text) | S | None | Example is |
| | | | | 291° F. |
| BDV | Setup - Y, N, N/A, | S | None | None |
| | O.O.S., Dep. | | | |

The following table describes the error checking for the user parameters that are affected. In addition to the specific fonnulas below, no user entry field can be left blank.

TABLE 18
ERROR CHECKING FOR THE COMPRESSOR PARAMETERS

| | Error | |
|---|---|---|
| Parameter | checking | Error |
| Name | formula | message |
| Op Range High | Must be (mb) > Op | Error - Operating Range |
| | Range Low | High must be greater |
| | | than Operating Range Low |
| Op Range Low | Must be (mb) < Op | Error - Operating Range |
| | Range High | Low must be less than |
| | | Operating Range High |
| Set PSH | 1) Not Greater than | 1) Error - PSH set out |
| | 1.15 × Op Range High | of tolerance (14C violation) |
| | rounded down to nearest | |
| | whole number - or - Op | |
| | Range Hi + 5 If Op | |
| | Range High less than | |
| | 33.33 | |
| | 2) Not Less than | 2) Warning - PSH set |
| | 1.15 × Op Range High | less than the 15% allowed |
| | rounded down to nearest | |
| | whole number - or - Op | |
| | Range Low − 5 If Op | |
| | Range Low < 33.33 | |
| | 3) Not Greater than | 3) Error - PSH must be |
| | 0.95 × Rec. PSV | 5% below PSV setting |
| | setting | |
| Set PSL | 1) Not Less than | 1) Error - PSL set out |
| | 0.85 × Op Range Low | of tolerance (14C violation) |
| | rounded up to nearest | |
| | whole number - or - Op | |
| | Range Hi + 5 If Op | |
| | Range High < 33.33 | |
| | 2) Not Greater than | 2) Warning - PSL set |
| | 0.85 × Op Range Low | less than the 15% allowed |
| | rounded up to nearest | |
| | whole number - or - Op | |
| | Range Low − 5 If Op | |
| | Range Low < 33.33 | |
| Found PSH | Same as set PSH above | |
| Found PSL | Same as set PSL above | |
| Left PSH | Same as set PSH above | |
| Left PSL | Same as set PSL above | |
| Rec. PSV | Not Greater than MAWP | Error - PSV Set Pressure |
| | | should not exceed MAWP |
| Disch FSV | If “Leak” Selected | Error - Repair or Replace |
| | | Valve and retest |

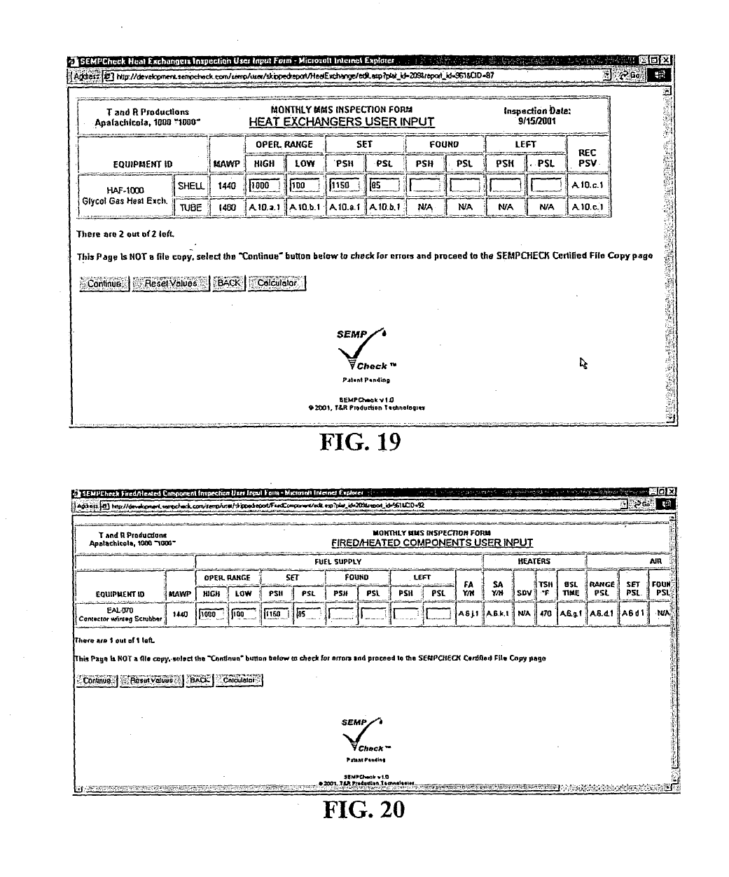

The Heat Exchanger page, shown in FIG. 19, contains information pertinent to the platforms Heat Exchangers. There is a combination of setup data and user input data on this page. The User Input data will be error checked. The Following Table defines the input fields, acceptable values and error checking for the Heat Exchanger pages.

TABLE 19
FIELDS FOR HEAT EXCHANGER PAGES

| | | Setup | | |
|---|---|---|---|---|
| | | or | | |
| Parameter | Acceptable | User | Error | Other |
| Name | Values | Input | Checking | Calculations |
| Equipment ID | Setup text | S | None | None |
| Equipment | Setup text | S | None | None |
| Desc. | | | | |
| (Shell) | Setup number | S | None | None |
| MAWP | | | | |
| (Shell) | If User - number | U/S | Y for | None |
| Op Range High | (Input), If Setup - | | User | |
| | A.10.a.1, A.10.a.2, | | | |
| | A.10.a.3, A.10.a.4, | | | |
| | N/A, Dep., O.O.S. | | | |
| (Shell) | If User - number | U/S | Y for | None |
| Op Range Low | (Input), If Setup - | | User | |
| | A.10.b.1, A.10.b.2, | | | |
| | A.10.b.3, N/A, | | | |
| | Dep., O.O.S. | | | |
| (Shell) | If User - number | U/S | Y for | None |
| Set PSH | (Input), If Setup - | | User | |
| | A.10.a.1, A.10.a.2, | | | |
| | A.10.a.3, A.10.a.4, | | | |
| | N/A, Dep., O.O.S. | | | |
| (Shell) | If User - number | U/S | Y for | None |
| Set PSL | (Input), If Setup - | | User | |
| | A.10.b.1, A.10.b.2, | | | |
| | A.10.b.3, N/A, | | | |
| | Dep., O.O.S. | | | |
| (Shell) | If User - number, | U/S | Y for | None |
| Found PSH | If Setup -N/A, | | User | |
| | Dep., O.O.S. | | | |
| (Shell) | If User - number, | U/S | Y for | None |
| Found PSL | If Setup -N/A, | | User | |
| | Dep., O.O.S. | | | |
| (Shell) | If User - number, | U/S | Y for | None |
| Left PSH | If Setup -N/A, | | User | |
| | Dep., O.O.S. | | | |
| (Shell) | If User - number, | U/S | Y for | None |
| Left PSL | If Setup -N/A, | | User | |
| | Dep., O.O.S. | | | |
| (Shell) | If User - Number | U/S | Y for | None |
| Rec PSV | (Input) If Setup - | | User | |
| | A.10.c.1, A.10.c.2, | | | |
| | A.10.c.3, A.10.c.4, | | | |
| | A.10.c.5, A.10.c.6, | | | |
| | A.10.c.7, N/A, | | | |
| | Dep, O.O.S. | | | |
| (Tube) | Setup number | S | None | None |
| MAWP | | | | |
| (Tube) | If User - number | U/S | Y for | None |
| Op Range High | (Input), If Setup - | | User | |
| | A.10.a.1, A.10.a.2, | | | |
| | A.10.a.3, A.10.a.4, | | | |
| | N/A, Dep., O.O.S. | | | |
| (Tube) | If User - number | U/S | Y for | None |
| Op Range Low | (Input), If Setup - | | User | |
| | A.10.b.1, A.10.b.2, | | | |
| | A.10.b.3, N/A, | | | |
| | Dep., O.O.S. | | | |
| (Tube) | If User - number | U/S | Y for | None |
| Set PSH | (Input), If Setup - | | User | |
| | A.10.a.1, A.10.a.2, | | | |
| | A.10.a.3, A.10.a.4, | | | |
| | N/A, Dep., O.O.S. | | | |
| (Tube) | If User - number | U/S | Y for | None |
| Set PSL | (Input), If Setup - | | User | |
| | A.10.b.1, A.10.b.2, | | | |
| | A.10.b.3, N/A, | | | |
| | Dep., O.O.S. | | | |
| (Tube) | If User - number, | U/S | Y for | None |
| Found PSH | If Setup -N/A, | | User | |
| | Dep., O.O.S. | | | |
| (Tube) | If User - number, | U/S | Y for | None |
| Found PSL | If Setup -N/A, | | User | |
| | Dep., O.O.S. | | | |
| (Tube) | If User - number, | U/S | Y for | None |
| Left PSH | If Setup -N/A, | | User | |
| | Dep., O.O.S. | | | |
| (Tube) | If User - number, | U/S | Y for | None |
| Left PSL | If Setup -N/A, | | User | |
| | Dep., O.O.S. | | | |
| (Tube) | If User - Number | U/S | Y for | None |
| Rec PSV | (Input) If Setup - | | User | |
| | A.10.c.1, A.10.c.2, | | | |
| | A.10.c.3, A.10.c.4, | | | |
| | A.10.c.5, A.10.c.6, | | | |
| | A.10.c.7, N/A, | | | |
| | Dep, O.O.S. | | | |

The following table describes the error checking for the user parameters that are affected. In addition to the specific formulas below, no user entry field can be left blank.

TABLE 20
ERROR CHECKING FOR THE HEAT
EXCHANGER PARAMETERS

| | Error | |
|---|---|---|
| Parameter | checking | Error |
| Name | formula | message |
| Op Range High | Must be (mb) > Op | Error - Operating Range |
| | Range Low | High must be greater |
| | | than Operating Range |
| | | Low |
| Op Range Low | Must be (mb) < Op | Error - Operating Range |
| | Range High | Low must be less than |
| | | Operating Range High |
| Set PSH | 1) Not Greater than | 1) Error - PSH set out |
| | 1.15 × Op Range High | of tolerance (14C violation) |
| | rounded down to nearest | |
| | whole number - or - Op | |
| | Range Hi + 5 If Op | |
| | Range High less than | |
| | 33.33 | |
| | 2) Not Less than | 2) Warning - PSH set |
| | 1.15 × Op Range High | less than the 15% allowed |
| | rounded down to nearest | |
| | whole number - or - Op | |
| | Range Low − 5 If Op | |
| | Range Low < 33.33 | |
| | 3) Not Greater than | 3) Error - PSH must |
| | 0.95 × Rec. PSV setting | be 5% below PSV setting |
| Set PSL | 1) Not Less than | 1) Error - PSL set out |
| | 0.85 × Op Range Low | of tolerance (14C violation) |
| | rounded up to nearest | |
| | whole number - or - Op | |
| | Range Hi + 5 If Op | |
| | Range High < 33.33 | |
| | 2) Not Greater than | 2) Warning - PSL set |
| | 0.85 × Op Range Low | less than the 15% allowed |
| | rounded up to nearest | |
| | whole number - or - Op | |
| | Range Low − 5 If Op | |
| | Range Low < 33.33 | |
| Found PSH | Same as set PSH above | |
| Found PSL | Same as set PSL above | |
| Left PSH | Same as set PSH above | |
| Left PSL | Same as set PSL above | |
| Rec. PSV | Not Greater than MAWP | Error - PSV Set Pressure |
| | | should not exceed MAWP |

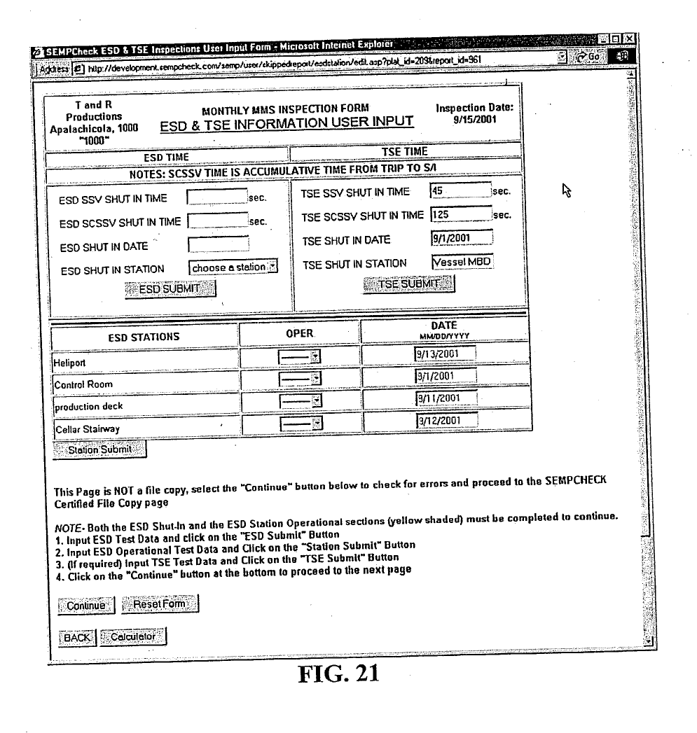

The Fired components page is shown in FIG. 20. There is a combination of setup data and user input data on this page. The User Input data will be error checked. The Following Table defines the input fields, acceptable values and error checking for the Fired Components pages.

TABLE 21
FIELDS FOR FIRED COMPONENTS PAGES

| | | Setup | | |
|---|---|---|---|---|
| | | or | | |
| Parameter | Acceptable | User | Error | Other |
| Name | Values | Input | Checking | Calculations |
| Equipment ID | Setup text | S | None | None |
| Equipment | Setup text | S | None | None |
| Desc. | | | | |
| MAWP | Setup number | S | None | None |
| (Fuel Supply) | If User - number | U/S | Y for | None |
| Op Range High | (Input), If Setup - | | User | |
| | A.6.e.1, A.6.e.2, | | | |
| | N/A, Dep., O.O.S. | | | |
| (Fuel Supply) | If User - number | U/S | Y for | None |
| Op Range Low | (Input), If Setup - | | User | |
| | A.6.f.1, A.6.f.2, | | | |
| | A.6.f.3, N/A, | | | |
| | Dep., O.O.S. | | | |
| (Fuel Supply) | If User - number | U/S | Y for | None |
| Set PSH | (Input), If Setup - | | User | |
| | A.6.e.1, A.6.e.2, | | | |
| | N/A, Dep., O.O.S. | | | |
| (Fuel Supply) | If User - number | U/S | Y for | None |
| Set PSL | (Input), If Setup - | | User | |
| | A.6.f.1, A.6.f.2, | | | |
| | A.6.f.3, N/A, Dep., | | | |
| | O.O.S. | | | |
| (Fuel Supply) | If User - number, | U/S | Y for | None |
| Found PSH | If Setup -N/A, | | User | |
| | Dep., O.O.S. | | | |
| (Fuel Supply) | If User - number, | U/S | Y for | None |
| Found PSL | If Setup -N/A, | | User | |
| | Dep., O.O.S. | | | |
| (Fuel Supply) | If User - number, | U/S | Y for | None |
| Left PSH | If Setup -N/A, | | User | |
| | Dep., O.O.S. | | | |
| (Fuel Supply) | If User - number, | U/S | Y for | None |
| Left PSL | If Setup -N/A, | | User | |
| | Dep., O.O.S. | | | |
| (Heaters) | Setup - A.6.j.1, | S | None | None |
| FA | A.6.j.2, A.6.j.3, | | | |
| | Y, N, N/A, O.O.S., | | | |
| | Dep. | | | |
| (Heaters) | Setup - A.6.k.1, | S | None | None |
| SA | A.6.k.2, A.6.k.3, | | | |
| | A.6.k.4, Y, N, | | | |
| | N/A, O.O.S., Dep. | | | |
| (Heaters) | Setup - Y, N, N/A, | S | None | None |
| SDV | O.O.S., Dep. | | | |
| (Heaters) | Setup - Input | S | None | Example |
| TSH Temp | (text) | | | is 291° F. |
| (Heaters) | If User - number, | U/S | Y for | None |
| BSL Time | If Setup - A.6.g.1, | | User | |
| | A.6.g.2, N/A, | | | |
| | O.O.S., Dep. | | | |
| (Air) | If User - number | U/S | Y for | None |
| Range PSL | (input), If Setup - | | User | |
| | A.6.d.1, A.6.d.2, | | | |
| | A.6.d.3, A.6.d.4 | | | |
| | N/A, O.O.S., Dep. | | | |
| (Air) | If User - number | U/S | Y for | None |
| Set PSL | (input), If Setup - | | User | |
| | A.6.d.1, A.6.d.2, | | | |
| | A.6.d.3, A.6.d.4 | | | |
| | N/A, O.O.S., Dep. | | | |
| (Air) | If User - number, | U/S | Y for | None |
| Found PSL | If Setup -N/A, | | User | |
| | Dep., O.O.S. | | | |
| (Air) | If User - number, | U/S | Y for | None |
| Left PSL | If Setup -N/A, | | User | |
| | Dep., O.O.S. | | | |
| (Shell/Tube) | If User - either | U/S | Y for | None |
| FSV | Held or Leak | | User | |
| | (only 2 choices) | | | |
| | If Setup - A.6.m.1, | | | |
| | A.6.m.2, A.6.m.3, | | | |
| | N/A, Dep., O.O.S. | | | |
| (Shell/Tube) | If User - number | U/S | Y for | None |
| Rec PSV | (input), If Setup - | | User | |
| | A.6.L.1, A.6.L.2, | | | |
| | A.6.L.3, N/A, O.O.S., | | | |
| | Dep. | | | |
| (Shell/Tube) | Setup - A.6.h.1, | S | N | None |
| FSL | A.6.h.2, Y, N, | | | |
| | N/A, Dep. O.O.S. | | | |
| (Shell/Tube) | Setup - A.6.i.1, | S | N | None |
| MI | A.6.i.2, A.6.i.3, | | | |
| | Y, N, N/A, Dep. | | | |
| | O.O.S. | | | |

The following table describes the error checking for the user parameters that are affected. In addition to the specific formulas below, no user entry field can be left blank.

TABLE 22
ERROR CHECKING FOR THE FIRED
COMPONENTS PARAMETERS

| | Error | |
|---|---|---|
| Parameter | checking | Error |
| Name | formula | message |
| Op Range High | Must be (mb) > Op | Error - Operating Range |
| | Range Low | High must be greater than |
| | | Operating Range Low |
| Op Range Low | Must be (mb) < Op | Error - Operating Range |
| | Range High | Low must be less than |
| | | Operating Range High |
| Set PSH | 1) Not Greater than | 1) Error - PSH set out of |
| | 1.15 × Op Range | tolerance (14C violation) |
| | High rounded down | |
| | to nearest whole | |
| | number - or - Op | |
| | Range Hi + 5 If | |
| | Op Range High less | |
| | than 33.33 | |
| | 2) Not Less than | 2) Warning - PSH set less |
| | 1.15 × Op Range | than the 15% allowed |
| | High rounded down | |
| | to nearest whole | |
| | number - or - Op | |
| | Range Low − 5 If | |
| | Op Range Low < 33.33 | |
| | 3) Not Greater than | 3) Error - PSH must be 5% |
| | 0.95 × Rec. PSV | below PSV setting |
| | setting | |
| Set PSL | 1) Not Less than | 1) Error - PSL set out of |
| | 0.85 × Op Range Low | tolerance (14C violation) |
| | rounded up to nearest | |
| | whole number - or - Op | |
| | Range Hi + 5 If Op | |
| | Range High < 33.33 | |
| | 2) Not Greater than | 2) Warning - PSL set less |
| | 0.85 × Op Range Low | than the 15% allowed |
| | rounded up to nearest | |
| | whole number - or - Op | |
| | Range Low − 5 If Op | |
| | Range Low < 33.33 | |
| Found PSH | Same as set PSH above | |
| Found PSL | Same as set PSL above | |
| Left PSH | Same as set PSH above | |
| Left PSL | Same as set PSL above | |
| BSL Time | Cannot exceed 45 sec | BSL Time cannot exceed 45 |
| | | seconds |
| Range PSL | Cannot be blank | Range PSL cannot be blank |
| Set PSL | 1) Not Less than | 1) Error - PSL set out of |
| | 0.85 × Range PSL | tolerance (14C violation) |
| | rounded up to nearest | |
| | whole number - or - | |
| | Op Range Hi + 5 If | |
| | Op Range High < 33.33 | |
| | 2) Not Greater than | 2) Warning - PSL set less |
| | 0.85 × Range PSL | than the 15% allowed |
| | rounded up to nearest | |
| | whole number - or - | |
| | Op Range Low − 5 If | |
| | Op Range Low < 33.33 | |
| Found PSL | Same as set PSL above | |
| Left PSL | Same as set PSL above | |
| FSV | If “Leak” Selected | Error - Repair or Replace |
| | | Valve and retest |
| Rec. PSV | Not Greater than MAWP | Error - PSV Set Pressure |
| | | should not exceed MAWP |

The ESD and TSE page, shown in FIG. 21, contains information pertinent to the platforms ESD stations and ESD/TSE shut in times. There is a combination of setup data and user input data on this page. The User Input data will be error checked. The Following Table defines the input fields, acceptable values and error checking for the ESD and TSE page.

TABLE 23
FIELDS FOR ESD and TSE PAGES

| | | Setup | | |
|---|---|---|---|---|
| | | or | | |
| Parameter | Acceptable | User | Error | Other |
| Name | Values | Input | Checking | Calculations |
| ESD Stations | Setup - | S | N | The number of |
| | Text entry | | | ESD stations |
| | | | | will be input |
| | | | | during the |
| | | | | setup process |
| Oper. | User - either | U | Y | None |
| | “Pass” of | | | |
| | “Fail” | | | |
| Date | Date format | U | Y | Error checking |
| | | | | this part will |
| | | | | get complicated. |
| ESD SSV Shut | User - number | U | Y | None |
| in time | (seconds) | | | |
| ESD SCSSV | User - number | U | Y | None |
| Shut in time | (seconds) | | | |
| TSE SSV Shut in | User - number | U | Y | None |
| time | (seconds) | | | |
| TSE SCSSV | User - number | U | Y | None |
| Shut in time | (seconds) | | | |

The following table describes the error checking for the user parameters that are affected. In addition to the specific fonnulas below, no user entry field can be left blank.

TABLE 24
ERROR CHECKING FOR THE ESD and TSE PARAMETERS

| | Error | |
|---|---|---|
| Parameter | checking | Error |
| Name | formula | message |
| ESD Oper. | If “Fail” selected | Repair and rested |
| | | failed ESD station |
| ESD Date | 1) One ESD Station | Incorrect ESD testing, |
| | must be tested per | One ESD station must |
| | month. | be tested per month, |
| | 2) All ESD Stations | and all other ESD |
| | must be tested before | stations must be |
| | the same ESD station | tested before the |
| | can be retested. | original ESD station |
| | | can be retested. |
| ESD SSV Shut | Cannot exceed 45 | SSV Shut in time cannot |
| in time | seconds | exceed 45 seconds |
| ESD SCSSV | Cannot exceed 120 | SCSSV Shut in time cannot |
| Shut in time | seconds plus SSV | exceed 120 seconds + SSV |
| | Shut in Time | Shut in time |
| TSE SSV Shut in | | SSV Shut in time cannot |
| time | | exceed 45 seconds |
| TSE SCSSV | Cannot exceed 120 | SCSSV Shut in time cannot |
| Shut in time | seconds plus SSV | exceed 120 seconds + SSV |
| | Shut in Time | Shut in time |

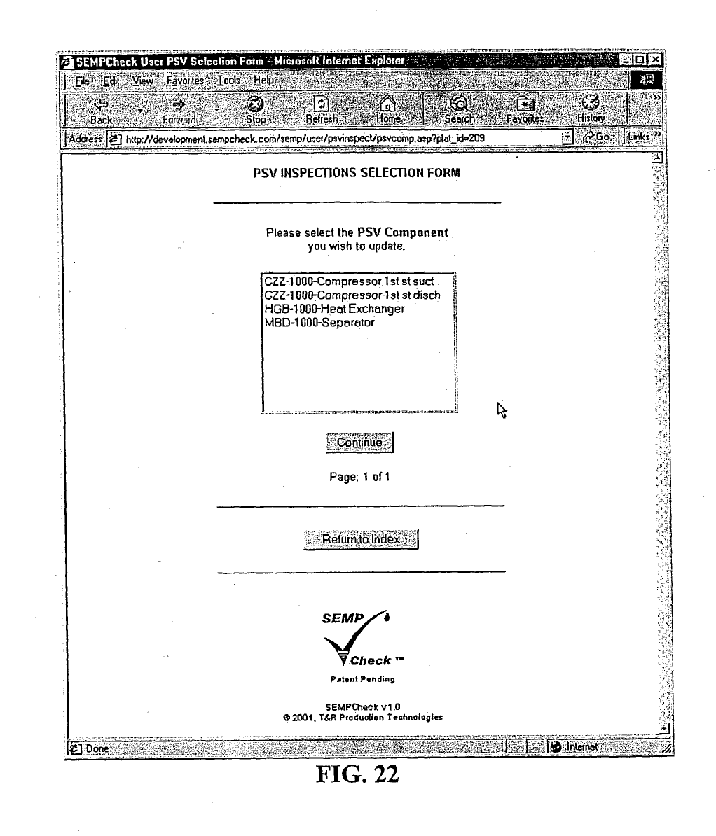

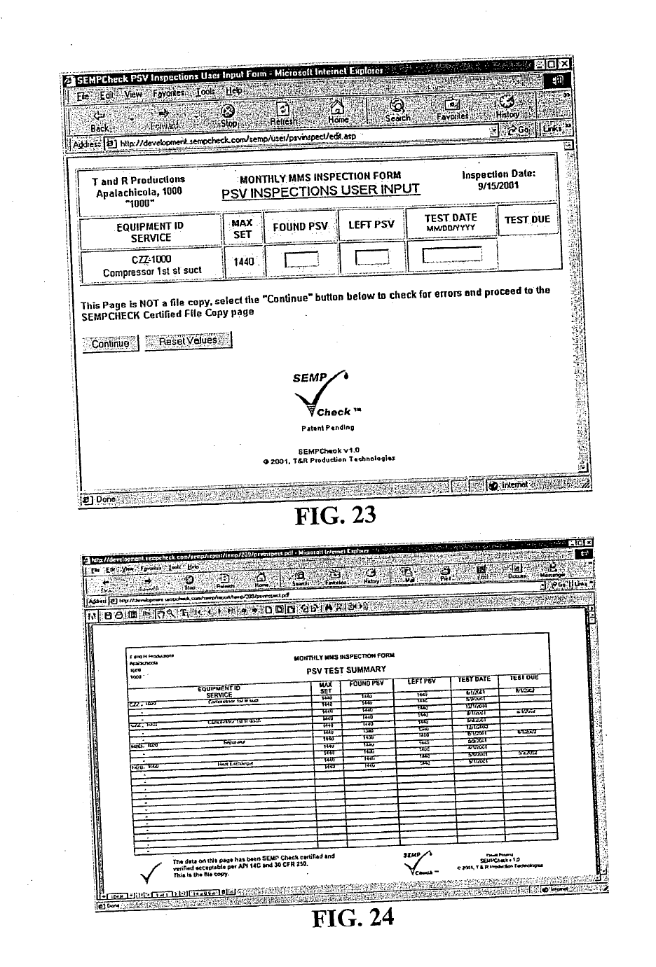

The PSV Inspection page (shown in FIG. 22), the PSV Input page (shown in FIG. 23), and the PDF that is generated (shown in FIG. 24) in order to print the PSV test data contain information about all of the platforms PSV valves. There is a combination of setup data and user input data on this page. The User Input data will be error checked. The Following Table defines the input fields, acceptable values and error checking for the PSV Inspection page.

TABLE 25
FIELDS FOR PSV INSPECTION PAGES

| | | Setup | | |
|---|---|---|---|---|
| | | or | | |
| Parameter | Acceptable | User | Error | Other |
| Name | Values | Input | Checking | Calculations |
| Equipment | Setup - Text entry | S | N | None |
| ID | | | | |
| Equipment | Setup - Text entry | S | N | None |
| Desc. | | | | |
| Max Set | Setup - Number | S | N | None |
| | Entry | | | |
| Found PSV | User - number | U | Y for | None |
| | (seconds) | | User | |
| Left PSV | User - number | U | Y for | None |
| | (seconds) | | User | |
| Test Date | User - Date entry | U | N | Must be in |
| | | | | Date Format |
| Test Due | Program Calculation | N/A | N/A | Program will |
| | | | | calculate - Test |
| | | | | due is 1 year |
| | | | | from Test Date |

The following table describes the error checking for the user parameters that are affected. In addition to the specific formulas below, no user entry field can be left blank.

TABLE 26
ERROR CHECKING FOR THE PSV
INSPECTION PARAMETERS

| | Error | |
|---|---|---|
| Parameter | checking | Error |
| Name | formula | message |
| Found PSV | Must be less than | PSV Set pressure must |
| | Max Set | not exceed max set |
| | | pressure - reset PSV |
| Left PSV | Must be less than | PSV Set pressure must |
| | Max Set | not exceed max set |
| | | pressure - reset PSV |
| Test Date | Must be entered | |

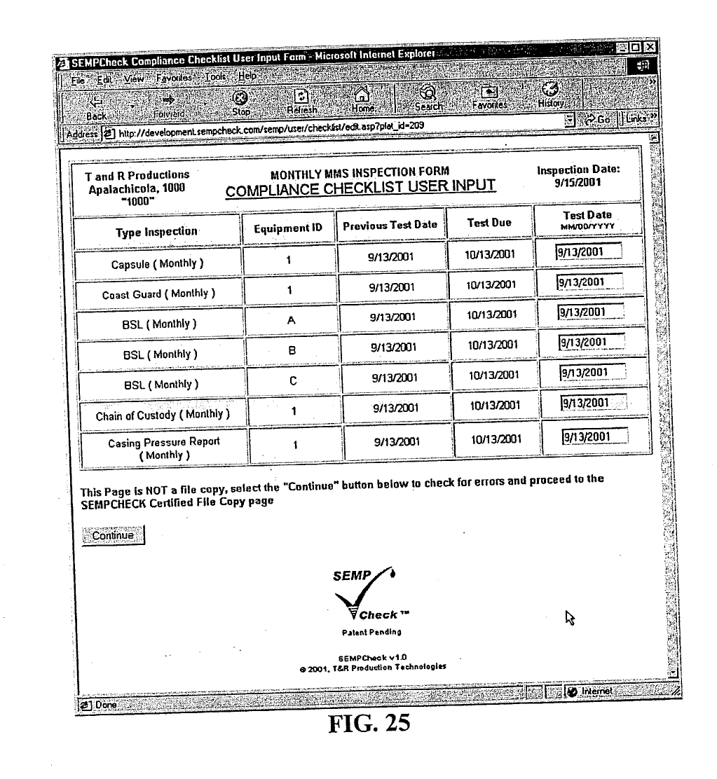

The Compliance Checklist page, shown in FIG. 25, provides the user with a notice of when the next test is due for a number of periodic tests. The user will input the most recent test date and the SEMP Check web page will calculate the next test due, based on the appropriate test frequency. The specific tests that are displayed are a function of the equipment installed on the platform. The specific setup of this page is customized for each platform during the platform setup process. The table below lists all the current tests that are possible for inclusion in the compliance checklist. NOTE: The system was designed with the flexibility to instantly add a new test category if so desired. The list below simply represents the current test categories at the time of this writing.

TABLE 27
TYPE TEST

Type Test
Capsule
Coast Guard
Fire Fighting Equipment
Fire Pump
NPDES
Toxicity
Fire/Smoke/Thermal Inspection
Crane Inspection
Gas Meter Calibration
Oil Meter Calibration
Prover Loop Water Draw
TSH Compressor
TSH Vessels
BSL
Pipeline Inspection
Casing Pressure
Emergency Flare Gas Inspection
Departures
Well Certifications
PSV History
Oil and Grease Analysis
Navaids
LACT Seal Report
Chain of Custody
Gas Detector Calibration
PSV Inspection
SSSV/Plug Inspection
SCSSV Inspection
Emergency Drill
Safety Meeting
Departures
MMS Inspections
SSV/SCSSV Certifications

Another fully customizable aspect of the compliance checklist is that an unlimited number of a category of test can be programmed. For Instance, if there are 4 Cranes on a platform, and each one has a different test date, then 4 individual Crane inspections can be created; and the cranes can be differentiated by serial number or type within the checklist. The combination of multiple test frequencies, programmable test frequencies, and the option of multiple tests within a category make the compliance checklist a totally flexible tool that can be tailored to any platform configuration.

Users can access the compliance checklist by logging in and selecting the appropriate platform. An option is available to make inputs (enter test dates) as well as view/print the compliance checklist. FIG. 25 shows the user input for the Compliance Checklist

The MMS reports are generated as Adobe Acrobat PDF files. The report pages can be generated one page at a time—if the user wants to print out data from a single component, or the entire report can be printed out when complete. In addition to printing out completed reports, a blank copy can also be printed out. The blank copy has all the platform Equipment setup data, but leaves blanks where user entered test data exists. This copy can be placed on a clipboard and used to “pencil in” the exact test data. Since this copy looks very similar to both the completed report pages and the user input pages, the user does not have to translate, and errors of transposition are minimized.

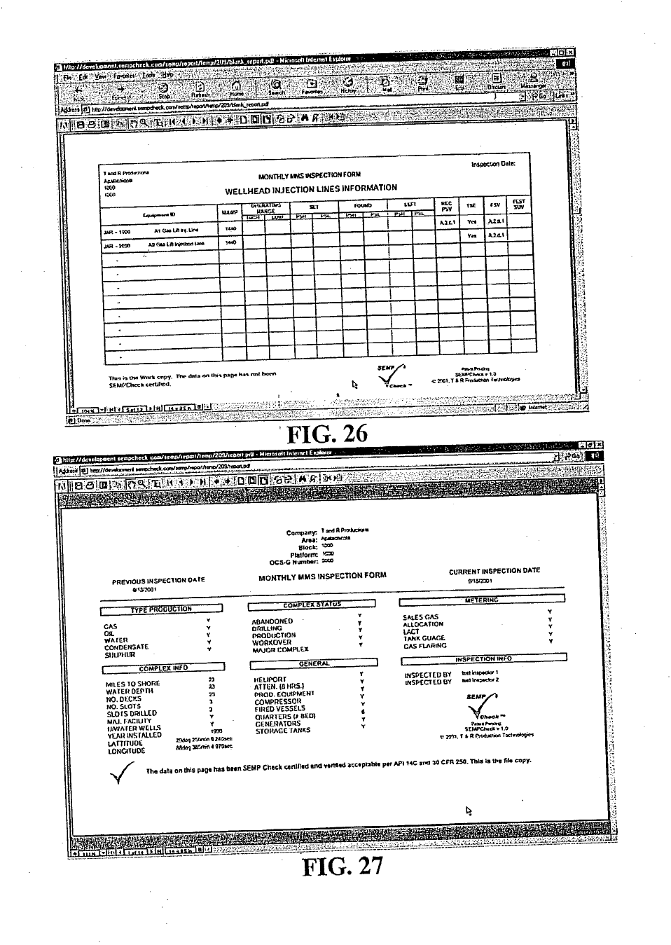

Both the Completed report pages and the Blank pages can be saved to the local hard drive and emailed or simply stored for future reference. In addition, all completed reports are always available on the system, so a historical record is available for all reports generated since the platform started utilizing the system. FIGS. 26 and 27 show a blank report and a completed report, respectively.

The Compliance e-library, FIG. 28, takes the Compliance Checklist idea one step further. Where the Compliance Checklist serves to alert the users to upcoming inspections and tests, the compliance e-library stores the relevant documentation relating to the tests on the compliance checklist, and other useful information related to the platform. The e-library is best thought of as an electronic filing cabinet, where users can access reports, documentation, certifications, and many other types of documentation. Like the Compliance Checklist, the categories are totally customizable. Most documents are archived as PDF files, by there is not requirement for this format standard, any electronic file format can be archived.

Users can access the compliance e-library by logging in and selecting the appropriate platform. An option is available to view/download Compliance e-library files. FIG. 28 shows the user selection for an e-library category.

Users can access Drawings of their platforms by logging on to the system and selecting the “Download Drawings” option. The drawings available are typically the latest available MMS approved drawings for their platforms. These drawings are typically in AutOCAD™ Format (.dwg), however any file format can be used.

Due to the flexibility of the system, there are a number of areas that the system can be applied to with very minor modifications. The current version of the system is focused on offshore oil production facilities, however the system can easily be adapted to Drilling platforms as well. Onshore and offshore pipelines are also candidates for future versions. In addition Production plants are potentials for variants of the system. All these facilities have similar safety requirements and shutdown systems.

The capabilities of the existing system can and will be continually improved through the addition of plotting capabilities, artificial intelligence, and automated data input.

The following section describes in detail the preferred tables that are used in the database, and the individual table columns.

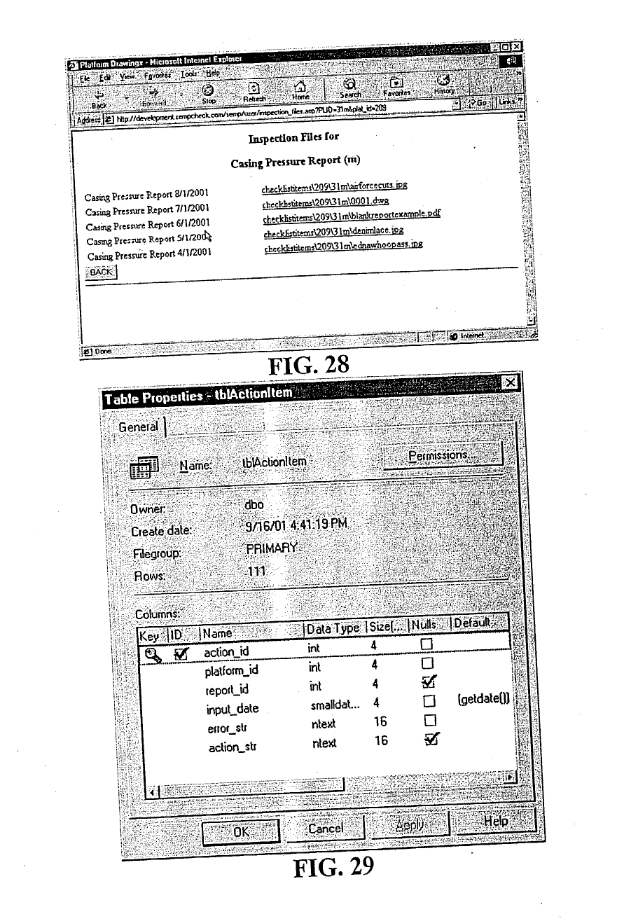

FIG. 29 is a representative “tblActionItem” Properties. The purpose of this table is to store the user error messages that can be generated when the user generates a monthly MMS report. The error messages (see “error_str” below) and the action taken are written to this table, and are displayed on the User Action item summary. This allows Platform Users to document what action was taken as a result of the errors and Customer Management to view the status and problems (errors) encountered during the report submission process.

TABLE 28
TABLE PARAMETERS

| Column | Common | | Default |
|---|---|---|---|
| Name | Name | Purpose | Value |
| action_id | Action Item ID | Key for all table | n/a |
| | | entries | |
| platform_id | Platform | Relates the action | n/a |
| | Identification | item entry to the | |
| | | relevant Platform ID | |
| report_id | Report | Relates the Action | n/a |
| | Identification | Item Entry to the | |
| | | relevant Report ID | |
| input_date | Action Item | Used to display the | n/a |
| | Generation Date | date and time that | |
| | | the action item was | |
| | | generated | |
| error_str | Error String | Actual error message | n/a |
| | | generated by user | |
| action_str | Action Taken | Action taken by User | n/a |
| | String | to correct the Error | |

ASP Pages Affected:

/semp/report/generate_complete_report.asp

/semp/report/actionitem/generate.asp

/semp/user/actionitem/default.asp

/semp/user/actionitem/summary.asp

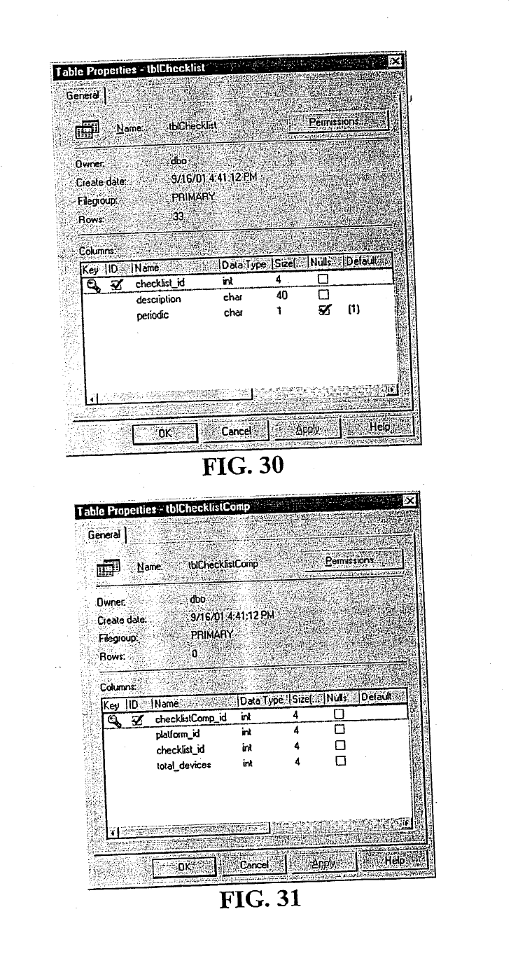

FIG. 30 is a representative “tblChecklist” Properties. The purpose of this table is to store all the possible categories for the Compliance Checklist. When a platform is created in the system, a Compliance checklist is created. Some or all of the checklist items on this table can be used, if required. Items in this table can be edited or added to by users with admin authority.

TABLE 29
TABLE PARAMETERS

| Column | Common | | Default |
|---|---|---|---|
| Name | Name | Purpose | Value |
| checklist_id | Checklist ID | Key for all table | n/a |
| | | entries | |
| description | Checklist Item | Name of the compliance | n/a |
| | Description | Checklist Item or | |
| | | Category (i.e. “Coast | |
| | | Guard Report”) | |
| periodic | periodic bit | Used to determine if | n/a |
| | | a category is a | |
| | | periodic test or if | |
| | | it is a “one time | |
| | | only” category. Items | |
| | | that are periodic can | |
| | | be included in the | |
| | | compliance checklist | |

ASP Pages Affected:

/semp/user/checklist/default.asp

/semp/setup/checklist/checklistComp.asp

/semp/setup/checklist/default.asp

/semp/setup/checklist/validateComp.asp

/semp/setup/checklist/edit/checklist_delete.asp

/semp/setup/checklist/edit/ed_checklistComp.asp

/semp/setup/checklist/edit/default.asp

/semp/setup/checklist/edit/ed_validateComp.asp

/semp/report/ComplianceChecklist/generate.asp

FIG. 31 is a representative “tblChecklistComp” Properties. The purpose of this table is to store results of Compliance Checklist build process. The table is only used during the building of the compliance checklist. The data in this table is written to this table as an intermediate step before it gets written to the final table for the compliance checklist-tblChecklistPlatform.

TABLE 30
TABLE PARAMETERS

| Column | Common | | Default |
|---|---|---|---|
| Name | Name | Purpose | Value |
| checklistComp_id | Checklist ID | Key for all table | n/a |
| | | entries | |
| platform_id | Platform ID | Unique ID for the | n/a |
| | | platform | |
| checklist_id | Checklist Item | Defined in | n/a |
| | ID | tblChecklist | |
| total_devices | Total Devices | The total number of | n/a |
| | | devices PER checklist | |
| | | ID for that specific | |
| | | platform | |

ASP Pages Affected:

/semp/setup/checklist/BuildChecklist.asp

/semp/setup/checklist/validateComp.asp

/semp/setup/checklist/edit/ed_validateComp.asp

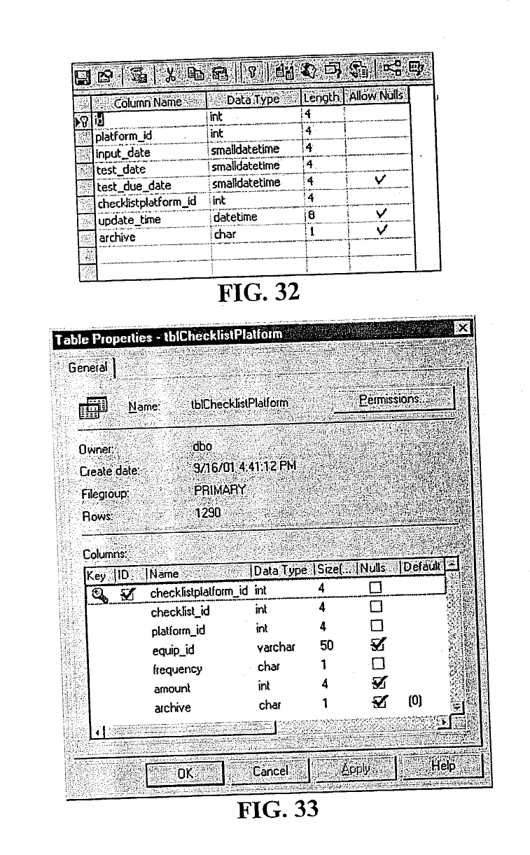

FIG. 32 is a representative “tblChecklistEntry” Properties. The purpose of this table is to store the user entered test dates for the Compliance Checklist items, as set up on a platform specific basis. The date that the next test is due is also stored, and the time that the item was updated.

TABLE 31
TABLE PARAMETERS

| Column | Common | | Default |
|---|---|---|---|
| Name | Name | Purpose | Value |
| Id | ID | Key for all table | n/a |
| | | entries | |
| platform_id | Platform ID | Unique ID for the | n/a |
| | | platform - used | |
| | | to relate the | |
| | | remaining table | |
| | | parameters to the | |
| | | relevant platform | |
| input_date | Input Date | Date/time table that | n/a |
| | | the user accessed the | |
| | | table items/rows for | |
| | | the platform (multiple | |
| | | items possible) | |
| test_date | Test Date | User entered date of | n/a |
| | | test | |
| test_due_date | Test Due Date | The system generated | n/a |
| | | date for next test | |
| checklistplatform_{—} | | Distinct ID for each | n/a |
| id | | checklist item | |
| update_time | Update Time | Date/time that the | n/a |
| | | individual table item | |
| | | (row) was updated. | |
| archive | Archive bit | bit to determine if | 0 |
| | | item has been archived | |

ASP Pages Affected:

/semp/user/checklist/default.asp

/semp/user/checklist/edit.asp

/semp/user/checklist/submit.asp

/semp/report/ComplianceChecklist/generate.asp

FIG. 33 is a representative “tblChecklistPlatform” Properties. The parameters are as follows:

TABLE 32
TABLE PARAMETERS

| Column | Common | | Default |
|---|---|---|---|
| Name | Name | Purpose | Value |
| checklistplatform_{—} | | key - Unique id for | n/a |
| id | | all checklist items | |
| checklist_id | Checklist ID | Checklist item ID | n/a |
| | | (defined in | |
| | | tblChecklist) | |
| platform_id | Platform ID | Unique ID for each | n/a |
| | | platform. Relates | |
| | | Checklist item to the | |
| | | relevant platform | |
| equip_id | Equipment ID | Identifier for each | n/a |
| | | equipment - used in | |
| | | the event that there | |
| | | are multiple | |
| | | equipment for a | |
| | | classification of test | |
| | | (i.e. 3 Cranes, etc) | |
| frequency | Test Frequency | Frequency of Test in | n/a |
| | | days(d), weeks(w), | |
| | | months(m), or Years(y) | |
| amount | Amount of | Used to apply | n/a |
| | Frequency | multiples of frequency | |
| | | (i.e. 3 × monthly = 3 | |
| | | month test frequency) | |
| archive | archive bit | used if item has been | 0 |
| | | removed or archived | |

ASP Pages Affected:

/semp/setup/checklist/buildChecklist.asp

/semp/setup/checklist/default.asp

/semp/setup/checklist/submit.asp

/semp/setup/checklist/edit/checklist_delete.asp

/semp/setup/checklist/edit/ed_buildChecklist.asp

/semp/setup/checklist/edit/ed_default.asp

/semp/setup/checklist/edit/ed_submit.asp

/semp/user/checklist/default.asp

/semp/user/checklist/edit.asp

/semp/user/checklist/submit.asp

/semp/report/ComplianceChecklist/generate.asp

FIG. 34 is a representative “tblComment” Properties. The purpose of this table is to store the user comments generated during the report generation process. This table may be replaced by tblCommentEntry below.

TABLE 33
TABLE PARAMETERS

| Column | Common | | Default |
|---|---|---|---|
| Name | Name | Purpose | Value |
| platform_id | Platform | Relates the Comment | n/a |
| | Identification | entry to the relevant | |
| | | Platform ID | |
| input_date | Input Date | Date and time input | n/a |
| | | made | |
| comments | Comments | Comment string | n/a |
| update_time | Update Time | Time table entry is | n/a |
| | | updated | |
| archive | archive bit | used if item has been | 0 |
| | | removed or archived | |

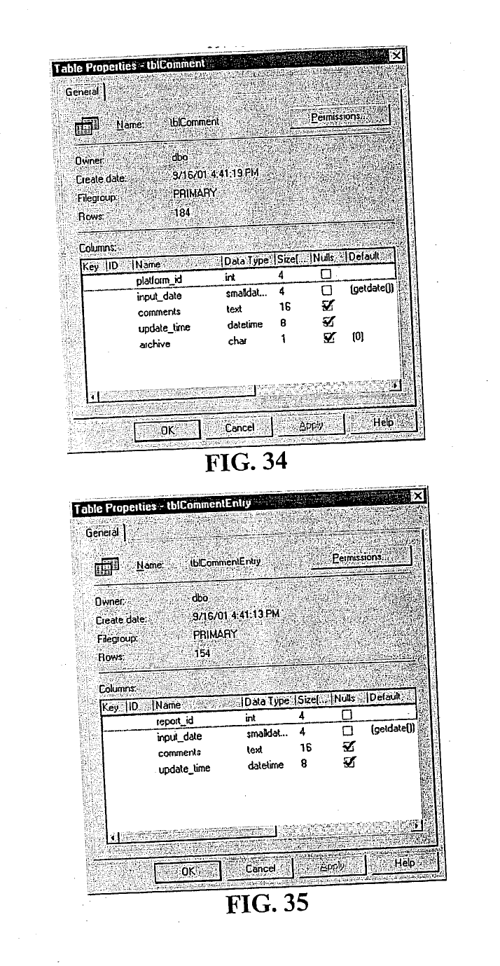

FIG. 35 is a representative “tblCommentEntry” Properties. The purpose of this table is to store the user comments generated during the report generation process.

TABLE 34
TABLE PARAMETERS

| Column | Common | | Default |
|---|---|---|---|
| Name | Name | Purpose | Value |
| report_id | Report | Relates the Comment | n/a |
| | Identification | entry to the relevant | |
| | | Report ID | |
| input_date | Input Date | Date and time input | n/a |
| | | made | |
| comments | Comments | Comment string | n/a |
| update_time | Update Time | Time table entry is | n/a |
| | | updated | |

ASP Pages Affected:

/semp/user/actionitem/default.asp

/semp/user/actionitem/submit.asp

/semp/user/actionitem/summary.asp

/semp/report/actionitemgenerate.asp

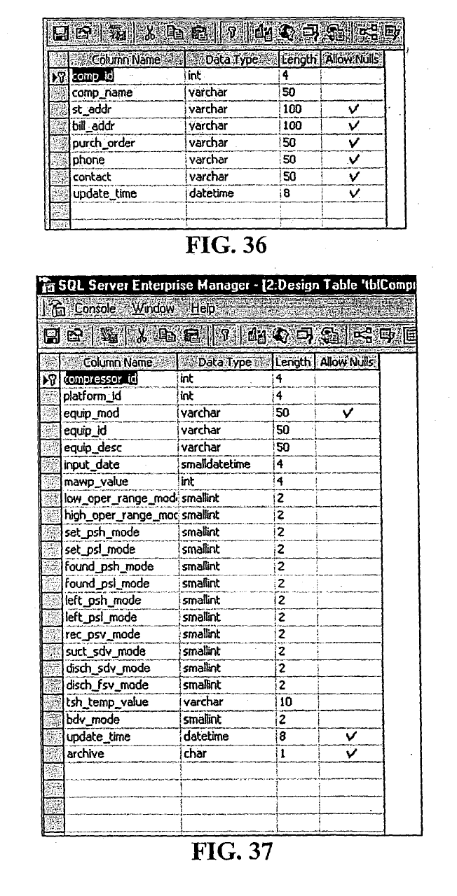

FIG. 36 is a representative “tblCompany” Properties.

TABLE 35
TABLE PARAMETERS

| Column | Common | | Default |
|---|---|---|---|
| Name | Name | Purpose | Value |
| comp_id | Company ID | Key - Unique number | n/a |
| | | generated for each | |
| | | company | |
| comp_name | Company Name | self explanatory | n/a |
| st_addr | Street Address | self explanatory | n/a |
| bill_addr | Billing Address | self explanatory | n/a |
| purch_order | Purchase Order | self explanatory - not | n/a |
| | | currently used | |
| phone | Phone Number | self explanatory | n/a |
| contact | Contact Name | self explanatory | n/a |
| update_time | Update Time | time when table entry | n/a |
| | | updated | |

ASP Pages Affected:

/semp/account/company/default.asp

/semp/account/company/edit.asp

/semp/account/company/update.asp

/semp/account/user/add.asp

/semp/account/user/default.asp

/semp/account/user/edit.asp

/semp/report/actionitem/generate.asp

/semp/report/ComplianceChecklist/generate.asp

/semp/report/compressor/generate.asp

/semp/report/departures/generate.asp

/semp/report/esdstation/generate.asp

/semp/report/firedcomponent/generate.asp

/semp/report/header/generate.asp

/semp/report/heatexchange/generate.asp

/semp/report/pipeline/generate.asp

/semp/report/platform/generate.asp

/semp/report/psvinspect/generate.asp

/semp/report/pump/generate.asp

/semp/report/vessel/generate.asp

/semp/report/well/generate.asp

/semp/report/wellbay/generate.asp

/semp/report/wellhead/generate.asp

/semp/report/platform_report_listing.asp

/semp/include/plat-info.asp

/semp/user/welcome.asp

/semp/user/platform.asp

/semp/user/platformDefault.asp

/semp/user/skippedReport.asp

/semp/user/skippedreport/Well/edit.asp

/semp/user/skippedreport/Well/default.asp

/semp/user/skippedreport/WellBay/edit.asp

/semp/user/skippedreport/WellBay/default.asp

/semp/user/skippedreport/WellHead/edit.asp

/semp/user/skippedreport/WellHead/default.asp

/semp/user/skippedreport/Header/edit.asp

/semp/user/skippedreport/Header/default.asp

/semp/user/skippedreport/Pump/edit.asp

/semp/user/skippedreport/Pump/default.asp

/semp/user/skippedreport/Vessel/edit.asp

/semp/user/skippedreport/Vessel/default.asp

/semp/user/skippedreport/Pipeline/edit.asp

/semp/user/skippedreport/Pipeline/default.asp

/semp/user/skippedreport/Compressor/edit.asp

/semp/user/skippedreport/Compressor/default.asp

/semp/user/skippedreport/HeatExchange/edit.asp

/semp/user/skippedreport/HeatExchange/default.asp

/semp/user/skippedreport/FiredComponent/edit.asp

/semp/user/skippedreport/FiredComponent/default.asp

/semp/user/skippedreport/esdstation/edit.asp

/semp/user/skippedreport/esdstation/default.asp

/semp/user/actionitem/default.asp

/semp/user/skipped.asp

FIG. 37 is a representative “tblCompressor” Properties. The purpose of this table is to store the data for the setup of compressors in the system. The data stored is configuration data, the actual user-input report data is stored in tblCompressorEntry.

TABLE 36
TABLE PARAMETERS

| Column | Common | | Default |
|---|---|---|---|
| Name | Name | Purpose | Value |
| compressor_id | Compressor ID | key - Unique ID for | n/a |
| | | each Compressor | |
| platform_id | Platform | Relates the Compressor | n/a |
| | Identification | entry to the relevant | |
| | | Platform ID | |
| equip_id | Equipment ID | The Equipment ID | n/a |
| | | component of the | |
| | | Compressor name - | |
| | | displayed on all | |
| | | user and setup pages | |
| equip_mod | Equipment | 3 letter code that | n/a |
| | Modifier | determines Compressor | |
| | | type - displayed on | |
| | | all user and setup | |
| | | pages | |
| equip_desc | Equipment | Text sting describing | n/a |
| | Description | equipment service | |
| input_date | Input Date | Date/Time Equipment | n/a |
| | | added to database | |
| mawp_value | MAWP | Maximum Allowed | n/a |
| | | Working Pressure | |
| | | for equipment | |
| low_oper_{—} | Operating | Mode for Operating | n/a |
| range_mode | Range Low | Range Low | |
| high_oper_{—} | Operating | Mode for Operating | n/a |
| range_mode | Range high | Range High | |
| set_psh_mode | Set PSH | Set PSH mode | n/a |
| set_psl_mode | Set PSL | Set PSL mode | n/a |
| found_psh_{—} | Found PSH | Found PSH mode | n/a |
| mode | | | |
| found_psl_{—} | Found PSL | Found PSL mode | n/a |
| mode | | | |
| left_psh_mode | Left PSH | Left PSH mode | n/a |
| left_psl_mode | Left PSL | Left PSL mode | n/a |
| rec_psv_mode | Recorded PSV | Recorded PSV mode | n/a |
| suct_sdv_mode | Suction SDV | Suction SDV Mode | n/a |
| disch_sdv_{—} | Discharge SDV | Discharge SDV Mode | n/a |
| mode | | | |
| disch_fsv_{—} | Discharge FSV | Discharge FSV Mode | n/a |
| mode | | | |
| tsh_temp_{—} | TSH Temp | TSH Temp Mode | n/a |
| value | | | |
| bdv_mode | BDV | BDV Mode | n/a |
| update_time | Update Time | time when table | n/a |
| | | entry updated | |
| archive | Archive bit | bit to determine | 0 |
| | | if item has been | |
| | | archived | |

ASP Pages Affected:

/semp/user/skippedreport/compressor/default.asp

/semp/user/skippedreport/compressor/edit.asp

/semp/setup/compressor/default.asp

/semp/setup/compressor/submit.asp

/semp/setup/compressor/edit/default.asp

/semp/setup/compressor/edit/submit.asp

/semp/setup/compressor/edit/compressor_add.asp

/semp/setup/compressor/edit/compressor_edit.asp

/semp/setup/compressor/edit/compressor_delete.asp

/semp/report/compressor/generate.asp

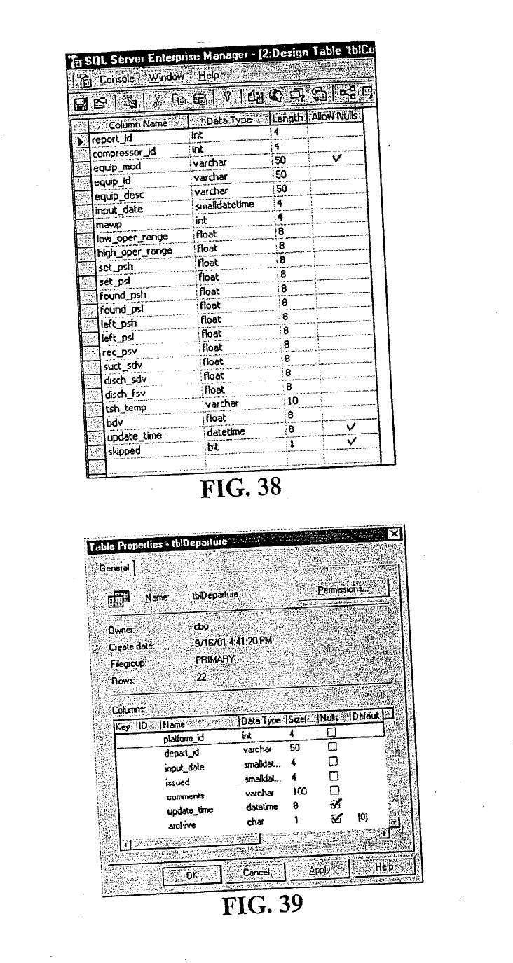

FIG. 38 is a representative “tblCompressorEntry” Properties. The purpose of this table is to store the user entered report data for the compressor equipment classification.

TABLE 37
TABLE PARAMETERS

| Column | Common | | Default |
|---|---|---|---|
| Name | Name | Purpose | Value |
| report_id | Report | Relates the Compressor | n/a |
| | Identification | entry to the | |
| | | relevant Report ID | |
| compressor_id | Compressor | unique key for | n/a |
| | Identification | compressor - defined | |
| | | in tblCompressor | |
| equip_id | Equipment ID | The Equipment ID | n/a |
| | | component of the | |
| | | Compressor name - | |
| | | displayed on all | |
| | | user and setup pages | |
| equip_mod | Equipment | 3 letter code that | n/a |
| | Modifier | determines Compressor | |
| | | type - displayed on | |
| | | all user and setup | |
| | | pages | |
| equip_desc | Equipment | Text sting describing | n/a |
| | Description | equipment service | |
| input_date | Input Date | Date/Time Equipment | n/a |
| | | added to database | |
| mawp_value | MAWP | Maximum Allowed | n/a |
| | | Working Pressure | |
| | | for equipment | |
| low_oper_{—} | Operating | Operating Range Low | n/a |
| range | Range Low | user input value | |
| high_oper_{—} | Operating | Operating Range High | n/a |
| range | Range high | user input value | |
| set_psh | Set PSH | Set PSH user input | n/a |
| | | value (if app.) | |
| set_psl | Set PSL | Set PSL user input | n/a |
| | | value (if app.) | |
| found_psh | Found PSH | Found PSH user input | n/a |
| | | value (if app.) | |
| found_psl | Found PSL | Found PSL user input | n/a |
| | | value (if app.) | |
| left_psh | Left PSH | Left PSH user input | n/a |
| | | value (if app.) | |
| left_psl | Left PSL | Left PSL user input | n/a |
| | | value (if app.) | |
| rec_psv | Recorded PSV | Recorded PSV user | n/a |
| | | input value (if app.) | |
| suct_sdv | Suction SDV | Suction SDV user | n/a |
| | | input value (if app.) | |
| disch_sdv | Discharge SDV | Discharge SDV user | n/a |
| | | input value (if app.) | |
| disch_fsv | Discharge FSV | Discharge FSV user | n/a |
| | | input value (if app.) | |
| tsh_temp | TSH Temp | TSH Temp user input | n/a |
| | | value (if app.) | |
| bdv | BDV | BDV user input value | n/a |
| | | (if app.) | |
| update_time | Update Time | time when table entry | n/a |
| | | updated | |
| skipped | skipped bit | bit to determine if | 0 |
| | | item has been skipped | |

ASP Pages Affected:

/semp/user/skippedreport/compressor/default.asp

/semp/user/skippedreport/compressor/edit.asp

/semp/user/skippedreport/compressor/submit.asp

/semp/report/compressor/generate.asp

FIG. 39 is a representative “tblDeparture” Properties. The purpose of this table is to store the information about a platforms issued departures. There are no user entered departure values, so there is no need for a tblDepartureEntry.

TABLE 38
TABLE PARAMETERS

| Column | Common | | Default |
|---|---|---|---|
| Name | Name | Purpose | Value |
| platform_id | Platform ID | Relates the Departure | n/a |
| | | entry to the relevant | |
| | | Platform ID | |
| depart_id | Departure ID | unique ID for each | n/a |
| | | Departure | |
| input_date | Input Date | Date/Time Equipment | n/a |
| | | added to database | |
| issued | Issue Date | Date departure was | n/a |
| | | issued | |
| comments | Comments | Departure comment | n/a |
| | | string | |
| update_time | Update Time | time when table entry | n/a |
| | | updated | |
| archive | Archive bit | bit to determine if | 0 |
| | | item has been archived | |

ASP Pages Affected:

/semp/setup/departure/default.asp

/semp/setup/departure/submit.asp

/semp/setup/departure/edit/default.asp

/semp/setup/departure/edit/submit.asp

/semp/setup/departure/edit/departures_add.asp

/semp/setup/departure/edit/departures_delete.asp

/semp/setup/departure/edit/departures_edit.asp

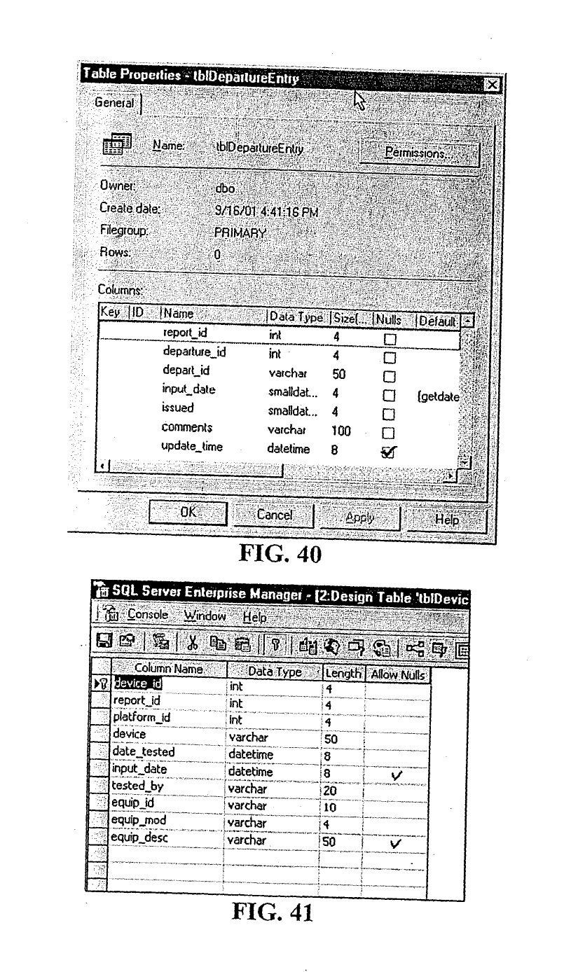

FIG. 40 is a representative “tblDepartureEntry” Properties. FIG. 41 is a representative “tblDeviceDueDate” Properties. FIG. 42 is a representative “tblDrawing” Properties. This table is used to store the location and description of platform drawing files.

TABLE 39
TABLE PARAMETERS

| Column | Common | | Default |
|---|---|---|---|
| Name | Name | Purpose | Value |
| drawing_id | Drawing ID | key - unique ID for | n/a |
| | | each drawing | |
| platform_id | Platform ID | Relates the Departure | n/a |
| | | entry to the | |
| | | relevant Platform ID | |
| drawing_{—} | Drawing | Location of drawing | n/a |
| location | Location | file on server | |
| drawing_desc | Drawing | Text string associated | n/a |
| | Description | with drawing file link | |

ASP Pages Affected:

/semp/setup/AddImage.asp

/semp/setup/addcomments.asp

/semp/setup/deleteimage.asp

/semp/user/drawing/drawing.asp

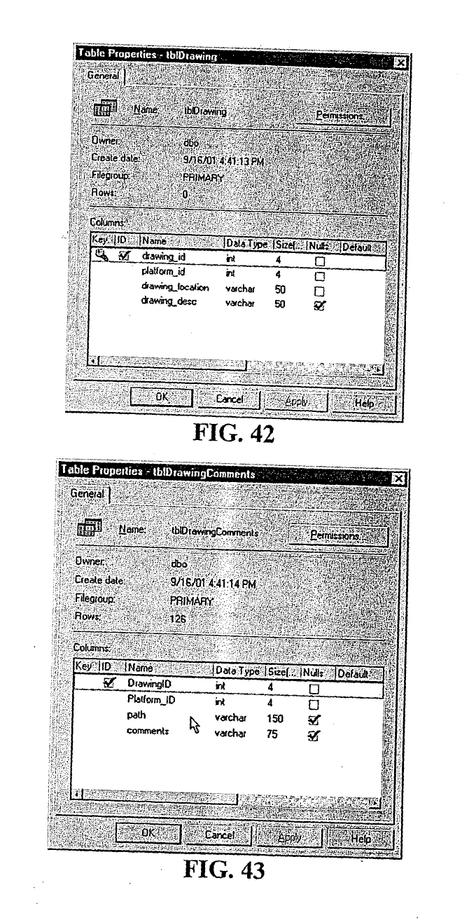

FIG. 43 is a representative “tblDrawingComments” Properties. This table is used to store the comments associated with the platform drawings.

TABLE 40
TABLE PARAMETERS

| Column | Common | | Default |
|---|---|---|---|
| Name | Name | Purpose | Value |
| DrawingID | Drawing ID | Defined in tblDrawing | n/a |
| Platform_ID | Platform ID | Relates the Departure | n/a |
| | | entry to the relevant | |
| | | Platform ID | |
| path | Path | Location of drawing | n/a |
| | | file on server | |
| comments | Comments | Comment string | n/a |
| | | associated with | |
| | | drawing file | |

ASP Pages Affected:

/semp/setup/AddImage.asp

/semp/setup/addcomments.asp

/semp/setup/deleteimage.asp

/semp/user/drawing/drawing.asp

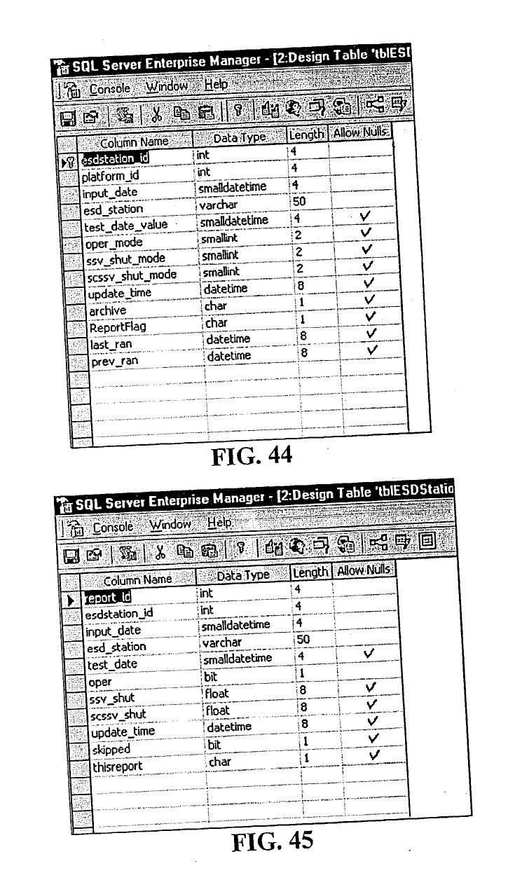

FIG. 44 is a representative “tblESDStation” Properties. This table is used to store the setup data for the ESD stations, as well as the last tested and previously tested dates.

TABLE 41
TABLE PARAMETERS

| Column | Common | | Default |
|---|---|---|---|
| Name | Name | Purpose | Value |
| esdstation_id | ESD Station ID | Unique ID for every | n/a |
| | | ESD Station | |
| platform_id | Platform ID | Relates the Departure | n/a |
| | | entry to the relevant | |
| | | Platform ID | |
| input_date | Input Date | Date/Time Equipment | n/a |
| | | added to database | |
| esd_station | ESD Station | text description of | n/a |
| | Desc | ESD Station | |
| test_date_value | Test Date | Null - not used | n/a |
| oper_mode | Operate Mode | Null - not used | n/a |
| ssv_shut_mode | SSV Shut Mode | Null - not used | n/a |
| scssv_shut_mode | SCSSV Shut | Null - not used | n/a |
| | Mode | | |
| update_time | Update Time | time when table entry | n/a |
| | | updated | |
| archive | Archive bit | bit to determine if | 0 |
| | | item has been archived | |
| ReportFlag | Report Flag | Indicates if ESD | n/a |
| | | station has been | |
| | | tested | |
| last_ran | Last Ran | Last date ESD station | n/a |
| | | tested | |
| prev_ran | Prev Ran | Previous date ESD | n/a |
| | | station tested | |

ASP Pages Affected:

/semp/setup/esd/default.asp

/semp/setup/esd/submit.asp

/semp/setup/esd/edit/default.asp

/semp/setup/esd/edit/submit.asp

/semp/setup/esd/edit/esd_add.asp

/semp/setup/esd/edit/esd_delete.asp

/semp/setup/esd/edit/esd_edit.asp

/semp/user/esdstation/default.asp

/semp/user/esdstation/edit.asp

/semp/report/esdstation/generate.asp

FIG. 45 is a representative “tblESDStationEntry” Properties. This table is used to store the user-entered test data for the ESD stations.

TABLE 42
TABLE PARAMETERS

| Column | Common | | Default |
|---|---|---|---|
| Name | Name | Purpose | Value |
| report_id | Report ID | Unique Report ID | n/a |
| esdstation_id | ESD Station ID | Unique ID for every | n/a |
| | | ESD Station | |
| input_date | Input Date | Date/Time Equipment | n/a |
| | | added to database | |
| esd_station | ESD Station Desc | text description of | n/a |
| | | ESD Station | |
| test_date | Test Date | User entered test date | n/a |
| oper | Operate bit | User entered test | n/a |
| | | value | |
| ssv_shut | SSV Shut time | User entered test | n/a |
| | | value | |
| scssv_shut | SCSSV Shut | User entered test | n/a |
| | time | value | |
| update_time | Update Time | time when table entry | n/a |
| | | updated | |
| skipped | skipped bit | bit to determine if | 0 |
| | | test has been skipped | |
| thisreport | Report Flag | Indicates if ESD | n/a |
| | | station has been | |
| | | tested on this report | |

ASP Pages Affected:

/semp/user/esdstation/default.asp

/semp/user/esdstation/edit.asp

/semp/report/esdstation/generate.asp

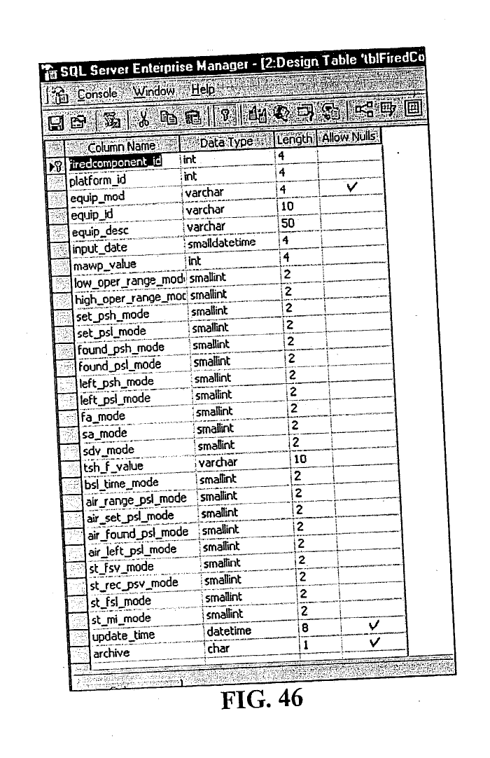

FIG. 46 is a representative “tblFiredComponent” Properties. This table is used to store platform setup data for the Fired Component equipment class. The actual user entered test data is stored in tblFiredComponentEntry.

TABLE 43
TABLE PARAMETERS

| Column | Common | | Default |
|---|---|---|---|
| Name | Name | Purpose | Value |
| firedcomponent_id | Fired | Key - unique ID | n/a |
| | Component ID | for each Fired | |
| | | Component | |
| | | (Table Entry) | |
| platform_id | Platform ID | Relates the Fired | n/a |
| | | Component table | |
| | | entry to the relevant | |
| | | Platform ID | |
| equip_id | Equipment ID | The Equipment ID | n/a |
| | | component of the | |
| | | Fired Component | |
| | | name - displayed | |
| | | on all user | |
| | | and setup pages | |
| equip_mod | Equipment | 3 letter code that | n/a |
| | Modifier | determines Fired | |
| | | Component type - | |
| | | displayed on all | |
| | | user and setup pages | |
| equip_desc | Equipment | Text sting describing | n/a |
| | Description | equipment service | |
| input_date | Input Date | Date/Time Equipment | n/a |
| | | added to database | |
| mawp_value | MAWP | Maximum Allowed | n/a |
| | | Working Pressure | |
| | | for equipment | |
| low_oper_{—} | Operating | Mode for Operating | n/a |
| range_mode | Range Low | Range Low | |
| high_oper_{—} | Operating | Mode for Operating | n/a |
| range_mode | Range high | Range High | |
| set_psh_mode | Set PSH | Set PSH mode | n/a |
| set_psl_mode | Set PSL | Set PSL mode | n/a |
| found_psh_mode | Found PSH | Found PSH mode | n/a |
| found_psl_mode | Found PSL | Found PSL mode | n/a |
| left_psh_mode | Left PSH | Left PSH mode | n/a |
| left_psl_mode | Left PSL | Left PSL mode | n/a |
| fa_mode | FA Mode | FA Mode | n/a |
| sa_mode | SA Mode | SA Mode | n/a |
| sdv_mode | SDV Mode | SDV Mode | n/a |
| tsh_f_value | TSH Value | Temperature Safety | n/a |
| | | High value | |
| bsl_time_mode | BSL Time Mode | BSL Time Mode | n/a |
| air_range_{—} | Air Range PSL | Air Range PSL Mode | n/a |
| psl_mode | | | |
| air_set_psl_{—} | Air Set PSL | Air Set PSL Mode | n/a |
| mode | | | |
| air_found_psl_{—} | Air Found PSL | Air Found PSL Mode | n/a |
| mode | | | |
| air_left_psl_{—} | Air Left PSL | Air Left PSL Mode | n/a |
| mode | | | |
| st_fsv_mode | ST FSV | ST FSV Mode | n/a |
| st_rec_psv_mode | ST Rec PSV | ST Rec PSV Mode | n/a |
| st_fsl_mode | ST FSL | ST FSL Mode | n/a |
| st_mi_mode | ST MI | ST MI Mode | n/a |
| update_time | Update Time | time when table | n/a |
| | | entry updated | |
| archive | Archive bit | bit to determine if | 0 |
| | | item has been | |
| | | archived | |

ASP Pages Affected:

/semp/setup/firedcomponent/default.asp

/semp/setup/firedcomponent/submit.asp

/semp/setup/firedcomponent/edit/default.asp

/semp/setup/firedcomponent/edit/submit.asp

/semp/setup/firedcomponent/edit/fired_add.asp

/semp/setup/firedcomponent/edit/fired_delete.asp

/semp/setup/firedcomponent/edit/fired_edit.asp

/semp/report/firedcomponent/generate.asp

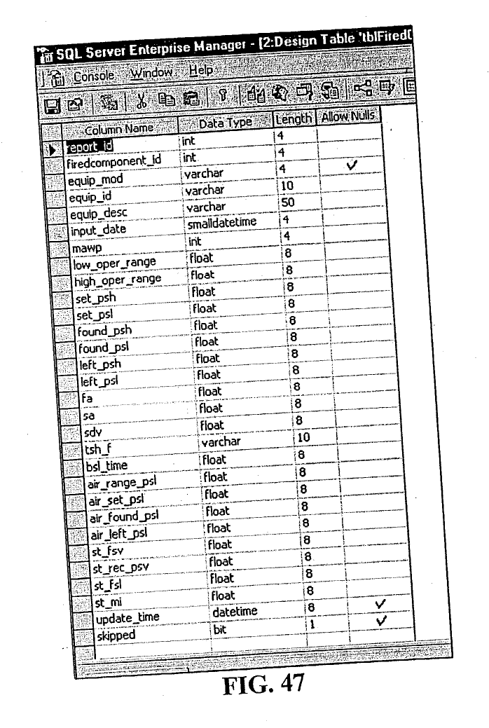

FIG. 47 is a representative “tblFiredComponentEntry” Properties. This table is used to store the user entered test data for the Fired Component equipment class. The component setup data is stored in tblFiredComponent.

TABLE 44
TABLE PARAMETERS

| Column | Common | | Default |
|---|---|---|---|
| Name | Name | Purpose | Value |
| firedcomponent_id | Fired | Key - unique ID | n/a |
| | Component ID | for each Fired | |
| | | Component | |
| | | (Table Entry) | |
| report_id | Report ID | Relates the Fired | n/a |
| | | Component table | |
| | | entry to the | |
| | | relevant Report ID | |
| equip_id | Equipment ID | The Equipment ID | n/a |
| | | component of the | |
| | | Fired Component | |
| | | name - displayed | |
| | | on all user and | |
| | | setup pages | |
| equip_mod | Equipment | 3 letter code that | n/a |
| | Modifier | determines Fired | |
| | | Component type - | |
| | | displayed on all | |
| | | user and setup pages | |
| equip_desc | Equipment | Text sting describing | n/a |
| | Description | equipment service | |
| input_date | Input Date | Date/Time Equipment | n/a |
| | | added to database | |
| mawp | MAWP | Maximum Allowed | n/a |
| | | Working Pressure | |
| | | for equipment | |
| low_oper_range | Operating | Operating Range Low | n/a |
| | Range Low | user input value | |
| high_oper_range | Operating | Operating Range High | n/a |
| | Range high | user input value | |
| set_psh | Set PSH | Set PSH user input | n/a |
| | | value (if app.) | |
| set_psl | Set PSL | Set PSL user input | n/a |
| | | value (if app.) | |
| found_psh | Found PSH | Found PSH user input | n/a |
| | | value (if app.) | |
| found_psl | Found PSL | Found PSL user input | n/a |
| | | value (if app.) | |
| left_psh | Left PSH | Left PSH user input | n/a |
| | | value (if app.) | |
| left_psl | Left PSL | Left PSL user input | n/a |
| | | value (if app.) | |
| fa | FA | FA user input value | n/a |
| | | (if app.) | |
| sa | SA | SA user input value | n/a |
| | | (if app.) | |
| sdv | SDV | SDV user input value | n/a |
| | | (if app.) | |
| tsh_f | TSH Value | Temperature Safety | n/a |
| | | High value | |
| bsl_time | BSL Time | BSL Time user input | n/a |
| | | value (if app.) | |
| air_range_psl | Air Range PSL | Air Range PSL user | n/a |
| | | input value (if app.) | |
| air_set_psl | Air Set PSL | Air Set PSL user | n/a |
| | | input value (if app.) | |
| air_found_psl | Air Found PSL | Air Found PSL user | n/a |
| | | input value (if app.) | |
| air_left_psl | Air Left PSL | Air Left PSL user | n/a |
| | | input value (if app.) | |
| st_fsv | ST FSV | ST FSV user input | n/a |
| | | value (if app.) | |
| st_rec_psv | ST Rec PSV | ST Rec PSV user | n/a |
| | | input value (if app.) | |
| st_fsv | ST FSL | ST FSL user input | n/a |
| | | value (if app.) | |
| st_mi | ST MI | ST MI user input | n/a |
| | | value (if app.) | |
| update_time | Update Time | time when table | n/a |
| | | entry updated | |
| skipped | skipped bit | bit to determine if | 0 |
| | | item has been skipped | |
| | | for given report id | |

ASP Pages Affected:

/semp/user/skippedreport/firedcomponent/edit.asp

/semp/user/skippedreport/firedcomponent/default.asp

/semp/user/skippedreport/firedcomponent/submit.asp

/semp/report/firedcomponent/generate.asp

FIG. 48 is a representative “tblHeader” Properties. This table is used to store platform setup data for the Header equipment class. The actual user entered test data is stored in tblHeaderEntry.

TABLE 45
TABLE PARAMETERS

| Column | Common | | Default |
|---|---|---|---|
| Name | Name | Purpose | Value |
| header_id | Header ID | Key - unique ID | n/a |
| | | for each Header | |
| | | (Table Entry) | |
| platform_id | Platform ID | Relates the Header | n/a |
| | | table entry to the | |
| | | relevant Platform ID | |
| equip_id | Equipment ID | The Equipment ID | n/a |
| | | component of the | |
| | | Header name - | |
| | | displayed on all user | |
| | | and setup pages | |
| equip_mod | Equipment | 3 letter code that | n/a |
| | Modifier | determines Header | |
| | | type - displayed on | |
| | | all user and setup | |
| | | pages | |
| equip_desc | Equipment | Text sting describing | n/a |
| | Description | equipment service | |
| input_date | Input Date | Date/Time Equipment | n/a |
| | | added to database | |
| mawp_value | MAWP | Maximum Allowed | n/a |
| | | Working Pressure | |
| | | for equipment | |
| low_oper_{—} | Operating | Mode for Operating | n/a |
| range_mode | Range Low | Range Low | |
| high_oper_{—} | Operating | Mode for Operating | n/a |
| range_mode | Range high | Range High | |
| set_psh_mode | Set PSH | Set PSH mode | n/a |
| set_psl_mode | Set PSL | Set PSL mode | n/a |
| found_psh_mode | Found PSH | Found PSH mode | n/a |
| found_psl_mode | Found PSL | Found PSL mode | n/a |
| left_psh_mode | Left PSH | Left PSH mode | n/a |
| left_psl_mode | Left PSL | Left PSL mode | n/a |
| rec_psv_mode | Rec PSV | Rec PSV Mode | n/a |
| tse_mode | TSE | TSE Mode | n/a |
| test_sdv_mode | SDV | SDV Mode | n/a |
| update_time | Update Time | time when table entry | n/a |
| | | updated | |
| archive | Archive bit | bit to determine | 0 |
| | | if item has been | |
| | | archived | |

ASP Pages Affected:

/semp/setup/header/default.asp

/semp/setup/header/submit.asp

/semp/setup/header/edit/default.asp

/semp/setup/header/edit/submit.asp

/semp/setup/header/edit/header_add.asp

/semp/setup/header/edit/header_delete.asp

/semp/setup/header/edit/header_edit.asp

/semp/report/header/generate.asp

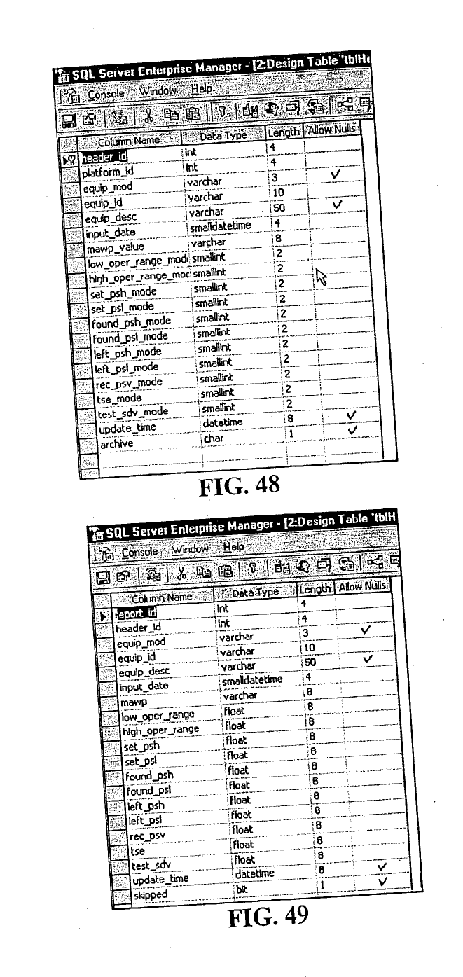

FIG. 49 is a representative “tblHeaderEntry” Properties. This table is used to store the user-entered test data for the Header equipment class. The setup data is stored in tblHeader.

TABLE 46
TABLE PARAMETERS

| Column | Common | | Default |
|---|---|---|---|
| Name | Name | Purpose | Value |
| header_id | Header ID | Key - unique ID | n/a |
| | | for each Header | |
| | | (Table Entry) | |
| report_id | Report ID | Relates the header | n/a |
| | | table entry to the | |
| | | relevant report ID | |
| equip_id | Equipment ID | The Equipment ID | n/a |
| | | component of the | |
| | | Header name - | |
| | | displayed on all | |
| | | user and setup pages | |
| equip_mod | Equipment | 3 letter code that | n/a |
| | Modifier | determines Header | |
| | | type - displayed on | |
| | | all user and setup | |
| | | pages | |
| equip_desc | Equipment | Text sting describing | n/a |
| | Description | equipment service | |
| input_date | Input Date | Date/Time Equipment | n/a |
| | | added to database | |
| mawp | MAWP | Maximum Allowed | n/a |
| | | Working Pressure | |
| | | for equipment | |
| low_oper_range | Operating | Operating Range Low | n/a |
| | Range Low | user input value | |
| high_oper_range | Operating | Operating Range High | n/a |
| | Range high | user input value | |
| set_psh | Set PSH | Set PSH user input | n/a |
| | | value | |
| set_psl | Set PSL | Set PSL user input | n/a |
| | | value | |
| found_psh | Found PSH | Found PSH user input | n/a |
| | | value | |
| found_psl | Found PSL | Found PSL user input | n/a |
| | | value | |
| left_psh | Left PSH | Left PSH user input | n/a |
| | | value | |
| left_psl | Left PSL | Left PSL user input | n/a |
| | | value | |
| rec_psv | Rec PSV | Rec PSV user input | n/a |
| | | value | |
| tse | TSE | TSE user input value | n/a |
| test_sdv | SDV | SDV user input value | n/a |
| update_time | Update Time | time when table entry | n/a |
| | | updated | |
| skipped | skipped bit | bit to determine if | 0 |
| | | item has been skipped | |

ASP Pages Affected:

/semp/user/skippedreport/header/edit.asp

/semp/user/skippedreport/header/default.asp

/semp/user/skippedreport/header/submit.asp

/semp/report/header/generate.asp

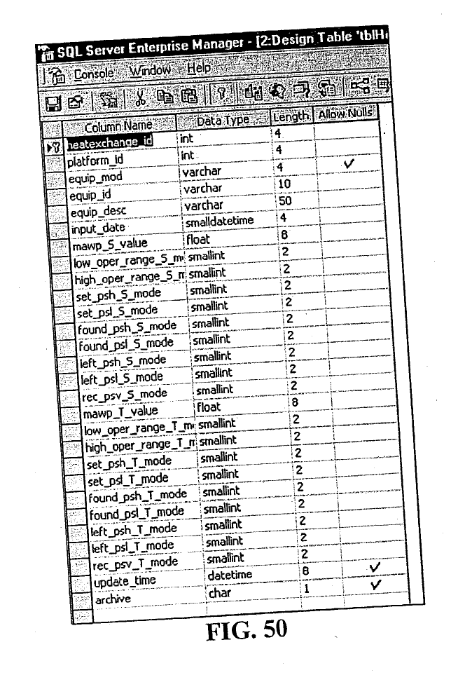

FIG. 50 is a representative “tblHeatExchange” Properties. This table is used to store platform setup data for the Heat Exchanger equipment class. The actual user entered test data is stored in tblHeatExchangeEntry.

TABLE 47
TABLE PARAMETERS

| Column | Common | | Default |
|---|---|---|---|
| Name | Name | Purpose | Value |
| heatexchange_id | Component | Key - unique ID | n/a |
| | table ID | for each component | |
| | | (Table Entry) | |
| platform_id | Platform ID | Relates the table | n/a |
| | | entry to the | |
| | | relevant | |
| | | Platform ID | |
| equip_id | Equipment | The Equipment ID | n/a |
| | ID | component of the | |
| | | component name - | |
| | | displayed on all | |
| | | user and setup pages | |
| equip_mod | Equipment | 3 letter code that | n/a |
| | Modifier | determines component | |
| | | type - displayed on | |
| | | all user and setup | |
| | | pages | |
| equip_desc | Equipment | Text sting | n/a |
| | Description | describing equipment | |
| | | service | |
| input_date | Input Date | Date/Time Equipment | n/a |
| | | added to database | |
| mawp_S_value | MAWP- Shell | Maximum Allowed | n/a |
| | | Working Pressure | |
| | | for equipment | |
| | | (Shell) | |
| high_oper_{—} | Operating Range | Mode for Operating | n/a |
| range_S_mode | High- Shell | Range High (Shell) | |
| low_oper_{—} | Operating Range | Mode for Operating | n/a |
| range_S_mode | Low- Shell | Range Low (Shell) | |
| set_psh_S_mode | Set PSH- Shell | Set PSH mode (Shell) | n/a |
| set_psl_S_mode | Set PSL- Shell | Set PSL mode (Shell) | n/a |
| found_psh_S_{—} | Found PSH- | Found PSH mode | n/a |
| mode | Shell | (Shell) | |
| found_psl_S_{—} | Found PSL- | Found PSL mode | n/a |
| mode | Shell | (Shell) | |
| left_psh_S_mode | Left PSH- Shell | Left PSH mode | n/a |
| | | (Shell) | |
| left_psl_S_mode | Left PSL- Shell | Left PSL mode | n/a |
| | | (Shell) | |
| rec_psv_S_mode | Rec PSV- Shell | Rec PSV Mode (Shell) | n/a |
| mawp_T_value | MAWP - Tube | Maximum Allowed | n/a |
| | | Working Pressure | |
| | | for equipment (Tube) | |
| high_oper_{—} | Operating Range | Mode for Operating | n/a |
| range_T_mode | High - Tube | Range High (Tube) | |
| low_oper_{—} | Operating Range | Mode for Operating | n/a |
| range_T_mode | Low - Tube | Range Low (Tube) | |
| set_psh_T_mode | Set PSH - Tube | Set PSH mode (Tube) | n/a |
| set_psl_T_mode | Set PSL - Tube | Set PSL mode (Tube) | n/a |
| found_psh_T_{—} | Found PSH - | Found PSH mode | n/a |
| mode | Tube | (Tube) | |
| found_psl_T_{—} | Found PSL - | Found PSL mode | n/a |
| mode | Tube | (Tube) | |
| left_psh_T_mode | Left PSH - Tube | Left PSH mode | n/a |
| | | (Tube) | |
| left_psl_T_mode | Left PSL - Tube | Left PSL mode | n/a |
| | | (Tube) | |
| rec_psv_T_mode | Rec PSV - Tube | Rec PSV Mode (Tube) | n/a |
| update_time | Update Time | time when table | n/a |
| | | entry updated | |
| archive | Archive bit | bit to determine | 0 |
| | | if item has been | |
| | | archived | |

ASP Pages Affected:

/semp/setup/heatexchanger/default.asp

/semp/setup/heatexchanger/submit.asp

/semp/setup/heatexchanger/edit/default.asp

/semp/setup/heatexchanger/edit/submit.asp

/semp/setup/heatexchanger/edit/heatexchange_add.asp

/semp/setup/heatexchanger/edit/heatexchange_delete.asp

/semp/setup/heatexchanger/edit/heatexchange_edit.asp

/semp/report/heatexchanger/generate.asp

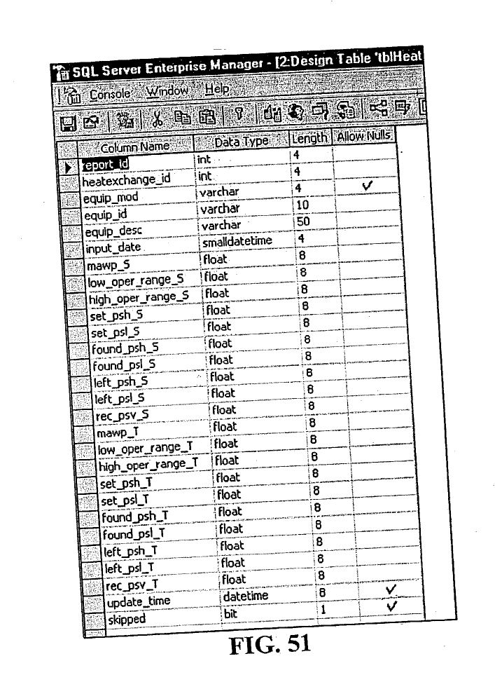

FIG. 51 is a representative “tblHeatExchangeEntry” Properties. This table is used to store user-entered test data for the Heat Exchanger equipment class. The setup data is stored in tblHeatExchange.

TABLE 48
TABLE PARAMETERS

| Column | Common | | Default |
|---|---|---|---|
| Name | Name | Purpose | Value |
| heatexchange_id | Component | Key - unique ID | n/a |
| | table ID | for each component | |
| | | (Table Entry) | |
| report_id | Report ID | Relates the table | n/a |
| | | entry to the | |
| | | relevant Report ID | |
| equip_id | Equipment ID | The Equipment ID | n/a |
| | | component of the | |
| | | component name - | |
| | | displayed on all | |
| | | user and setup pages | |
| equip_mod | Equipment | 3 letter code that | n/a |
| | Modifier | determines component | |
| | | type - displayed on | |
| | | all user and setup | |
| | | pages | |
| equip_desc | Equipment | Text sting | n/a |
| | Description | describing | |
| | | equipment service | |
| input_date | Input Date | Date/Time Equipment | n/a |
| | | added to database | |
| mawp_S | MAWP- Shell | Maximum Allowed | n/a |
| | | Working Pressure | |
| | | for equipment | |
| | | (Shell) user input | |
| | | value | |
| high_oper_{—} | Operating Range | Operating Range High | n/a |
| range_S | High- Shell | (Shell) user input | |
| | | value | |
| low_oper_{—} | Operating Range | Operating Range Low | n/a |
| range_S | Low- Shell | (Shell) user input | |
| | | value | |
| set_psh_S | Set PSH- Shell | Set PSH (Shell) | n/a |
| | | user input value | |
| set_psl_S | Set PSL- Shell | Set PSL (Shell) | n/a |
| | | user input value | |
| found_psh_S | Found PSH- | Found PSH (Shell) | n/a |
| | Shell | user input value | |
| found_psl_S | Found PSL- | Found PSL (Shell) | n/a |
| | Shell | user input value | |
| left_psh_S | Left PSH- Shell | Left PSH (Shell) | n/a |
| | | user input value | |
| left_psl_S | Left PSL- Shell | Left PSL (Shell) | n/a |
| | | user input value | |
| rec_psv_S | Rec PSV- Shell | Rec PSV (Shell) | n/a |
| | | user input value | |
| mawp_T | MAWP - Tube | Maximum Allowed | n/a |
| | | Working Pressure | |
| | | for equipment (Tube) | |
| | | user input value | |
| high_oper_{—} | Operating Range | Operating Range | n/a |
| range_T | High - Tube | High (Tube) user | |
| | | input value | |
| low_oper_{—} | Operating Range | Operating Range Low | n/a |
| range_T | Low - Tube | (Tube) user input | |
| | | value | |
| set_psh_T | Set PSH - Tube | Set PSH (Tube) user | n/a |
| | | input value | |
| set_psl_T | Set PSL - Tube | Set PSL (Tube) user | n/a |
| | | input value | |
| found_psh_T | Found PSH - | Found PSH (Tube) | n/a |
| | Tube | user input value | |
| found_psl_T | Found PSL - | Found PSL (Tube) | n/a |
| | Tube | user input value | |
| left_psh_T | Left PSH - Tube | Left PSH (Tube) user | n/a |
| | | input value | |
| left_psl_T | Left PSL - Tube | Left PSL (Tube) user | n/a |
| | | input value | |
| rec_psv_T | Rec PSV - Tube | Rec PSV (Tube) user | n/a |
| | | input value | |
| update_time | Update Time | time when table | n/a |
| | | entry updated | |
| skipped | skipped bit | bit to determine | 0 |
| | | if item has been | |
| | | skipped | |

ASP Pages Affected:

/semp/user/skippedreport/heatexchange/edit.asp

/semp/user/skippedreport/heatexchange/default.asp

/semp/user/skippedreport/heatexchange/submit.asp

/semp/report/heatexchange/generate.asp

FIG. 52 is a representative “tblHistory” Properties. This table is used to store and record transactions to tblUser. All inserts into the table are tracked as well as updates.

TABLE 49
TABLE PARAMETERS

| Column | Common | | Default |
|---|---|---|---|
| Name | Name | Purpose | Value |
| user_id | User id | Identifies who | n/a |
| | | has performed the | |
| | | action | |
| time_executed | Time | Identifies when | n/a |
| | | the action was | |
| | | taken | |
| action | Action | Action Taken | n/a |

ASP Pages Affected:

/semp/account/user/update.asp

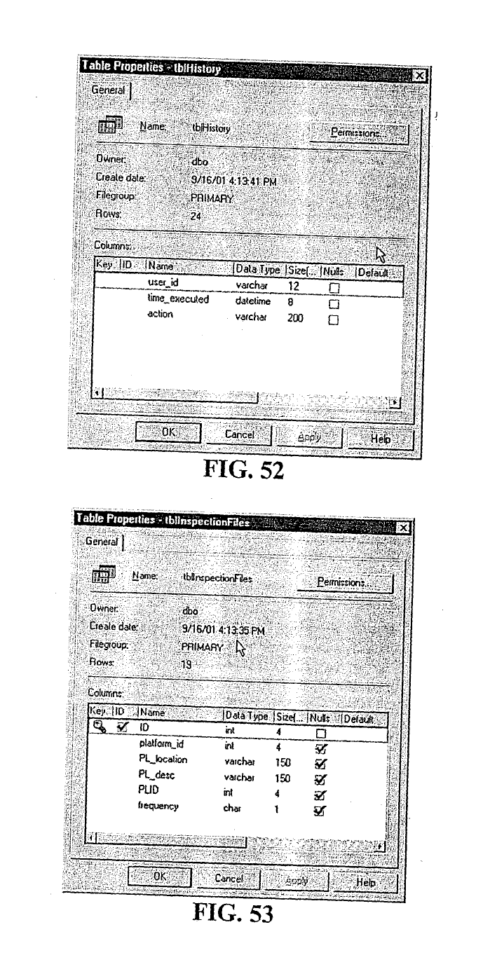

FIG. 53 is a representative “tblInspectionFiles” Properties. This table is used to store the links and description data for the Compliance e-library uploaded inspection files.

TABLE 50
TABLE PARAMETERS

| Column | Common | | Default |
|---|---|---|---|
| Name | Name | Purpose | Value |
| ID | Checklist ID | Unique ID for | n/a |
| | | each checklist | |
| platform_id | Platform ID | Relates the table | n/a |
| | | entry to the | |
| | | relevant Platform ID | |
| PL_location | PL location | Provides link to | n/a |
| | | Inspection | |
| | | e-library file | |
| | | location | |
| PL_description | PL Description | Provided text | n/a |
| | | description of | |
| | | e-library file | |
| | | item | |
| PLID | Library ID | Provided ID for | n/a |
| | | item classification | |
| frequency | Frequency | Test Frequency | n/a |
| | | for item | |

ASP Pages Affected:

/semp/setup/checklistmgmt/addcomments.asp

/semp/setup/checklistmgmt/Addfile.asp

/semp/setup/checklistmgmt/deletefile.asp

/semp/setup/checklistmgmt/deleteindex.asp

/semp/setup/checklistmgmt/upload.asp

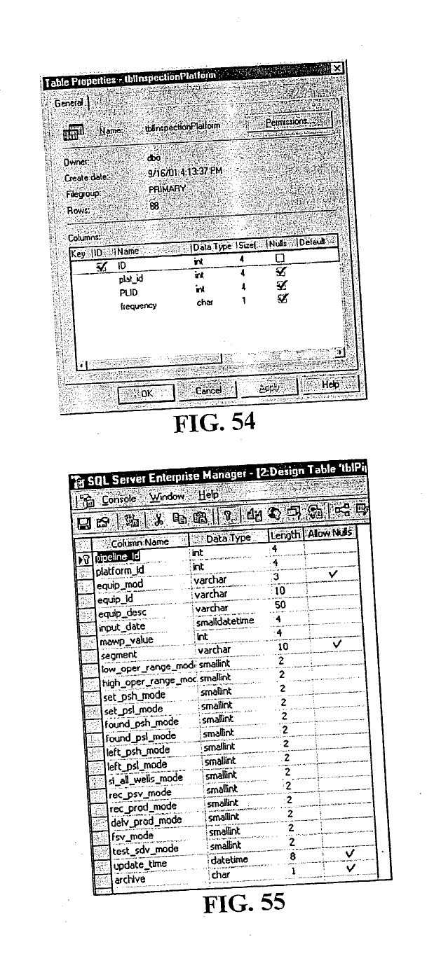

FIG. 54 is a representative “tblInspectionPlatform” Properties. This table is used to store the category data for the Compliance e-library uploaded inspection files.

TABLE 51
TABLE PARAMETERS

| Column | Common | | Default |
|---|---|---|---|
| Name | Name | Purpose | Value |
| ID | Checklist ID | Unique ID for each | n/a |
| | | checklist | |
| plat_id | Platform ID | Relates the table | n/a |
| | | entry to the relevant | |
| | | Platform ID | |
| PLID | Library ID | Provided ID for item | n/a |
| | | classification | |
| frequency | Frequency | Test Frequency for item | n/a |

ASP Pages Affected:

/semp/setup/checklistmgmt/addcomments.asp

/semp/setup/checklistmgmt/Addfile.asp

/semp/setup/checklistmgmt/deletefile.asp

/semp/setup/checklistmgmt/deleteindex.asp

/semp/setup/checklistmgmt/upload.asp

/semp/setup/checklistmgmt/EditInspection.asp

FIG. 55 is a representative “tblPipeline” Properties. This table is used to store platform setup data for the Pipeline equipment class. The actual user entered test data is stored in tblPipelineEntry.

TABLE 52
TABLE PARAMETERS

| Column | Common | | Default |
|---|---|---|---|
| Name | Name | Purpose | Value |
| pipeline_id | Pipeline ID | Key - unique ID | n/a |
| | | for each component | |
| | | (Table Entry) | |
| platform_id | Platform ID | Relates the table | n/a |
| | | entry to the relevant | |
| | | Platform ID | |
| equip_id | Equipment ID | The Equipment ID | n/a |
| | | component of the | |
| | | component name - | |
| | | displayed on all | |
| | | user and setup | |
| | | pages | |
| equip_mod | Equipment | 3 letter code that | n/a |
| | Modifier | determines component | |
| | | type - displayed on | |
| | | all user and setup | |
| | | pages | |
| equip_desc | Equipment | Text sting describing | n/a |
| | Description | equipment service | |
| input_date | Input Date | Date/Time Equipment | n/a |
| | | added to database | |
| mawp_value | MAWP | Maximum Allowed | n/a |
| | | Working Pressure | |
| | | for component | |
| segment | Segment | Segment number | n/a |
| low_oper_{—} | Operating | Mode for Operating | n/a |
| range_mode | Range Low | Range Low | |
| high_oper_{—} | Operating | Mode for Operating | n/a |
| range_mode | Range high | Range High | |
| set_psh_mode | Set PSH | Set PSH mode | n/a |
| set_psl_mode | Set PSL | Set PSL mode | n/a |
| found_psh_mode | Found PSH | Found PSH mode | n/a |
| found_psl_mode | Found PSL | Found PSL mode | n/a |
| left_psh_mode | Left PSH | Left PSH mode | n/a |
| left_psl_mode | Left PSL | Left PSL mode | n/a |
| si_all_wells_{—} | SI All Wells | Shut In All Wells | n/a |
| mode | | Mode | |
| rec_psv_mode | Rec PSV | Rec PSV Mode | n/a |
| tse_mode | TSE | TSE Mode | n/a |
| rec_prod_mode | Rec Prod | Receive Production | n/a |
| | | Mode | |
| delv_prod_mode | Deliver Prod | Deliver Production | n/a |
| | | Mode | |
| fsv_mode | FSV Mode | FSC Mode | n/a |
| test_sdv_mode | SDV | SDV Mode | n/a |
| update_time | Update Time | time when table | n/a |
| | | entry updated | |
| archive | Archive bit | bit to determine | 0 |
| | | if item has been | |
| | | archived | |

ASP Pages Affected:

/semp/setup/pipeline/default.asp

/semp/setup/pipeline/submit.asp

/semp/setup/pipeline/edit/default.asp

/semp/setup/pipeline/edit/submit.asp

/semp/setup/pipeline/edit/pipeline_add.asp

/semp/setup/pipeline/edit/pipeline_delete.asp

/semp/setup/pipeline/edit/pipeline_edit.asp

/semp/report/pipeline/generate.asp

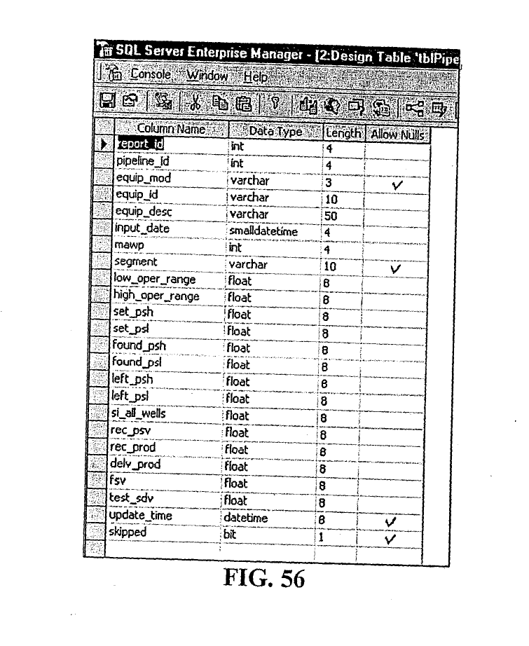

FIG. 56 is a representative “tblPipelineEntry” Properties. This table is used to store the user-entered test data for the Pipeline equipment class. The setup data is stored in tblPipeline.

TABLE 53
TABLE PARAMETERS

| Column | Common | | Default |
|---|---|---|---|
| Name | Name | Purpose | Value |
| pipeline_id | Pipeline ID | Key - unique ID | n/a |
| | | for each component | |
| | | (Table Entry) | |
| report_id | Report ID | Relates the component | n/a |
| | | table entry to the | |
| | | relevant report ID | |
| equip_id | Equipment ID | The Equipment ID | n/a |
| | | component of the | |
| | | component name - | |
| | | displayed on all | |
| | | user and setup pages | |
| equip_mod | Equipment | 3 letter code that | n/a |
| | Modifier | determines Header | |
| | | type - displayed on | |
| | | all user and setup | |
| | | pages | |
| equip_desc | Equipment | Text sting describing | n/a |
| | Description | equipment service | |
| input_date | Input Date | Date/Time Equipment | n/a |
| | | added to database | |
| mawp | MAWP | Maximum Allowed | n/a |
| | | Working Pressure | |
| | | for equipment | |
| segment | Segment | Segment value | n/a |
| low_oper_range | Operating | Operating Range | n/a |
| | Range Low | Low user input | |
| | | value | |
| high_oper_range | Operating | Operating Range | n/a |
| | Range high | High user input | |
| | | value | |
| set_psh | Set PSH | Set PSH user | n/a |
| | | input value | |
| set_psl | Set PSL | Set PSL user | n/a |
| | | input value | |
| found_psh | Found PSH | Found PSH user | n/a |
| | | input value | |
| found_psl | Found PSL | Found PSL user | n/a |
| | | input value | |
| left_psh | Left PSH | Left PSH user | n/a |
| | | input value | |
| left_psl | Left PSL | Left PSL user | n/a |
| | | input value | |
| si_all_wells | SI All Wells | Shut In All | n/a |
| | | Wells value | |
| rec_psv | Rec PSV | Rec PSV user | n/a |
| | | input value | |
| tse | TSE | TSE user input | n/a |
| | | value | |
| rec_prod | Rec Prod | Receive Production | n/a |
| | | value | |
| delv_prod | Delv Prod | Deliver Production | n/a |
| fsv | FSV | FSV Test user | n/a |
| | | input value | |
| test_sdv | SDV | SDV user input | n/a |
| | | value | |
| update_time | Update Time | time when table | n/a |
| | | entry updated | |
| skipped | skipped bit | bit to determine | 0 |
| | | if item has been | |
| | | skipped | |

ASP Pages Affected:

/semp/user/skippedreport/pipeline/edit.asp

/semp/user/skippedreport/pipeline/default.asp

/semp/user/skippedreport/pipeline/submit.asp

/semp/report/pipeline/generate.asp

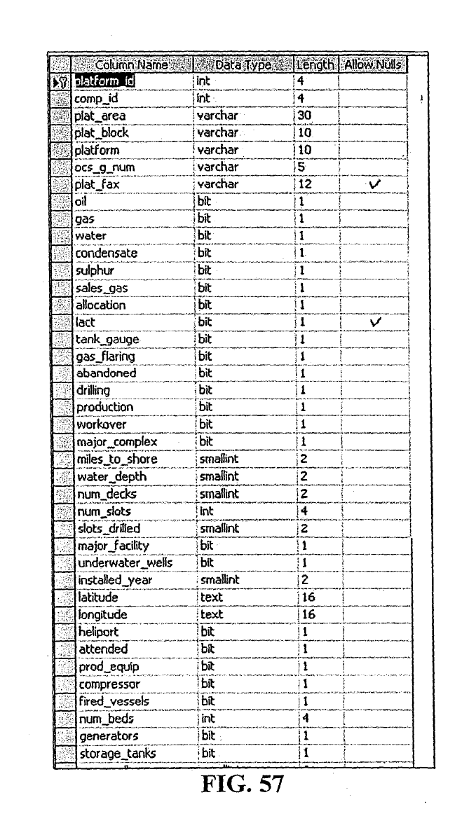

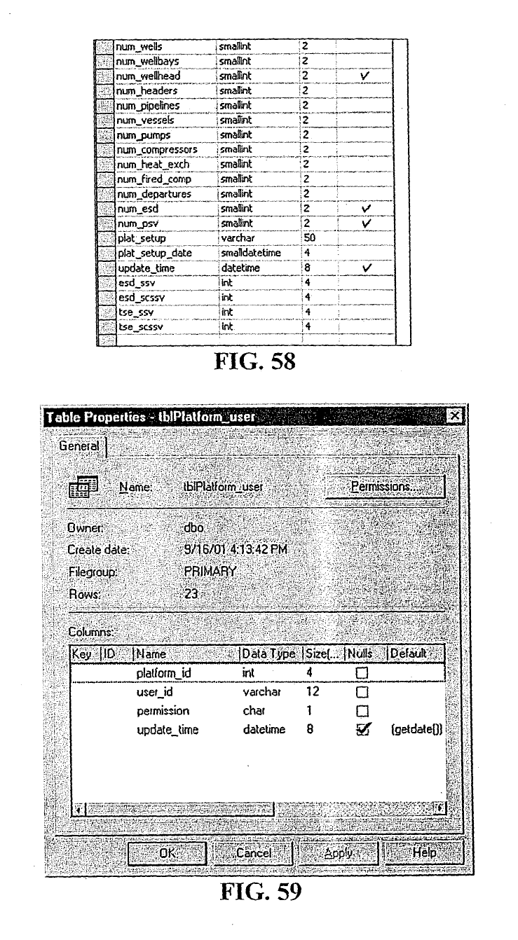

FIG. 57 is a representative “tblPlatform” Properties-I. FIG. 58 is a representative “tblPlatform” Properties-II. These tables are used to store fundamental platform setup data.

TABLE 54
TABLE PARAMETERS

| Column | Common | | Default |
|---|---|---|---|
| Name | Name | Purpose | Value |
| platform_id | Platform ID | key - unique number | n/a |
| | | for each platform | |
| comp_id | Company ID | Company ID (defined | n/a |
| | | in tblCompany) | |
| plat_area | Platform Area | Platform Area | n/a |
| plat_block | Platform Block | Platform Block | n/a |
| platform | Platform Desig | Platform Designation | n/a |
| ocs_g_num | OCSG Number | OCSG Designation | n/a |
| plat_fax | Fax number | Fax number | n/a |
| oil | Oil | Oil Production status | n/a |
| gas | Gas | Gas Production status | n/a |
| water | Water | Water Production | n/a |
| | | Status | |
| condensate | Condensate | Condensate Production | n/a |
| | | Status | |
| sulphur | Sulphur | Sulphur Production | n/a |
| | | Status | |
| sales_gas | Sales Gas | Sales Gas status | n/a |
| allocation | Allocation | Allocation status | n/a |
| lact | LACT | LACT Status | n/a |
| tank_guage | Tank Gauge | Tank Gauge Status | n/a |
| gas_flaring | Gas Flaring | Gas Flaring | n/a |
| | | Equipment Status | |
| abandoned | Abandoned | Platform Abandoned | n/a |
| | | Status | |
| drilling | Drilling | Drilling Status | n/a |
| production | Production | Production Status | n/a |
| workover | Workover | Workover Status | n/a |
| major_complex | Major Complex | Major Complex Status | n/a |
| miles_to_shore | Miles to Shore | Miles to Shore | n/a |
| water_depth | Water Depth | Water Depth | n/a |
| num_decks | Number of | Number of Decks | n/a |
| | Decks | | |
| num_slots | Number of | Number of Slots | n/a |
| | Slots | | |
| slots_drilled | Slots Drilled | Slots Drilled | n/a |
| major_facility | Major Facility | Major Facility Status | n/a |
| underwater_wells | Underwater | Underwater Wells | n/a |
| | Wells | | |
| installed_year | Installed Year | Installed Year | n/a |
| latitude | Latitude | Latitude | n/a |
| longitude | Longitude | Longitude | n/a |
| heliport | Heliport | Heliport Status | n/a |
| attended | Attended | Attended Status | n/a |
| prod_equipment | Production Eq. | Production Eq. | n/a |
| | | Status | |
| compressor | Compressor | Compressor present | n/a |
| | | Status | |
| fired_vessels | Fired Vessels | Fired Vessels | n/a |
| | | present Status | |
| num_beds | Number of beds | Number of beds | n/a |
| generators | Generators | Generators present | n/a |
| | | Status | |
| storage_tanks | Storage Tanks | Storage Tanks | n/a |
| | | present Status | |
| num_wells | Number of Wells | Number of Wells | n/a |
| num_wellbays | num of wellbays | num of wellbays | n/a |
| num_wellhead | num of wellhead | num of wellhead | n/a |
| num_headers | num of headers | num of headers | n/a |
| num_pipelines | num of pipelines | num of pipelines | n/a |
| num_vessels | num of vessels | num of vessels | n/a |
| num_pumps | num of pumps | num of pumps | n/a |
| num_compressors | num of | num of compressors | n/a |
| | compressors | | |
| num_heat_exch | num of | num of heatexchangers | n/a |
| | heatexchangers | | |
| num_fired_comp | num of fired | num of fired | n/a |
| | components | components | |
| num_departures | num of | num of departures | n/a |
| | departures | | |
| num_esd | num of esd | num of esd stations | n/a |
| | stations | | |
| num_psv | num of psvs | num of psvs | n/a |
| plat_setup | Platform Setup | user ID performing | n/a |
| | | setup | |
| plat_setup_date | Platform Setup | Date/Time of | n/a |
| | Date | Platform setup | |
| update_time | Update Time | Update Time | n/a |
| esd_ssv | ESD SSV time | ESD SSV time | 45 |
| esd_scssv | ESD SCSSV time | ESD SCSSV time | 120 |
| tse_ssv | TSE SSV time | TSE SSV time | 45 |
| tse_scssv | TSE SCSSV time | TSE SCSSV time | 120 |

ASP Pages Affected:

/semp/setup/pipeline/default.asp

/semp/setup/pipeline/submit.asp

/semp/setup/pipeline/edit/default.asp

/semp/setup/pipeline/edit/submit.asp

/semp/setup/pipeline/edit/pipeline_add.asp

/semp/setup/pipeline/edit/pipeline_delete.asp

/semp/setup/pipeline/edit/pipeline_edit.asp

/semp/report/pipeline/generate.asp

FIG. 59 is a representative “tblPlatform_User” Properties. This table is used to store permissions information for the platforms-I.e. which users have read/write authority.

TABLE 55
TABLE PARAMETERS

| Column | Common | | Default |
|---|---|---|---|
| Name | Name | Purpose | Value |
| platform_id | Platform ID | Unique ID for each | n/a |
| | | Platform | |
| user_id | User ID | User ID | n/a |
| permission | Permission | Users Permission for | n/a |
| | | that platform (read, | |
| | | write, or neither) | |
| update_time | update time | Time items was updated | n/a |

ASP Pages Affected:

/semp/setup/permissions/default.asp

/semp/setup/permissions/submit.asp

/semp/setup/permissions/edit/default.asp

/semp/setup/permissions/edit/submit.asp

/semp/setup/permissions/edit/permissions_edit.asp

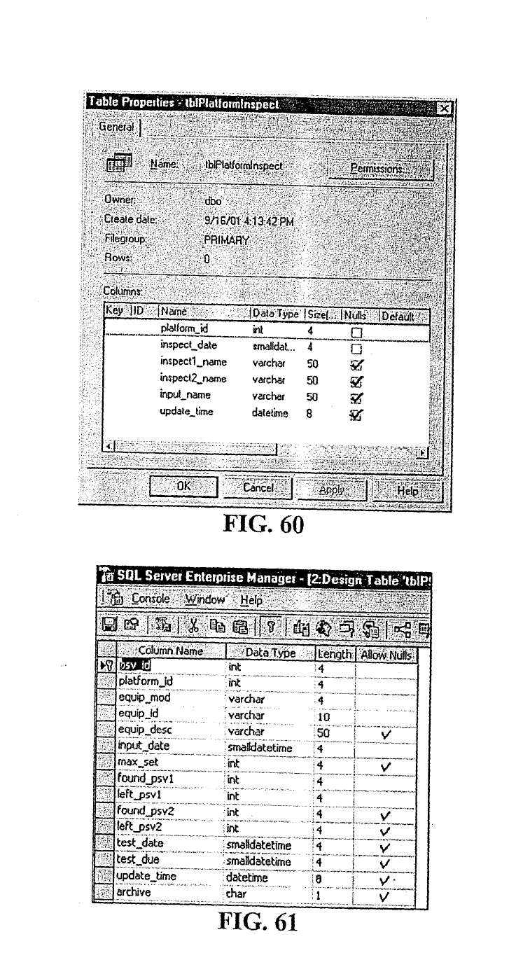

FIG. 60 is a representative “tblPlatformInspect” Properties. This table is optional and the data can be migrated to tblReport.

TABLE 56
TABLE PARAMETERS

| Column | Common | | Default |
|---|---|---|---|
| Name | Name | Purpose | Value |
| platform_id | Platform ID | Platform ID (generated | n/a |
| | | by tblPlatform) | |
| Inspect_date | Inspection Date | Date of Inspection | n/a |
| inspect1_name | Inspector 1 Name | Inspector 1 Name | n/a |
| inspect2_name | Inspector 2 Name | Inspector 2 Name | n/a |
| input_name | | | |
| update_time | update time | Time item was updated | n/a |

ASP Pages Affected:

/semp/setup/permissions/default.asp

/semp/setup/permissions/submit.asp

/semp/setup/permissions/edit/default.asp

/semp/setup/permissions/edit/submit.asp

/semp/setup/permissions/edit/permissions_edit.asp

FIG. 61 is a representative “tblPSVInspect” Properties. This table is used to store setup data for the PSV Component. The user entered test data is stored in tblPSVInspectEntry.

TABLE 57
TABLE PARAMETERS

| Column | Common | | Default |
|---|---|---|---|
| Name | Name | Purpose | Value |
| psv_id | PSV ID | Unique PSV ID | |
| platform_id | Platform ID | Platform ID (generated | n/a |
| | | by tblPlatform) | |
| equip_id | Equipment ID | The Equipment ID | n/a |
| | | component of the | |
| | | component name - | |
| | | displayed on all | |
| | | user and setup pages | |
| equip_mod | Equipment | 3 letter code that | n/a |
| | Modifier | determines component | |
| | | type - displayed on all | |
| | | user and setup pages | |
| equip_desc | Equipment | Text sting describing | n/a |
| | Description | equipment service | |
| input_date | Input Date | Date/Time Equipment | n/a |
| | | added to database | |
| max_set | MAX Set | Maximum Allowed | n/a |
| | | Setting for component | |
| found_psv1 | Found PSV 1 | Found PSV 1 | n/a |
| left_psv1 | Left PSV 1 | Left PSV 1 | n/a |
| found_psv2 | Found PSV 2 | Found PSV 2 (no | n/a |
| | | longer used) | |
| left_psv2 | Left PSV 2 | Left PSV 2 (no | n/a |
| | | longer used) | |
| test_date | Test Date | Date of Test | n/a |
| test_due | Test Due | Date next Test Due | n/a |
| update_time | update time | Time item was updated | n/a |
| archive | Archive bit | Determines if item | 0 |
| | | has been archived | |

ASP Pages Affected:

/semp/setup/psvinspect/default.asp

/semp/setup/psvinspect/submit.asp

/semp/setup/psvinspect/edit/default.asp

/semp/setup/psvinspect/edit/submit.asp

/semp/setup/psvinspect/edit/psv_edit.asp

/semp/setup/psvinspect/edit/psv_add.asp

/semp/setup/psvinspect/edit/psv_delete.asp

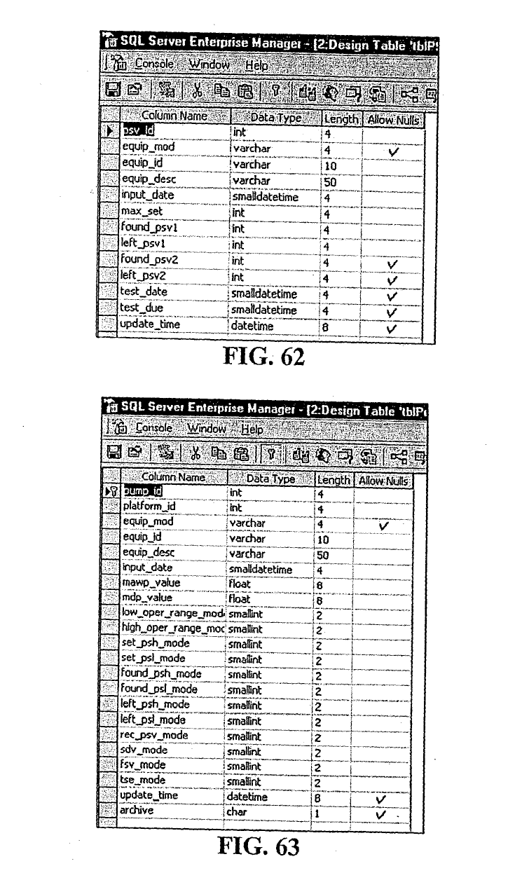

FIG. 62 is a representative “tblPSVInspectEntry” Properties. This table is used to store user entered test data for the PSV Component. The setup data is stored in tblPSVInspect.

TABLE 58
TABLE PARAMETERS

| Column | Common | | Default |
|---|---|---|---|
| Name | Name | Purpose | Value |
| psv_id | PSV ID | Unique PSV ID | |
| platform_id | Platform ID | Platform ID (generated | n/a |
| | | by tblPlatform) | |
| equip_id | Equipment ID | The Equipment ID | n/a |
| | | component of the | |
| | | component name - | |
| | | displayed on all | |
| | | user and setup pages | |
| equip_mod | Equipment | 3 letter code that | n/a |
| | Modifier | determines component | |
| | | type - displayed on | |
| | | all user and setup | |
| | | pages | |
| equip_desc | Equipment | Text sting describing | n/a |
| | Description | equipment service | |
| input_date | Input Date | Date/Time Equipment | n/a |
| | | added to database | |
| max_set | MAX Set | Maximum Allowed Setting | n/a |
| | | for component | |
| found_psv1 | Found PSV 1 | Found PSV 1 user | n/a |
| | | test data | |
| left_psv1 | Left PSV 1 | Left PSV 1 user | n/a |
| | | test data | |
| found_psv2 | Found PSV 2 | Found PSV 2 (no | n/a |
| | | longer used) | |
| left_psv2 | Left PSV 2 | Left PSV 2 (no | n/a |
| | | longer used) | |
| test_date | Test Date | Date of Test | n/a |
| test_due | Test Due | Date next Test Due | n/a |
| update_time | update time | Time item was updated | n/a |
| archive | Archive bit | Determines if item | 0 |
| | | has been archived | |

ASP Pages Affected:

/semp/user/psvinspect/default.asp

/semp/user/psvinspect/submit.asp

/semp/user/psvinspect/psvcomp.asp

/semp/user/psvinspect/edit.asp

FIG. 63 is a representative “tblPump” Properties. This table is used to store platform setup data for the Pump equipment class. The actual user entered test data is stored in tblPumpEntry.

TABLE 59
TABLE PARAMETERS

| Column | Common | | Default |
|---|---|---|---|
| Name | Name | Purpose | Value |
| pump_id | Pump ID | Key - unique ID for | n/a |
| | | each component | |
| | | (Table Entry) | |
| platform_id | Platform ID | Relates the table | n/a |
| | | entry to the relevant | |
| | | Platform ID | |
| equip_id | Equipment ID | The Equipment ID | n/a |
| | | component of the | |
| | | component name - | |
| | | displayed on all | |
| | | user and setup pages | |
| equip_mod | Equipment | 3 letter code that | n/a |
| | Modifier | determines component | |
| | | type - displayed on all | |
| | | user and setup pages | |
| equip_desc | Equipment | Text sting describing | n/a |
| | Description | equipment service | |
| input_date | Input Date | Date/Time Equipment | n/a |
| | | added to database | |
| mawp_value | MAWP | Maximum Allowed | n/a |
| | | Working Pressure | |
| | | for component | |
| mdp | Max Discharge | Max Discharge Press | n/a |
| | Pressure | | |
| high_oper_{—} | Operating | Mode for Operating | n/a |
| range_mode | Range high | Range High | |
| low_oper_{—} | Operating | Mode for Operating | n/a |
| range_mode | Range Low | Range Low | |
| set_psh_mode | Set PSH | Set PSH mode | n/a |
| set_psl_mode | Set PSL | Set PSL mode | n/a |
| found_psh_mode | Found PSH | Found PSH mode | n/a |
| found_psl_mode | Found PSL | Found PSL mode | n/a |
| left_psh_mode | Left PSH | Left PSH mode | n/a |
| left_psl_mode | Left PSL | Left PSL mode | n/a |
| rec_psv_mode | Rec PSV | Rec PSV Mode | n/a |
| sdv_mode | SDV | SDV Mode | n/a |
| fsv_mode | FSV Mode | FSC Mode | n/a |
| tse_mode | TSE | TSE Mode | n/a |
| update_time | Update Time | time when table | n/a |
| | | entry updated | |
| archive | Archive bit | bit to determine | 0 |
| | | if item has been | |
| | | archived | |

ASP Pages Affected:

/semp/setup/pump/default.asp

/semp/setup/pump/submit.asp

/semp/setup/pump/edit/default.asp

/semp/setup/pump/edit/submit.asp

/semp/setup/pump/edit/pump_add.asp

/semp/setup/pump/edit/pump_delete.asp

/semp/setup/pump/edit/pump_edit.asp

/semp/report/pump/generate.asp

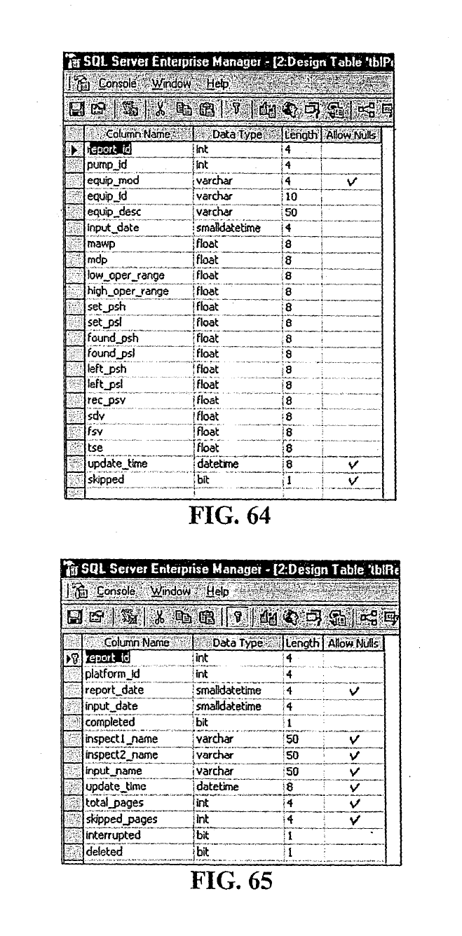

FIG. 64 is a representative “tblPumpEntry” Properties. This table is used to store platform user entered test data for the Pump equipment class. The setup data is stored in tblPump.

TABLE 60
TABLE PARAMETERS

| Column | Common | | Default |
|---|---|---|---|
| Name | Name | Purpose | Value |
| pump_id | Pump ID | Key - unique ID for | n/a |
| | | each component | |
| | | (Table Entry) | |
| report_id | Report ID | Relates the table | n/a |
| | | entry to the relevant | |
| | | Report ID | |
| equip_id | Equipment ID | The Equipment ID | n/a |
| | | component of the | |
| | | component name - | |
| | | displayed on all | |
| | | user and setup pages | |
| equip_mod | Equipment | 3 letter code that | n/a |
| | Modifier | determines component | |
| | | type - displayed on all | |
| | | user and setup pages | |
| equip_desc | Equipment | Text sting describing | n/a |
| | Description | equipment service | |
| input_date | Input Date | Date/Time Equipment | n/a |
| | | added to database | |
| mawp_value | MAWP | Maximum Allowed | n/a |
| | | Working Pressure | |
| | | for component | |
| mdp | Max Discharge | Max Discharge Press | n/a |
| | Pressure | | |
| high_oper_{—} | Operating | Operating Range High | n/a |
| range_mode | Range high | user test value | |
| low_oper_{—} | Operating | Operating Range Low | n/a |
| range_mode | Range Low | user test value | |
| set_psh_mode | Set PSH | Set PSH user test | n/a |
| | | value | |
| set_psl_mode | Set PSL | Set PSL user test | n/a |
| | | value | |
| found_psh_mode | Found PSH | Found PSH user test | n/a |
| | | value | |
| found_psl_mode | Found PSL | Found PSL user test | n/a |
| | | value | |
| left_psh_mode | Left PSH | Left PSH user test | n/a |
| | | value | |
| left_psl_mode | Left PSL | Left PSL user test | n/a |
| | | value | |
| rec_psv_mode | Rec PSV | Rec PSV user test | n/a |
| | | value | |
| sdv_mode | SDV | SDV user test value | n/a |
| fsv_mode | FSV | FSV user test value | n/a |
| tse_mode | TSE | TSE user test value | n/a |
| update_time | Update Time | time when table entry | n/a |
| | | updated | |
| skipped | skipped bit | bit to determine if | 0 |
| | | item has been skipped | |

ASP Pages Affected:

/semp/user/skippedreport/pump/default.asp

/semp/user/skippedreport/pump/submit.asp

/semp/user/skippedreport/pump/edit.asp

/semp/report/pump/generate.asp

FIG. 65 is a representative “tblReport” Properties. This table is used to store platform report data.

TABLE 61
TABLE PARAMETERS

| Column | Common | | Default |
|---|---|---|---|
| Name | Name | Purpose | Value |
| report_id | Report ID | key - unique Report ID | n/a |
| | | for every report | |
| platform_id | Platform ID | Relates the table entry | n/a |
| | | to the relevant Platform | |
| | | ID | |
| report_date | Report Date | User Entered Report Date | n/a |
| input_date | Input Date | Date/Time Report created | n/a |
| completed | Completed bit | bit indicating of report | n/a |
| | | is complete | |
| inspect1_name | Inspected By 1 | Report Inspected by name | n/a |
| inspect2_name | Inspected By 2 | Report Inspected by name | n/a |
| input_name | Input by | User ID of report creator | n/a |
| update_time | Update Time | Date/Time Report last | n/a |
| | | updated | |
| total_pages | Total | Total number of component | n/a |
| | components | on report platform | |
| skipped_pages | Skipped | Number of Skipped | n/a |
| | Components | Components on | |
| | | report Platform | |
| interrupted | Interrupted bit | Report interruption flag | n/a |
| deleted | Deleted bit | Report Deleted flag | n/a |

ASP Pages Affected:

/semp/user/complete.asp

/semp/user/removeReport.asp

/semp/user/reportHandler.asp

/semp/user/skippedReport.asp

/semp/user/submit.asp

/semp/user/welcome.asp

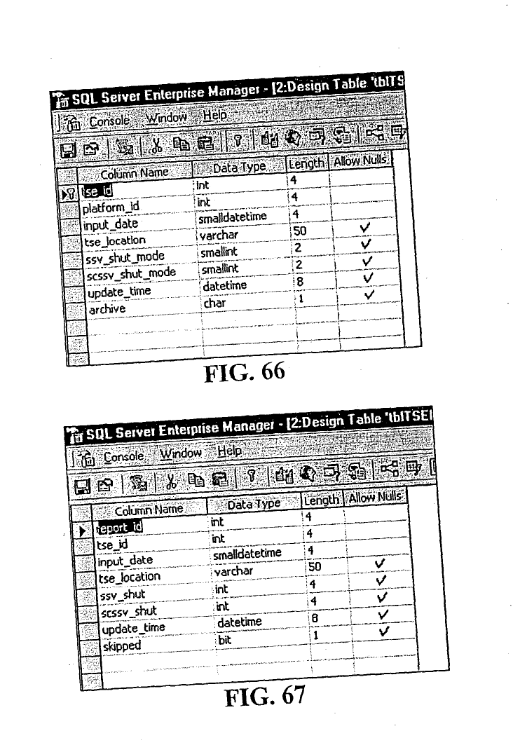

FIG. 66 is a representative “tblTSE” Properties. This table is used to store platform setup data for TSE equipment. The actual user entered test data is stored in tblTSEEntry.

TABLE 62
TABLE PARAMETERS

| Column | Common | | Default |
|---|---|---|---|
| Name | Name | Purpose | Value |
| tse_id | TSE ID | Key - unique ED for | n/a |
| | | each component | |
| | | (Table Entry) | |
| platform_id | Platform ID | Relates the table | n/a |
| | | entry to the relevant | |
| | | Platform ID | |
| input_date | Input Date | Date/Time Equipment | n/a |
| | | added to database | |
| tse_location | TSE Location | TSE Location | n/a |
| ssv_shut_mode | SSV Shutin | SSV Shutin Mode | n/a |
| | Mode | | |
| scssv_shut_mode | SCSSV Shutin | SCSSV Shutin Mode | n/a |
| | Mode | | |
| update_time | Update Time | time when table | n/a |
| | | entry updated | |
| archive | Archive bit | bit to determine | 0 |
| | | if item has been | |
| | | archived | |

ASP Pages Affected:

/semp/user//skippedreport/esdstation/TSEsubmit.asp

/semp/report/esdstation/generate.asp

FIG. 67 is a representative “tblTSEEntry” Properties. This table is used to store platform setup data for TSE equipment. The actual user entered test data is stored in tblTSEEntry.

TABLE 63
TABLE PARAMETERS

| Column | Common | | Default |
|---|---|---|---|
| Name | Name | Purpose | Value |
| tse_id | TSE ID | Key - unique ID for each | n/a |
| | | component (Table Entry) | |
| report_id | Report ID | Relates the table entry | n/a |
| | | to the relevant Report | |
| | | ID | |
| input_date | Input Date | Date/Time Equipment added | n/a |
| | | to database | |
| tse_location | TSE Location | TSE Location | n/a |
| ssv_shut | SSV | SSV Shutin time (user | n/a |
| | | value) | |
| scssv_shut | SCSSV | SCSSV Shutin time (user | n/a |
| | | value) | |
| update_time | Update Time | time when table entry | n/a |
| | | updated | |
| skipped | skipped bit | bit to determine if item | 0 |
| | | has been skipped | |

ASP Pages Affected:

/semp/user/esdstation/TSEsubmit.asp

/semp/report/esdstation/generate.asp

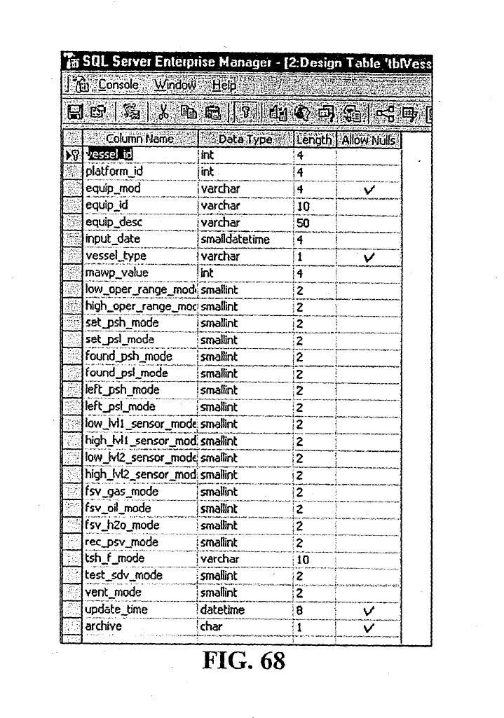

FIG. 68 is a representative “tblVessel” Properties. This table is used to store platform setup data for the Vessel equipment class. The actual user entered test data is stored in tblVesselEntry.

TABLE 64
TABLE PARAMETERS

| Column | Common | | Default |
|---|---|---|---|
| Name | Name | Purpose | Value |
| vessel_id | Vessel ID | Key - unique ID for each | n/a |
| | | component (Table Entry) | |
| platform_id | Platform ID | Relates the table entry | n/a |
| | | to the relevant Platform | |
| | | ID | |
| equip_id | Equipment ED | The Equipment ID component | n/a |
| | | of the component name - | |
| | | displayed on all | |
| | | user and setup pages | |
| equip_mod | Equipment | 3 letter code that determines | n/a |
| | Modifier | component type - displayed | |
| | | on all user and setup pages | |
| equip_desc | Equipment | Text sting describing | n/a |
| | Description | equipment service | |
| input_date | Input Date | Date/Time Equipment added | n/a |
| | | to database | |
| vessel_type | Vessel Type | Vessel Type (ATMO or PRESS) | n/a |
| mawp_value | MAWP | Maximum Allowed Working | n/a |
| | | Pressure for component | |
| high_oper_range_mode | Operating | Mode for Operating Range High | n/a |
| | Range high | | |
| low_oper_range_mode | Operating | Mode for Operating Range Low | n/a |
| | Range Low | | |
| set_psh_mode | Set PSH | Set PSH mode | n/a |
| set_psl_mode | Set PSL | Set PSL mode | n/a |
| found_psh_mode | Found PSH | Found PSH mode | n/a |
| found_psl_mode | Found PSL | Found PSL mode | n/a |
| left_psh_mode | Left PSH | Left PSH mode | n/a |
| left_psl_mode | Left PSL | Left PSL mode | n/a |
| rec_psv_mode | Rec PSV | Rec PSV Mode | n/a |
| low_lvl1_sensor_mode | LL 1 Sensor | LL 1 Sensor Mode | n/a |
| high_lvl1_sensor_mode | HL 1 Sensor | HL 1 Sensor Mode | n/a |
| low_lvl2_sensor_mode | LL 2 Sensor | LL 2 Sensor Mode | n/a |
| high_lvl2_sensor_mode | HL 2 Sensor | HL 2 Sensor Mode | n/a |
| fsv_gas_mode | FSV Gas Mode | FSV Mode - Gas | n/a |
| fsv_oil_mode | FSV Oil Mode | FSV Mode - Oil | n/a |
| fsv_water_mode | FSV Water | FSV Mode - Water | n/a |
| | Mode | | |
| rec_psv_mode | Recorded PSV | Recorded PSV Mode | n/a |
| tsh_f_mode | TSH Mode | TSH F Mode | n/a |
| test_sdv_mode | SDV | SDV Mode | n/a |
| vent_mode | Vent Mode | Vent Mode | n/a |
| update_time | Update Time | time when table entry | n/a |
| | | updated | |
| archive | Archive bit | bit to determine if item | 0 |
| | | has been archived | |

ASP Pages Affected:

/semp/setup/vessel/default.asp

/semp/setup/vessel/submit.asp

/semp/setup/vessel/edit/default.asp

/semp/setup/vessel/edit/submit.asp

/semp/setup/vessel/edit/vessel_add.asp

/semp/setup/vessel/edit/vessel_delete.asp

/semp/setup/vessel/edit/vessel_edit.asp

/semp/report/vessel/generate.asp

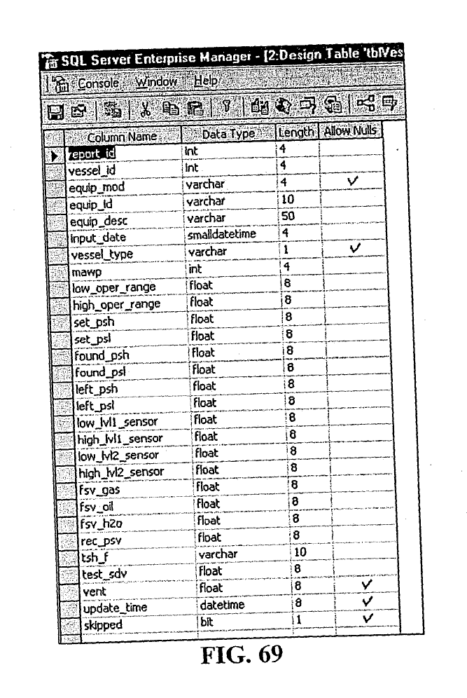

FIG. 69 is a representative “tblVesselEntry” Properties. This table is used to store user entered test data for the Vessel equipment class. The platform setup data is stored in tblVessel.

TABLE 65
TABLE PARAMETERS

| Column | Common | | Default |
|---|---|---|---|
| Name | Name | Purpose | Value |
| vessel_id | Vessel ID | Key - unique ID | n/a |
| | | for each component | |
| | | (Table Entry) | |
| report id | Report ID | Relates the table | n/a |
| | | entry to the | |
| | | relevant Report ID | |
| equip_id | Equipment | The Equipment ID | n/a |
| | ID | component of the | |
| | | component name - | |
| | | displayed on all | |
| | | user and setup pages | |
| equip_mod | Equipment | 3 letter code that | n/a |
| | Modifier | determines component | |
| | | type - displayed | |
| | | on all user and | |
| | | setup pages | |
| equip_desc | Equipment | Text sting describing | n/a |
| | Description | equipment service | |
| input_date | Input Date | Date/Time Equipment | n/a |
| | | added to database | |
| vessel_type | Vessel Type | Vessel Type | n/a |
| | | (ATMO or PRESS) | |
| mawp | MAWP | Maximum Allowed | n/a |
| | | Working Pressure | |
| | | for component | |
| high_oper_range | Operating | Operating Range | n/a |
| | Range high | High user | |
| | | entered value | |
| low_oper_range | Operating | Operating Range | n/a |
| | Range Low | Low High user | |
| | | entered value | |
| set_psh | Set PSH | Set PSH user | n/a |
| | | entered value | |
| set_psl | Set PSL | Set PSL user | n/a |
| | | entered value | |
| found_psh | Found PSH | Found PSH user | n/a |
| | | entered value | |
| found_psl | Found PSL | Found PSL user | n/a |
| | | entered value | |
| left_psh | Left PSH | Left PSH user | n/a |
| | | entered value | |
| left_psl | Left PSL | Left PSL user | n/a |
| | | entered value | |
| rec_psv | Rec PSV | Rec PSV user | n/a |
| | | entered value | |
| low_lvl1_sensor | LL 1 Sensor | LL 1 Sensor user | n/a |
| | | entered value | |
| high_lvl1_sensor | HL 1 Sensor | HL 1 Sensor user | n/a |
| | | entered value | |
| low_lvl2_sensor | LL 2 Sensor | LL 2 Sensor user | n/a |
| | | entered value | |
| high_lvl2_sensor | HL 2 Sensor | HL 2 Sensor user | n/a |
| | | entered value | |
| fsv_gas | FSV Gas | FSV- Gas user | n/a |
| | | entered value | |
| fsv_oil | FSV Oil | FSV- Oil user | n/a |
| | | entered value | |
| fsv_water | FSV Water | FSV- Water user | n/a |
| | | entered value | |
| rec_psv | Recorded PSV | Recorded PSV user | n/a |
| | | entered value | |
| tsh_f | TSH | TSH F user | n/a |
| | | entered value | |
| test_sdv | SDV | SDV user entered | n/a |
| | | value | |
| vent | Vent | Vent user entered | n/a |
| | | value | |
| update_time | Update Time | time when table | n/a |
| | | entry updated | |
| skipped | Skipped bit | bit to determine | 0 |
| | | if item has been | |
| | | skipped | |

ASP Pages Affected:

/semp/user/skippedreport/vessel/default.asp

/semp/user/skippedreport/vessel/submit.asp

/semp/user/skippedreport/vessel/edit.asp

/semp/report/vessel/generate.asp

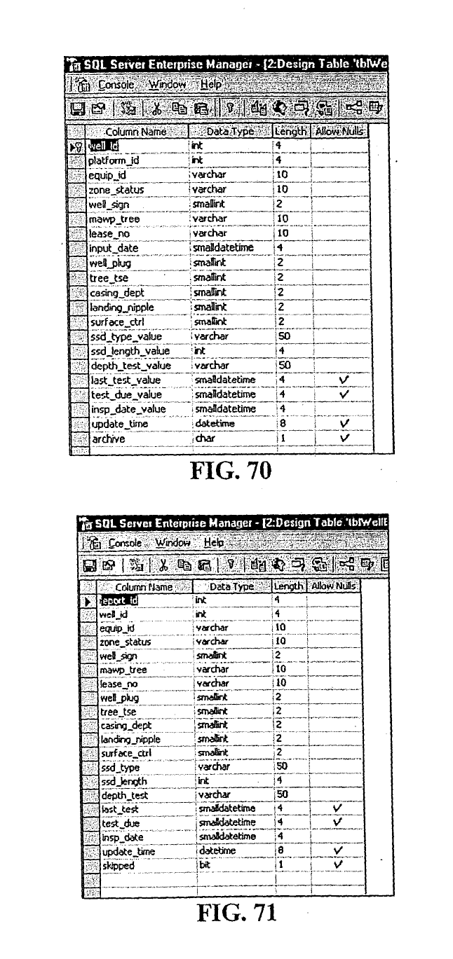

FIG. 70 is a representative “tblWell” Properties. This table is used to store platform setup data for the Well equipment class. The actual user entered test data is stored in tblWellEntry.

TABLE 66
TABLE PARAMETERS

| Column | Common | | Default |
|---|---|---|---|
| Name | Name | Purpose | Value |
| well_id | Well ID | Key - unique ID for | n/a |
| | | each component | |
| | | (Table Entry) | |
| platform_id | Platform | Relates the table | n/a |
| | ID | entry to the | |
| | | relevant Platform | |
| | | ID | |
| equip_id | Equipment | The Equipment ID | n/a |
| | ID | component of the | |
| | | component name - | |
| | | displayed on all | |
| | | user and setup pages | |
| zone_status | Zone Status | Zone Status | n/a |
| well_sign | Well Sign | Well Sign | n/a |
| mawp_tree | MAWP Tree | MAWP Tree | n/a |
| lease_no | Lease No. | Lease No. | n/a |
| input_date | Input Date | Date/Time | n/a |
| | | Equipment added | |
| | | to database | |
| well_plug | Well Plug | Well Plug | n/a |
| tree_tse | Tree TSE | Tree TSE | n/a |
| casing_dept | Casing | Casing Departure | n/a |
| | Departure | | |
| landing_nipple | landing | landing Nipple | n/a |
| | Nipple | | |
| surface_cntl | Surface | Surface Control | n/a |
| | Control | | |
| ssd_type_value | SSD Type | SSD Type | n/a |
| ssd_length_value | SSD Test | SSD Test length | n/a |
| | length | | |
| depth_test_value | Depth Set | Depth Set | n/a |
| last_test_value | Last Test | Last Test | n/a |
| test_due_value | Test Due | Test Due | n/a |
| insp_date_value | Inspection | Inspection Date | n/a |
| | Date | | |
| update_time | Update Time | time when table | n/a |
| | | entry updated | |
| archive | Archive bit | bit to determine | 0 |
| | | if item has been | |
| | | archived | |

ASP Pages Affected:

/semp/setup/well/default.asp

/semp/setup/well/submit.asp

/semp/setup/well/edit/default.asp

/semp/setup/well/edit/submit.asp

/semp/setup/well/edit/well_add.asp

/semp/setup/well/edit/well_delete.asp

/semp/setup/well/edit/well_edit.asp

/semp/report/well/generate.asp

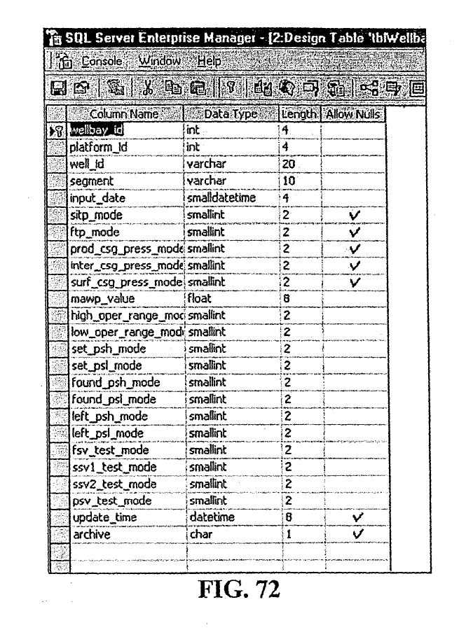

FIG. 71 is a representative “tblWellEntry” Properties. This table is used to store user entered test data for the Well equipment class. The platform setup data is stored in tblWell.

TABLE 67
TABLE PARAMETERS

| Column | Common | | Default |
|---|---|---|---|
| Name | Name | Purpose | Value |
| well_id | Well ID | Key - unique ID for | n/a |
| | | each component | |
| | | (Table Entry) | |
| report id | Report ID | Relates the table | n/a |
| | | entry to the | |
| | | relevant Report ID | |
| equip_id | Equipment | The Equipment ID | n/a |
| | ID | component of the | |
| | | component name - | |
| | | displayed on all | |
| | | user and setup pages | |
| zone_status | Zone Status | Zone Status | n/a |
| well_sign | Well Sign | Well Sign | n/a |
| mawp_tree | MAWP Tree | MAWP Tree | n/a |
| lease_no | Lease No. | Lease No. | n/a |
| input_date | Input Date | Date/Time Equipment | n/a |
| | | added to database | |
| well_plug | Well Plug | Well Plug | n/a |
| tree_tse | Tree TSE | Tree TSE | n/a |
| casing_dept | Casing | Casing Departure | n/a |
| | Departure | | |
| landing_nipple | landing | landing Nipple | n/a |
| | Nipple | | |
| surface_cntl | Surface | Surface Control | n/a |
| | Control | | |
| ssd_type | SSD Type | SSD Type | n/a |
| ssd_length | SSD Test | SSD Test length | n/a |
| | length | | |
| depth_test | Depth Set | Depth Set | n/a |
| last_test | Last Test | Last Test user | n/a |
| | | entered value | |
| test_due | Test Due | Test Due | n/a |
| insp_date | Inspection | Inspection Date | n/a |
| | Date | | |
| update_time | Update Time | time when table | n/a |
| | | entry updated | |
| skipped | Skipped bit | bit to determine | 0 |
| | | if item has been | |
| | | skipped | |

ASP Pages Affected:

/semp/user/skippedreport/well/default.asp

/semp/user/skippedreport/well/submit.asp

/semp/user/skippedreport/well/edit.asp

/semp/report/well/generate.asp

FIG. 72 is a representative “tblWellbay” Properties. This table is used to store platform setup data for the Wellbay equipment class. The actual user entered test data is stored in tblWellbayEntry.

TABLE 68
TABLE PARAMETERS

| Column | Common | | Default |
|---|---|---|---|
| Name | Name | Purpose | Value |
| wellbay_id | Well ID | Key - unique ID for | n/a |
| | | each component | |
| | | (Table Entry) | |
| platform_id | Platform | Relates the table | n/a |
| | ID | entry to the | |
| | | relevant Platform | |
| | | ID | |
| well_id | Well ID | The Equipment ID | n/a |
| | | component of the | |
| | | component name - | |
| | | displayed on all | |
| | | user and setup pages | |
| segment | Flowline | FA-1, FA-2, or FA-3 | n/a |
| | Segment | | |
| input_date | Input Date | Date/Time Equipment | n/a |
| | | added to database | |
| sitp_mode | SITP Mode | SITP Mode | n/a |
| ftp_mode | FTP Mode | FTP Mode | n/a |
| prod_csg_press_mode | Prod Casing | Prod Casing | n/a |
| | Press Mode | Press Mode | |
| inter_csg_press_mode | Intermed | Intermed Casing | n/a |
| | Casing Press | Press Mode | |
| | Mode | | |
| surf_csg_press_mode | Surf Casing | Surf Casing | n/a |
| | Press Mode | Press Mode | |
| mawp_value | MAWP | Maximum Allowed | n/a |
| | | Working Pressure | |
| | | for component | |
| high_oper_range_mode | Operating | Mode for Operating | n/a |
| | Range high | Range High | |
| low_oper_range_mode | Operating | Mode for Operating | n/a |
| | Range Low | Range Low | |
| set_psh_mode | Set PSH | Set PSH mode | n/a |
| set_psl_mode | Set PSL | Set PSL mode | n/a |
| found_psh_mode | Found PSH | Found PSH mode | n/a |
| found_psl_mode | Found PSL | Found PSL mode | n/a |
| left_psh_mode | Left PSH | Left PSH mode | n/a |
| left_psl_mode | Left PSL | Left PSL mode | n/a |
| fsv_test_mode | FSV Test | FSV Test mode | n/a |
| ssv1_test_mode | SSV1 Test | SSV 1 Test mode | n/a |
| ssv2_test_mode | SSV2 Test | SSV 2 Test mode | n/a |
| psv_mode | PSV | PSV Mode | n/a |
| update_time | Update Time | time when table | n/a |
| | | entry updated | |
| archive | Archive bit | bit to determine | 0 |
| | | if item has been | |
| | | archived | |

ASP Pages Affected:

/semp/setup/wellbay/default.asp

/semp/setup/wellbay/submit.asp

/semp/setup/wellbay/edit/default.asp

/semp/setup/wellbay/edit/submit.asp

/semp/setup/wellbay/edit/wellbay_add.asp

/semp/setup/wellbay/edit/wellbay_delete.asp

/semp/setup/wellbay/edit/wellbay_edit.asp

/semp/setup/wellbay/edit/wellbay_add_update.asp

/semp/setup/wellbay/edit/wellbay_edit_update.asp

/semp/report/wellbay/generate.asp

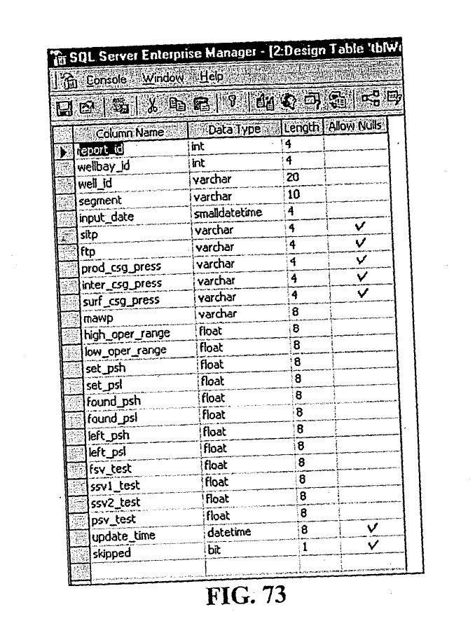

FIG. 73 is a representative “tblWellbayEntry” Properties. This table is used to store user entered test data for the Wellbay equipment class. The platform setup data is stored in tblWellbay.

TABLE 69
TABLE PARAMETERS

| Column | Common | | Default |
|---|---|---|---|
| Name | Name | Purpose | Value |
| wellbay_id | Well ID | Key - unique ID for | n/a |
| | | each component | |
| | | (Table Entry) | |
| report_id | Report ID | Relates the table | n/a |
| | | entry to the | |
| | | relevant Report ID | |
| well_id | Well ID | The Equipment ID | n/a |
| | | component of the | |
| | | component name - | |
| | | displayed on all | |
| | | user and setup pages | |
| segment | Flowline | FA-1, FA-2, or FA-3 | n/a |
| | Segment | | |
| input_date | Input Date | Date/Time Equipment | n/a |
| | | added to database | |
| sitp | SITP | SITP Mode | n/a |
| ftp | FTP | FTP Mode | n/a |
| prod_csg_press | Prod Casing | Prod Casing Press | n/a |
| | Press | User entered value | |
| inter_csg_press | Intermed | Intermed Casing Press | n/a |
| | Casing Press | User entered value | |
| surf_csg_press | Surf Casing | Surf Casing Press | n/a |
| | Press | User entered value | |
| mawp | MAWP | Maximum Allowed | n/a |
| | | Working Pressure | |
| | | for component | |
| high_oper_range | Operating | Operating Range | n/a |
| | Range high | High User entered | |
| | | value | |
| low_oper_range | Operating | Operating Range | n/a |
| | Range Low | Low User entered | |
| | | value | |
| set_psh | Set PSH | Set PSH User | n/a |
| | | entered value | |
| set_psl | Set PSL | Set PSL User | n/a |
| | | entered value | |
| found_psh | Found PSH | Found PSH User | n/a |
| | | entered value | |
| found_psl | Found PSL | Found PSL User | n/a |
| | | entered value | |
| left_psh | Left PSH | Left PSH User | n/a |
| | | entered value | |
| left_psl | Left PSL | Left PSL User | n/a |
| | | entered value | |
| fsv_test | FSV Test | FSV Test User | n/a |
| | | entered value | |
| ssv1_test | SSV1 Test | SSV 1 Test User | n/a |
| | | entered value | |
| ssv2_test | SSV2 Test | SSV 2 Test User | n/a |
| | | entered value | |
| psv | PSV | PSV User entered | n/a |
| | | value | |
| update_time | Update Time | time when table | n/a |
| | | entry updated | |
| archive | Archive bit | bit to determine | 0 |
| | | if item has been | |
| | | archived | |

ASP Pages Affected:

/semp/user/skippedreport/wellbay/default.asp

/semp/user/skippedreport/wellbay/submit.asp

/semp/user/skippedreport/wellbay/edit.asp

/semp/report/wellbay/generate.asp

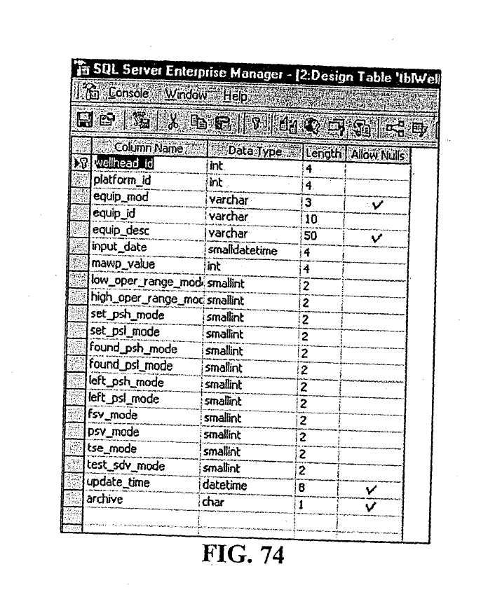

FIG. 74 is a representative “tblWellhead” Properties. This table is used to store platform setup data for the Wellhead Injection Lines equipment class. The actual user entered test data is stored in tblWellheadEntry.

TABLE 70
TABLE PARAMETERS

| Column | Common | | Default |
|---|---|---|---|
| Name | Name | Purpose | Value |
| wellhead_id | Wellhead ID | Key - unique ID for | n/a |
| | | each component | |
| | | (Table Entry) | |
| platform_id | Platform ID | Relates the table | n/a |
| | | entry to the | |
| | | relevant Platform | |
| | | ID | |
| equip_id | Equipment | The Equipment ID | n/a |
| | ID | component of the | |
| | | component name - | |
| | | displayed on all | |
| | | user and setup | |
| | | pages | |
| equip_mod | Equipment | 3 letter code that | n/a |
| | Modifier | determines component | |
| | | type - displayed on | |
| | | all user and setup | |
| | | pages | |
| equip_desc | Equipment | Text sting describing | n/a |
| | Description | equipment service | |
| input_date | Input Date | Date/Time Equipment | n/a |
| | | added to database | |
| mawp_value | MAWP | Maximum Allowed | n/a |
| | | Working Pressure | |
| | | for component | |
| high_oper_range_mode | Operating | Mode for Operating | n/a |
| | Range high | Range High | |
| low_oper_range_mode | Operating | Mode for Operating | n/a |
| | Range Low | Range Low | |
| set_psh_mode | Set PSH | Set PSH mode | n/a |
| set_psl_mode | Set PSL | Set PSL mode | n/a |
| found_psh_mode | Found PSH | Found PSH mode | n/a |
| found_psl_mode | Found PSL | Found PSL mode | n/a |
| left_psh_mode | Left PSH | Left PSH mode | n/a |
| left_psl_mode | Left PSL | Left PSL mode | n/a |
| fsv_test_mode | FSV Test | FSV Test mode | n/a |
| psv_mode | PSV | PSV Mode | n/a |
| tse_mode | TSE | TSE Mode | n/a |
| test_sdv_mode | SDV | SDV Mode | n/a |
| update_time | Update | time when table | n/a |
| | Time | entry updated | |
| archive | Archive | bit to determine | 0 |
| | bit | if item has been | |
| | | archived | |

ASP Pages Affected:

/semp/setup/wellhead/default.asp

/semp/setup/wellhead/submit.asp

/semp/setup/wellhead/edit/default.asp

/semp/setup/wellhead/edit/submit.asp

/semp/setup/wellhead/edit/wellhead_add.asp

/semp/setup/wellhead/edit/wellhead_delete.asp

/semp/setup/wellhead/edit/wellhead_edit.asp

/semp/report/wellhead/generate.asp

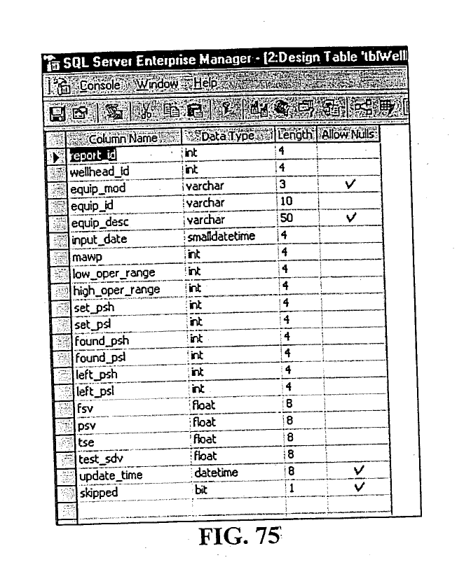

FIG. 75 is a representative “tblWellheadEntry” Properties. This table is used to store user entered test data for the Wellhead Injection Lines equipment class. The platform setup data is stored in tblWellhead.

TABLE 71
TABLE PARAMETERS

| Column | Common | | Default |
|---|---|---|---|
| Name | Name | Purpose | Value |
| wellhead_id | Wellhead | Key - unique ID for each | n/a |
| | ID | component (Table Entry) | |
| report_id | Report ID | Relates the table entry to | n/a |
| | | the relevant Report ID | |
| equip_id | Equipment | The Equipment ID component | n/a |
| | ID | of the component name - | |
| | | displayed on all | |
| | | user and setup pages | |
| equip_mod | Equipment | 3 letter code that determines | n/a |
| | Modifier | component type - displayed | |
| | | on all user and setup pages | |
| equip_desc | Equipment | Text sting describing | n/a |
| | Description | equipment service | |
| input_date | Input Date | Date/Time Equipment added | n/a |
| | | to database | |
| mawp | MAWP | Maximum Allowed Working | n/a |
| | | Pressure for component | |
| high_oper_range | Operating | Operating Range High User | n/a |
| | Range high | entered test data | |
| low_oper_range | Operating | Operating Range Low User | n/a |
| | Range Low | entered test data | |
| set_psh | Set PSH | Set PSH User entered | n/a |
| | | test data | |
| set_psl | Set PSL | Set PSL User entered | n/a |
| | | test data | |
| found_psh | Found PSH | Found PSH User entered | n/a |
| | | test data | |
| found_psl | Found PSL | Found PSL User entered | n/a |
| | | test data | |
| left_psh | Left PSH | Left PSH User entered | n/a |
| | | test data | |
| left_psl | Left PSL | Left PSL User entered | n/a |
| | | test data | |
| fsv_test | FSV Test | FSV Test User entered | n/a |
| | | test data | |
| psv | PSV | PSV User entered test | n/a |
| | | data | |
| tse | TSE | TSE User entered test | n/a |
| | | data | |
| test_sdv | SDV | SDV User entered test | n/a |
| | | data | |
| update_time | Update | time when table entry | n/a |
| | Time | updated | |
| skipped | skipped | bit to determine if item | 0 |
| | bit | has been skipped | |

ASP Pages Affected:

/semp/user/skippedreport/wellhead/default.asp

/semp/user/skippedreport/wellhead/submit.asp

/semp/user/skippedreport/wellhead/edit.asp

/semp/report/wellhead/generate.asp

Though the preferred embodiment as depicted herein represents an embodiment of the invention should allow for the flexibility and versatility for embodiments not described or depicted herein. Those skilled in the art will realize its significant variation and deviations from this embodiment are meant to be within the scope of this invention.

We claim:

1. A system for management of safety system test data comprising:
at least one server connected to a wide area network;
wherein the at least one server contains safety system test data; and
wherein the at least one safety system test data is remotely accessible.

2. The system of claim 1 wherein the safety system test data is platform-specific testing/compliance data.

3. The system of claim 1 wherein a portion of the safety system test data is an operational model of each user's production and safety processes.

4. The system of claim 1 wherein the safety system test data is safety and environmental management program data.

5. The system of claim 1 wherein at least one server is an application server.

6. The system of claim 1 wherein the system is remotely hosted using at least one Web server/application server.

7. The system of claim 1 wherein a portion of the safety system test data relates to production components and safety devices.

8. The system of claim 6 wherein at least one production component is Platform Info; Well; Wellbay; Wellhead Injection Lines; Header; Pump; Compressor; Vessels (Atmospheric and Pressure); Pipeline; Heat Exchanger; Fired Components; ESD and TSE Stations; and/or Compliance Checklist.

9. The system of claim 1 further comprising:
at least one platform setup page;
at least one user input page; and
at least one database. method of claim 9 which further comprises the Step of analyzing operation based on the safety system test data.

10. A method for management of safety system test data which comprises the steps of:
(a) inputting the safety system test data;
(b) verifying that the safety system test data was input correctly; and
(c) generating a report;
the at least one Step (a)-(c) is performed remotely.

11. The method of claim 10 which further comprises the Step of analyzing operation based on the safety system test data.

12. The method of claim 10 which further comprises the Step of entering data for all appropriate production components and safety devices.

13. The method of claim 12 wherein at least one production component is Platform Info; Well; Wellbay; Wellhead Injection Lines; Header; Pump; Compressor; Vessels (Atmospheric and Pressure); Pipeline; Heat Exchanger; Fired Components; ESD and TSE Stations; and/or Compliance Checklist.

14. The method of claim 10 which further comprises the Step of studying reliability.

15. The method of claim 10 which further comprises the Step of reporting to at least one regulatory agency.

16. The method of claim 10 wherein the safety system test data is platform-specific testing/compliance data.

17. The method of claim 10 wherein the safety system test data is an operational model of each user's production and safety processes.

18. The method of claim 10 wherein the safety system test data is safety and environmental management program data.

19. The method of claim 10 wherein the safety system test data includes a system that comprisses:
at least one platform setup page;
at least one user input page; and
at least one database
